(19) United States
(12) Patent Application Publication
(10) Pub. No.: US 2021/0181488 A1
(43) Pub. Date: Jun. 17, 2021

(54) WIDE-ANGLE OPTICAL SYSTEM AND IMAGE PICKUP APPARATUS USING THE SAME

(71) Applicant: OLYMPUS CORPORATION, Tokyo (JP)

(72) Inventors: Takashi FUJIKURA, Tokyo (JP); Keisuke ICHIKAWA, Tokyo (JP); Shinichi MIHARA, Tokyo (JP)

(73) Assignee: OLYMPUS CORPORATION, Tokyo (JP)

(21) Appl. No.: 17/190,453

(22) Filed: Mar. 3, 2021

Related U.S. Application Data
(63) Continuation of application No. PCT/JP2019/008028, filed on Mar. 1, 2019.

(51) Int. Cl. G02B 15/14; H04N 5/225; G02B 7/04; G02B 23/24

(52) U.S. Cl. CPC G02B 15/143507; H04N 5/2254; H04N 2005/2255; G02B 23/2438; G02B 7/04

(57) ABSTRACT

A wide-angle optical system is a wide-angle optical system having a lens component. The lens component has a plurality of optical surfaces, in the lens component, two optical surfaces are in contact with air, and at least one optical surface is a curved surface. The wide-angle optical system includes in order from an object side, a first lens unit having a negative refractive power, a second lens unit, and a third lens unit having a positive refractive power. The second lens unit, for a focal-position adjustment, is moved between a first position and a second position along an optical axis. The third lens unit includes a cemented lens having a positive refractive power and a cemented lens having a negative refractive power, and following conditional expression (1) is satisfied:

0.05<fL/R31F<1.0 (1).

### CROSS-REFERENCE TO RELATED APPLICATION

The present application is a continuation application of International Application No. PCT/JP2019/008028 filed on Mar. 1, 2019, the entire contents of which are incorporated herein by reference.

### BACKGROUND

### Technical Field

The present disclosure relates to a wide-angle optical system and an image pickup apparatus using the same.

### Description of the Related Art

As an optical system having a wide angle of view, an objective optical system for endoscope has been known. In the objective optical system for endoscope, a wide-angle optical system with the angle of view of more than 100 degrees has been used.

In conventional endoscopes, an image sensor with a small number of pixels was used. Therefore, in an objective optical system for endoscope, an optical system with a fixed focus was used. Even when the optical system with a fixed focus was used, it was possible to cover a range of an object distance required to be observed (observation depth), by a depth of field.

However, in recent years, for improving a quality of an observed image, an image sensor with a large number of pixels has been used. In an endoscope in which the image sensor with a large number of pixels is used, a high resolution is sought even for the optical system.

When an optical system is made to have a high resolution, the depth of field becomes narrower than the required observation depth. Consequently, it becomes difficult to observe the required observation depth in a focused state. For such reasons, a need arose to impart a function of adjusting a focal position to an optical system.

An objective optical system for endoscope which enables to adjust the focal position has been known. In this objective optical system for endoscope, an inner focusing has been used for adjusting the focal position. For carrying out the inner focusing, an actuator is provided around an optical system.

An optical unit, for instance, includes an optical system and an actuator. In an endoscope, it is necessary to seal the optical unit. Moreover, the angle of view is 140° or more, and there are restrictions on a size and an output of the actuator. Therefore, in the focal-position adjustment, it is difficult to move the optical system. A light-weight and space-saving inner focusing is necessary.

Objective optical systems for endoscope in which, the inner focusing is used, have been disclosed in International Unexamined Patent Application Publication No. 2014/129089 and International Unexamined Patent Application Publication No. 2016/067838.

### SUMMARY

A wide-angle optical system according to at least some embodiments of the present disclosure is a wide-angle optical system having a lens component,

the lens component has a plurality of optical surfaces, and

in the lens component, two optical surfaces are in contact with air and at least one optical surface is a curved surface, includes in order from an object side:

a first lens unit having a negative refractive power,

a second lens unit, and

a third lens unit having a positive refractive power, wherein

the second lens unit is moved between a first position and a second position along an optical axis for a focal-position adjustment, the first position is a position at which a distance between the first lens unit and the second lens unit becomes the minimum, and the second position is a position at which a distance between the second lens unit and the third lens unit becomes the minimum,

the third lens unit includes a cemented lens having a positive refractive power and a cemented lens having a negative refractive power, and

following conditional expression (1) is satisfied:

0.05<fL/R31F<1.0 (1)

where,

R31F denotes a radius of curvature of a surface on the object side of an object-side lens component,

fL denotes a focal length of the wide-angle optical system at the first position, and

the object-side lens component is a lens component located nearest to an object in the third lens unit.

Moreover, an image pickup apparatus of the present disclosure includes:

an optical system, and

an image sensor which is disposed on an image plane, wherein

the image sensor has an image pickup surface, and converts an image formed on the image pickup surface by the optical system to an electric signal, and

the optical system is the abovementioned wide-angle optical system.

### BRIEF DESCRIPTION OF THE DRAWINGS

FIG. 1A and FIG. 1B are lens cross-sectional views of a wide-angle optical system of an example 1;

FIG. 2A and FIG. 2B are lens cross-sectional views of a wide-angle optical system of an example 2;

FIG. 3A and FIG. 3B are lens cross-sectional views of a wide-angle optical system of an example 3;

FIG. 4A and FIG. 4B are lens cross-sectional views of a wide-angle optical system of an example 4;

FIG. 5A and FIG. 5B are lens cross-sectional views of a wide-angle optical system of an example 5;

FIG. 6A and FIG. 6B are lens cross-sectional views of a wide-angle optical system of an example 6;

FIG. 7A and FIG. 7B are lens cross-sectional views of a wide-angle optical system of an example 7;

FIG. 8A and FIG. 8B are lens cross-sectional views of a wide-angle optical system of an example 8;

FIG. 9A and FIG. 9B are lens cross-sectional views of a wide-angle optical system of an example 9;

FIG. 10A and FIG. 10B are lens cross-sectional views of a wide-angle optical system of an example 10;

FIG. 11A and FIG. 11B are lens cross-sectional views of a wide-angle optical system of an example 11;

FIG. 12A and FIG. 12B are lens cross-sectional views of a wide-angle optical system of an example 12;

FIG. 13A and FIG. 13B are lens cross-sectional views of a wide-angle optical system of an example 13;

FIG. 14A and FIG. 14B are lens cross-sectional views of a wide-angle optical system of an example 14;

FIG. 15A and FIG. 15B are lens cross-sectional views of a wide-angle optical system of an example 15;

FIG. 16A and FIG. 16B are lens cross-sectional views of a wide-angle optical system of an example 16;

FIG. 17A and FIG. 17B are lens cross-sectional views of a wide-angle optical system of an example 17;

FIG. 18A and FIG. 18B are lens cross-sectional views of a wide-angle optical system of an example 18;

FIG. 19A and FIG. 19B are lens cross-sectional views of a wide-angle optical system of an example 19;

FIG. 20A and FIG. 20B are lens cross-sectional views of a wide-angle optical system of an example 20;

FIG. 21A and FIG. 21B are lens cross-sectional views of a wide-angle optical system of an example 21;

FIG. 22A, FIG. 22B, FIG. 22C, FIG. 22D, FIG. 22E, FIG. 22F, FIG. 22G, and FIG. 22H are aberration diagrams of the wide-angle optical system of the example 1;

FIG. 23A, FIG. 23B, FIG. 23C, FIG. 23D, FIG. 23E,

FIG. 23F, FIG. 23G, and FIG. 23H are aberration diagrams of the wide-angle optical system of the example 2;

FIG. 24A, FIG. 24B, FIG. 24C, FIG. 24D, FIG. 24E, FIG. 24F, FIG. 24G, and FIG. 24H are aberration diagrams of the wide-angle optical system of the example 3;

FIG. 25A, FIG. 25B, FIG. 25C, FIG. 25D, FIG. 25E, FIG. 25F, FIG. 25G, and FIG. 25H are aberration diagrams of the wide-angle optical system of the example 4;

FIG. 26A, FIG. 26B, FIG. 26C, FIG. 26D, FIG. 26E, FIG. 26F, FIG. 26G, and FIG. 26H are aberration diagrams of the wide-angle optical system of the example 5;

FIG. 27A, FIG. 27B, FIG. 27C, FIG. 27D, FIG. 27E, FIG. 27F, FIG. 27G, and FIG. 27H are aberration diagrams of the wide-angle optical system of the example 6;

FIG. 28A, FIG. 28B, FIG. 28C, FIG. 28D, FIG. 28E, FIG. 28F, FIG. 28G, and FIG. 28H are aberration diagrams of the wide-angle optical system of the example 7;

FIG. 29A, FIG. 29B, FIG. 29C, FIG. 29D, FIG. 29E, FIG. 29F, FIG. 29G, and FIG. 29H are aberration diagrams of the wide-angle optical system of the example 8;

FIG. 30A, FIG. 30B, FIG. 30C, FIG. 30D, FIG. 30E, FIG. 30F, FIG. 30G, and FIG. 30H are aberration diagrams of the wide-angle optical system of the example 9;

FIG. 31A, FIG. 31B, FIG. 31C, FIG. 31D, FIG. 31E, FIG. 31F, FIG. 31G, and FIG. 31H are aberration diagrams of the wide-angle optical system of the example 10;

FIG. 32A, FIG. 32B, FIG. 32C, FIG. 32D, FIG. 32E, FIG. 32F, FIG. 32G, and FIG. 32H are aberration diagrams of the wide-angle optical system of the example 11;

FIG. 33A, FIG. 33B, FIG. 33C, FIG. 33D, FIG. 33E, FIG. 33F, FIG. 33G, and FIG. 33H are aberration diagrams of the wide-angle optical system of the example 12;

FIG. 34A, FIG. 34B, FIG. 34C, FIG. 34D, FIG. 34E, FIG. 34F, FIG. 34G, and FIG. 34H are aberration diagrams of the wide-angle optical system of the example 13;

FIG. 35A, FIG. 35B, FIG. 35C, FIG. 35D, FIG. 35E, FIG. 35F, FIG. 35G, and FIG. 35H are aberration diagrams of the wide-angle optical system of the example 14;

FIG. 36A, FIG. 36B, FIG. 36C, FIG. 36D, FIG. 36E, FIG. 36F, FIG. 36G, and FIG. 36H are aberration diagrams of the wide-angle optical system of the example 15;

FIG. 37A, FIG. 37B, FIG. 37C, FIG. 37D, FIG. 37E, FIG. 37F, FIG. 37G, and FIG. 37H are aberration diagrams of the wide-angle optical system of the example 16;

FIG. 38A, FIG. 38B, FIG. 38C, FIG. 38D, FIG. 38E, FIG. 38F, FIG. 38G, and FIG. 38H are aberration diagrams of the wide-angle optical system of the example 17;

FIG. 39A, FIG. 39B, FIG. 39C, FIG. 39D, FIG. 39E, FIG. 39F, FIG. 39G, and FIG. 39H are aberration diagrams of the wide-angle optical system of the example 18;

FIG. 40A, FIG. 40B, FIG. 40C, FIG. 40D, FIG. 40E, FIG. 40F, FIG. 40G, and FIG. 40H are aberration diagrams of the wide-angle optical system of the example 19;

FIG. 41A, FIG. 41B, FIG. 41C, FIG. 41D, FIG. 41E, FIG. 41F, FIG. 41G, and FIG. 41H are aberration diagrams of the wide-angle optical system of the example 20;

FIG. 42A, FIG. 42B, FIG. 42C, FIG. 42D, FIG. 42E, FIG. 42F, FIG. 42G, and FIG. 42H are aberration diagrams of the wide-angle optical system of the example 21;

FIG. 43 is a diagram showing a schematic configuration of an endoscope system;

FIG. 44 is a diagram showing an arrangement of an optical system of an endoscope;

FIG. 45 is a diagram showing an arrangement of an optical system of an image pickup apparatus;

FIG. 46A and FIG. 46B are diagrams showing a schematic configuration of an image pickup apparatus; and

FIG. 47 is a diagram showing a positional relationship of an object, an objective optical system, and an optical-path splitting element.

### DETAILED DESCRIPTION

Prior to the explanation of examples, action and effect of embodiments according to certain aspects of the present disclosure will be described below. In the explanation of the action and effect of the embodiments concretely, the explanation will be made by citing concrete examples. However, similar to a case of the examples to be described later, aspects exemplified thereof are only some of the aspects included in the present disclosure, and there exists a large number of variations in these aspects. Consequently, the present disclosure is not restricted to the aspects that will be exemplified.

A wide-angle optical system of the present embodiment is a wide-angle optical system having a lens component. The lens component has a plurality of optical surfaces, in the lens component, two optical surfaces are in contact with air, and at least one optical surface is a curved surface. The wide-angle optical system includes in order from an object side, a first lens unit having a negative refractive power, a second lens unit, and a third lens unit having a positive refractive power. The second lens unit is moved between a first position and a second position along an optical axis for a focal-position adjustment. The first position is a position at which a distance between the first lens unit and the second lens unit becomes the minimum, and the second position is a position at which a distance between the second lens unit and the third lens unit becomes the minimum. The third lens unit includes a cemented lens having a positive refractive power and a cemented lens having a negative refractive power, and following conditional expression (1) is satisfied:

0.05<fL/R31F<1.0 (1)

where,

R31F denotes a radius of curvature of a surface on the object side of an object-side lens component, fL denotes a focal length of the wide-angle optical system at the first position, and the object-side lens component is a lens component located nearest to an object in the third lens unit.

The wide-angle optical system of the present embodiment, for instance, is about a wide-angle optical system with an angle of view of more than 100 degrees. In recent years, with the debut of a high-resolution monitor and the like, regarding an image quality at the time of observation, a high image quality is being sought. The wide-angle optical system of the present embodiment is a wide-angle optical system which is capable of dealing with such requirement.

Moreover, the wide-angle optical system of the present embodiment is an optical system in which an inner focusing is used. Therefore, an actuator is disposed around an inner-focusing lens. In the wide-angle optical system of the present embodiment, even with the actuator disposed around the optical system, an outer diameter of the overall optical system is small. The wide-angle optical system of the present embodiment, while being an optical system having a wide angle of view, is an optical system in which a light-ray height is suppressed to be low over a long range of a central portion of the optical system.

The wide-angle optical system of the present embodiment is a wide-angle optical system having the lens component. The lens component has the plurality of optical surfaces. In the lens component, the two optical surfaces are in contact with air, and at least one optical surface is a curved surface. The lens component includes a single lens and a cemented lens for example.

Moreover, in the lens component, a lens and a plane parallel plate may have been cemented. In this case, one optical surface in contact with air is a lens surface, and the other optical surface in contact with air is a flat surface. A lens component in which a single lens and a plane parallel plate are cemented, is to be deemed as a single lens. A lens component in which a cemented lens and a plane parallel plate are cemented, is to be deemed as a cemented lens.

Moreover, a planoconvex lens and a planoconcave lens may have been cemented. In this case, a cemented surface is a curved surface and an optical surface in contact with air is a flat surface.

The surface on the object side of the lens component, out of the two optical surfaces in contact with air, is an optical surface located on the object side. A surface on an image side of the lens component, out of the two optical surfaces in contact with air, is an optical surface located on the image side. In a case in which the lens component is a cemented lens, a cemented surface is located between the surface on the object side and the surface on the image side.

The wide-angle optical system of the present embodiment includes in order from the object side, the first lens unit having a negative refractive power, the second lens unit, and the third lens unit having a positive refractive power. The second lens unit is moved between the first position and the second position along the optical axis for the focal-position adjustment. By the movement of the second lens unit, the distance between the first lens unit and the second lens unit and the distance between the second lens unit and the third lens unit change.

The first position is a position at which the distance between the first lens unit and the second lens unit becomes the minimum. At the first position, the second lens unit is located nearest to the object in a range of movement. At the first position, it is possible to focus to an object located at a far point.

The second position is a position at which the distance between the second lens unit and the third lens unit becomes the minimum. At the second position, the second lens unit is located nearest to an image in a range of movement. At the second position, it is possible to focus to an object located at a near point.

The third lens unit includes the cemented lens having a positive refractive power and the cemented lens having a negative refractive power. Accordingly, it is possible to realize a wide-angle optical system in which an angle of view is large and an aberration within a range of adjustment of the focal position is corrected favorably, and which has a high resolution. Moreover, by the optical system having the high resolution, even when an image sensor with a large number of pixels is used, it is possible to acquire a sharp image corresponding to the large number of pixels.

The second lens unit is moved for the focal-position adjustment. An actuator is used for moving the second lens unit. The actuator is disposed near the second lens unit or near the third lens unit. Therefore, it is necessary to provide a space for disposing the actuator near the second lens unit or near the third lens unit.

By disposing the cemented lens having a positive refractive power and the cemented lens having a negative refractive power in the third lens unit, it is possible to lower a light-ray height over a wide range from the object side of the second lens unit up to a vicinity of a center of the third lens unit (hereinafter, referred to as ‘predetermined range’).

By satisfying conditional expression (1), it is possible to lower the light-ray height in the predetermined range. Consequently, it is possible to make small an outer diameter of the second lens unit and an outer diameter of a part of the third lens unit. As a result, it is possible to suppress an increase in an outer diameter of an optical unit even when the actuator is disposed.

In a case in which a value exceeds an upper limit value of conditional expression (1), the light-ray height becomes high. Consequently, the outer diameter of the second lens unit and the outer diameter of a part of the third lens unit become large. As a result, the outer diameter of the optical unit increases.

In a case in which the value falls below a lower limit value of conditional expression (1), a spherical aberration and a coma are susceptible to occur. Consequently, it becomes difficult to realize a wide-angle optical system having a high resolution. Moreover, in a case in which an image sensor with a large number of pixels is used, it becomes difficult to acquire a sharp image corresponding to the large number of pixels.

It is preferable that following conditional expression (1′) be satisfied instead of conditional expression (1).

0.08<fL/R31F<1.0 (1′)

Moreover, it is more preferable that following conditional expression (1″) be satisfied instead of conditional expression (1).

0.10<fL/R31F<1.0 (1″)

An optical system which satisfies conditional expression (1) has a value larger than the lower limit value. As the value in the optical system becomes larger, it becomes easier to suppress the light-ray height to be lower in that optical system.

Regarding conditional expression (1), it is possible to set a favorable lower limit value. It is preferable to set the lower limit value to any of 0.12633, 0.15, 0.25, and 0.35. Moreover, from 0.40 up to 0.70 can be said to be the most suitable range for conditional expression (1).

In the wide-angle optical system of the present embodiment, it is preferable that following conditional expression (2) be satisfied:

−1.0×10²<(R31F +R31R)/(R31F−R31R)<0.5 (2)

where,

R31F denotes the radius of curvature of the surface on the object side of the object-side lens component, and

R31R denotes a radius of curvature of a surface on the image side of the object-side lens component.

By satisfying conditional expression (2), it is possible to correct the spherical aberration and the coma favorably while lowering the light-ray height in the predetermined range. Consequently, it is possible to realize a wide-angle optical system having a high resolution. Moreover, even when an image sensor with a large number of pixels is used, it is possible to acquire a sharp image corresponding to the large number of pixels.

A technical significance of conditional expression (2) is same as the technical significance of conditional expression (1).

It is preferable that following conditional expression (2′) be satisfied instead of conditional expression (2).

−1.0×10²<(R31F +R31R)/(R31F−R31R)<0.2 (2′)

Moreover, it is more preferable that following conditional expression (2″) be satisfied instead of conditional expression (2).

−1.0×10²<(R31F+R31R)/(R31F−R31R)<−0.1 (2′)

An optical system which satisfies conditional expression (2) has a value smaller than an upper limit value. As the value in the optical system becomes smaller, it becomes easier to suppress the light-ray height to be lower in that optical system. For such reason, for conditional expression (2), it is possible to set a favorable upper limit value.

It is preferable to set the upper limit value to any of −0.13049, −0.6, −1.0, and −1.3. Moreover, from −20.0 up to −1.3 can be said to be the most suitable range for conditional expression (2).

It is preferable that the wide-angle optical system of the present embodiment include a first air lens, wherein the first lens be an air lens which satisfies following conditional expression (3), and the third lens unit be provided with the first air lens:

−0.7<fL/R3AF<1.0 (3)

where,

R3AF denotes a radius of curvature of a surface on the object side of the first air lens, and

fL denotes the focal length of the wide-angle optical system at the first position.

An air layer is formed between two adjacent lenses. A refractive index of the air layer is smaller than a refractive index of two lenses. Accordingly, the air layer functions as a lens. This air layer is called as an air lens. The surface on the object side of the air lens is a lens surface of a lens located on the object side of the air layer. A surface on the image side of the air lens is a lens surface of a lens located on the image side of the air layer.

In a case in which the lens surface located on the object side of the air layer and the lens surface located on the image side of the air layer are rotationally-symmetric aspheric surfaces, a radius of curvature of the surface on the object side of the air lens and a radius of curvature of the surface on the image side of the air lens become a radius of curvature on an optical axis (paraxial radius of curvature).

The first air lens is an air lens which satisfies conditional expression (3). Even by providing the third lens unit with the first air lens, it is possible to correct the spherical aberration and the coma favorably while lowering the light-ray height in the predetermined range. Consequently, it is possible to realize a wide-angle optical system which has a high resolution. Moreover, even when an image sensor with a large number of pixels is used, it is possible to acquire a sharp image corresponding to the large number of pixels.

A technical significance of conditional expression (3) is same as the technical significance of conditional expression (1).

A plurality of air layers is formed in the third lens unit. At least one of the plurality of air layers is to be the first air lens.

It is preferable that the first air lens be an air layer having a biconvex shape or an air layer having a meniscus shape. Or, it is preferable that the first air lens be an air layer located second from the object or an air layer located third from the object.

It is preferable that following conditional expression (3′) be satisfied instead of conditional expression (3).

−0.7<fL/R3AF<0.9 (3′)

Moreover, it is more preferable that following conditional expression (3″) be satisfied instead of conditional expression (3).

−0.7<fL/R3AF<0.8 (3″)

An optical system which satisfies conditional expression (3) has a value larger than a lower limit value. As the value in the optical system becomes larger, it becomes easier to suppress the light-ray height to be lower in that optical system.

For conditional expression (3), it is possible to set a favorable lower limit value. It is preferable to set the lower limit value to any of −0.65943, 0.0, 0.1, and 0.2. Moreover, from 0.2 up to 0.7 can be said to be the most suitable range for conditional expression (3).

Instead of providing the first air lens, a negative lens may be provided on the image side of the cemented lens having a negative refractive power which is located nearest to the image in the third lens unit. By making such arrangement, it is possible to achieve a similar effect.

It is preferable that the wide-angle optical system include a first air lens, wherein the first air lens be an air lens which satisfies following conditional expression (4), and the third lens unit be provided with the first air lens:

−20.0<(R3AF+R3AR)/(R3AF−R3AR)<15.0 (4)

where,

R3AF denotes a radius of curvature of a surface on the object side of the first air lens, and

R3AR denotes a radius of curvature of a surface on the image side of the first air lens.

The firs air lens is an air lens which satisfies conditional expression (4). Even by providing the third lens unit with the first air lens, it is possible to correct the spherical aberration and the coma favorably while lowering the light-ray height in the predetermined range. Consequently, it is possible to realize a wide-angle optical system which has a high resolution. Moreover, even when an image sensor with a large number of pixels is used, it is possible to acquire a sharp image corresponding to the large number of pixels.

A technical significance of conditional expression (4) is same as the technical significance of conditional expression (1).

It is preferable that following conditional expression (4′) be satisfied instead of conditional expression (4).

−17.0<(R3AF+R3AR)/(R3AF−R3AR)<0.0 (4′)

Moreover, it is more preferable that following conditional expression (4″) be satisfied instead of conditional expression (4).

−14.0<(R3AF+R3AR)/(R3AF−R3AR)<−0.2 (4″)

An optical system which satisfies conditional expression (4) has a value smaller than an upper limit value. As the value in the optical system becomes smaller, it becomes easier to suppress the light-ray height to be lower in that optical system.

For conditional expression (4), it is possible to set a favorable lower limit value. It is preferable to set the lower limit value to any of 10.29218, −0.49068, −0.6, −0.8, and −1.0. Moreover, from −4.0 up to −1.0 can be said to be the most suitable range for conditional expression (4).

Instead of providing the first air lens, a negative lens is provided on the image side of the cemented lens having a negative refractive power which is located nearest to the image in the third lens unit. Moreover, in addition, any of conditional expressions (4), (4′), and (4″) may be satisfied. By making such arrangement, it is possible to achieve a similar effect.

It is preferable that the wide-angle optical system of the present embodiment include a first air lens, wherein the first air lens be an air lens which satisfies following conditional expression (5), and the third lens unit be provided with the first air lens:

1.0<D31/fL<10.0 (5)

where,

D31 denotes a distance on an optical axis between the surface on the object side of the object-side lens component and a surface on the object side of the first air lens, and

fL denotes the focal length of the wide-angle optical system at the first position.

The first air lens is an air lens which satisfies conditional expression (5). Even by providing the third lens unit with the first air lens, it is possible to correct the spherical aberration and the coma favorably while lowering the light-ray height in the predetermined range. Consequently, it is possible to realize a wide-angle optical system which has a high resolution. Moreover, even by using an image sensor with a large number of pixels is used, it is possible to acquire a sharp image corresponding to the large number of pixels.

On the other hand, in a case in which a value exceeds an upper limit value of conditional expression (5), an overall length of the optical system becomes long. In a case in which the value falls below a lower limit value of conditional expression (5), the light-ray height becomes high. Consequently, the outer diameter of the second lens unit and the outer diameter of a part of the third lens unit become large. As a result, the outer diameter of the optical unit increases.

It is preferable that following conditional expression (5′) be satisfied instead of conditional expression (5).

1.4<D31/fL<8.0 (5′)

Moreover, it is more preferable that following conditional expression (5″) be satisfied instead of conditional expression (5).

1.75<D31/fL<7.0 (5″)

An optical system which satisfies conditional expression (5) has a value larger than the lower limit value. As the value in the optical system becomes larger, it becomes easier to suppress the light-ray height to be lower in that optical system.

For conditional expression (5), it is possible to set a favorable lower limit value. It is preferable to set the lower limit value to any of 1.83800, 2.0, 2.5, and 3.0. Moreover, from 3.0 up to 6.0 can be said to be the most suitable range for conditional expression (5).

Instead of providing the first air lens, a negative lens is provided on the image side of the cemented lens having a negative refractive power which is located nearest to the image in the third lens unit. Moreover, the surface on the object side of the first air lens in the D31 is replaced by a surface on the object side of the negative lens. By satisfying any of conditional expressions (5), (5′), and (5″) with the replacement carried out, it is possible to achieve a similar effect.

In the wide-angle optical system of the present embodiment, it is preferable that the cemented lens having a positive refractive power be disposed on the object side of the cemented lens having a negative refractive power.

In this case, the third lens unit includes in order from the object side, the cemented lens having a positive refractive power and the cemented lens having a negative refractive power. By making such arrangement, it is possible to realize a wide-angle optical system in which an angle of view is large, and an aberration within the range of adjustment of the focal position is corrected favorably, and which has a high resolution. Moreover, it is possible to lower the light-ray height in the predetermined range.

The cemented lens having a positive refractive power and the cemented lens having a negative refractive power may be adjacent.

As mentioned above, by satisfying conditional expression (1) or by satisfying any of conditional expressions (2) to (5) in addition to conditional expression (1), it is possible to suppress the light-ray height to be low in the predetermined range without various aberrations being deteriorated. Preferable arrangements and conditional expressions for correcting various aberrations more favorably will be described below.

In a case in which conditional expression (1) is satisfied, an effect in which a light beam is converged becomes strong in the lens component located nearer the object of the third lens unit. Consequently, there is a possibility that securing a desired back focus becomes difficult or there is a possibility that correction of the spherical aberration becomes difficult.

Therefore, it is preferable that the third lens unit include at least one lens component having a negative refractive power. By making such arrangement, it is possible to secure easily the desired back focus or to correct the spherical aberration easily.

In the wide-angle optical system of the present embodiment, it is preferable that the third lens unit include a plurality of negative lenses.

As mentioned above, by the third lens unit including one negative lens, it is possible to secure easily the desired back focus or it is possible to correct the spherical aberration easily.

By the third lens unit including not less than two negative lenses, even in a case of satisfying conditional expression (1), it is possible to secure the desired back focus or it is possible to correct favorably not only the spherical aberration but also a curvature of field and a chromatic aberration.

In the wide-angle optical system of the present embodiment, it is preferable that the third lens unit include a plurality of positive lens components on the object side of a negative lens component which is nearest to the object.

The third lens unit includes the negative lens component nearest to the object. As mentioned above, by the third lens unit including one negative lens, it is possible to secure easily the desired back focus, or it is possible to correct the spherical aberration favorably.

Furthermore, by including the plurality of positive lens components on the object side of the negative lens component which is nearest to the object, it is possible to secure more easily the desired back focus without making the light-ray height high. Or, it is possible to correct the spherical aberration more favorably without making the light-ray height high.

Moreover, in a case in which the desired back focus is secured adequately and the spherical aberration is corrected adequately, it is possible to suppress the light-ray height to be further lower.

In the wide-angle optical system of the present embodiment, it is preferable that the cemented lens having a positive refractive power be disposed on the object side of the negative lens component which is nearest to the object, and following conditional expression (6) be satisfied:

0.5<f3C/fL<15 (6)

where,

f3C denotes a focal length of the cemented lens having a positive refractive power, and

fL denotes the focal length of the wide-angle optical system at the first position.

The third lens unit includes the negative lens component nearest to the object. As mentioned above, by the third lens unit including one negative lens, it is possible to secure easily the desired back focus or it is possible to correct the spherical aberration easily.

Furthermore, by disposing the cemented lens having a positive refractive power on the object side of the negative lens component which is nearest to the object, and satisfying conditional expression (6), it is possible to prevent the coma from being deteriorated.

In a case in which a value exceeds an upper limit value of conditional expression (6), an effect of suppressing the light-ray height to be lower is weakened. In a case in which the value falls below than a lower limit value of conditional expression (6), an effect of suppressing an occurrence of the coma is weakened.

It is preferable that following conditional expression (6′) be satisfied instead of conditional expression (6).

0.5<f3C/fL<12 (6′)

Moreover, it is more preferable that following conditional expression (6″) be satisfied instead of conditional expression (6).

0.5<f3C/fL<10.5 (6″)

An optical system which satisfies conditional expression (6) has a value smaller than the upper limit value. As the value in the optical system becomes smaller, it becomes easier to suppress the light-ray height to be lower in that optical system.

For conditional expression (6), it is possible to set a favorable upper limit value. It is preferable to set the upper limit value to any of 10.13971, 9.0, 8.0, and 7.0. Moreover, from 1.5 up to 6.0 can be said to be the most suitable range for conditional expression (6).

In the wide-angle optical system of the present embodiment, it is preferable that the third lens unit include a first lens component, a second lens component, and a third lens component, the first lens component be a single lens, and the second lens component and the third lens component be cemented lenses.

The wide-angle optical system of the present embodiment satisfies conditional expression (1). Accordingly, in the wide-angle optical system of the present embodiment, it is possible to realize a state in which the light-ray height has been maintained to be low in the predetermined range. By making the first lens component a single lens and the second lens component and the third lens component cemented lenses, it is possible to correct favorably various aberrations, and particularly the chromatic aberration and the curvature of field while maintaining the state of the low right-ray height in the predetermined range.

In the wide-angle optical system of the present embodiment, it is preferable that the third lens unit include a plurality of positive lenses, the plurality of positive lenses include a first positive lens and a second positive lens, the first positive lens, among the plurality of positive lenses, be a positive lens located nearest to the object, the second positive lens, among the plurality of positive lenses, be a positive lens located second from the object, and following conditional expression (7) be satisfied:

−70<ν_{31P}−V_{32P}<20 (7)

where,

ν_{31P} denotes an Abbe number for the first positive lens, and

ν_{32P} denotes an Abbe number for the second positive lens.

As mentioned above, in the case in which conditional expression (1) is satisfied, the effect in which a light beam is converged becomes strong in the lens component located nearer the object of the third lens unit. Consequently, there is a possibility that securing a desired back focus becomes difficult or there is a possibility that correction of the spherical aberration becomes difficult. Moreover, in some cases, it becomes difficult to correct favorably a longitudinal chromatic aberration and a chromatic aberration of magnification at the same time.

By satisfying conditional expression (7), even in the case in which conditional expression (1) is satisfied, it is possible to secure the desired back focus or it is possible to correct favorably not only the spherical aberration but also the longitudinal chromatic aberration and the chromatic aberration of magnification at the same time.

In a case in which a value exceeds an upper limit value of conditional expression (7), the longitudinal chromatic aberration is susceptible to have a tendency to be corrected excessively or the chromatic aberration of magnification is susceptible to have a tendency to be corrected inadequately. In a case in which the value falls below a lower limit value of conditional expression (7), the longitudinal chromatic aberration is susceptible to have a tendency to be corrected inadequately or the chromatic aberration of magnification is susceptible to have a tendency to be corrected excessively. In both cases, it is disadvantageous from a viewpoint of realization of a wide-angle optical system having a high resolution. Moreover, even when an image sensor with a large number of pixels is used, it is disadvantageous from a viewpoint of acquiring a sharp image corresponding to the large number of pixels.

It is preferable that following conditional expression (7′) be satisfied instead of conditional expression (7).

−65<ν_{31P}−ν_{32P}<15 (7′)

Moreover, it is more preferable that following conditional expression (7″) be satisfied instead of conditional expression (7).

−60 <ν_{31P-}ν_{32P}<10 (7″)

An optical system which satisfies conditional expression (7) has a value smaller than an upper limit value. As the value in the optical system becomes smaller, it becomes easier to correct the longitudinal chromatic aberration and the chromatic aberration of magnification more favorably at the same time in that optical system.

For conditional expression (7), it is possible to set a favorable upper limit value. It is preferable to set the upper limit value to any of 6.35, 0.0, −8.0, and −15.0. Moreover, from −60.0 to −20.0 can be said to be the most suitable range for conditional expression (7).

In the wide-angle optical system of the present embodiment, it is preferable that the third lens unit include a plurality of positive lenses, the plurality of positive lenses include a first positive lens, a second positive lens, and a third positive lens, the first positive lens, among the plurality of positive lenses, be a positive lens located nearest to the object, the second positive lens, among the plurality of positive lenses, be a positive lens located second from the object, the third positive lens, among the plurality of positive lenses, be a positive lens located third from the object, and following conditional expression (8) be satisfied:

−40<ν_{33P}−(ν_{31P}+ν_{32P})/2<60 (8)

where,

ν_{31P} denotes the Abbe number for the first positive lens,

ν_{32P} denotes the Abbe number for the second positive lens, and

ν_{33P} denotes an Abbe number for the third positive lens.

As mentioned above, in the case in which conditional expression (1) is satisfied, the effect in which a light beam is converged becomes strong in the lens component located nearer the object of the third lens unit. Consequently, there is a possibility that securing the desired back focus becomes difficult or there is a possibility that correction of the spherical aberration becomes difficult. Moreover, in some cases, it becomes difficult to correct the longitudinal chromatic aberration and the chromatic aberration of magnification at the same time.

By satisfying conditional expression (8), even in the case in which conditional expression (1) is satisfied, it is possible to secure the desired back focus or it is possible to correct favorably not only the spherical aberration but also the longitudinal chromatic aberration and the chromatic aberration of magnification at the same time.

In a case in which a value exceeds an upper limit value of conditional expression (8), the longitudinal chromatic aberration is susceptible to have a tendency to be corrected inadequately or the chromatic aberration of magnification is susceptible to have a tendency to be corrected excessively. In a case in which the value falls below a lower limit value of conditional expression (8), the longitudinal chromatic aberration is susceptible to have a tendency to be corrected inadequately or the chromatic aberration of magnification is susceptible to have a tendency to be corrected excessively. In both cases, it is disadvantageous from a viewpoint of realization of a wide-angle optical system having a high resolution. Moreover, even when an image sensor with a large number of pixels is used, it is disadvantageous from a viewpoint of acquiring a sharp image corresponding to the large number of pixels.

It is preferable that following conditional expression (8′) be satisfied instead of conditional expression (8).

−35 <ν_{33P}−(ν_{31P}+ν_{32P})/2<60 (8′)

Moreover, it is more preferable that following conditional expression (8″) be satisfied instead of conditional expression (8).

−32<ν_{33P}−(ν_{31P}+ν_{32P})/2<60 (8″)

An optical system which satisfies conditional expression (8) has a value larger than a lower limit value. As the value in the optical system becomes larger, it becomes easier to correct the longitudinal chromatic aberration and the chromatic aberration of magnification more favorably at the same time in that optical system.

For conditional expression (8), it is possible to set a favorable lower limit value. It is preferable to set the lower limit value to any of −31.01, −5.0, 0.0, and 5.0. Moreover, from 10.0 up to 60.0 can be said to be the most suitable range for conditional expression (8).

In the wide-angle optical system of the present embodiment, it is preferable that the third lens unit include a plurality of negative lenses, the plurality of negative lenses include a first negative lens and a second negative lens, the first negative lens, among the plurality of negative lenses, be a negative lens located nearest to the object, the second negative lens, among the plurality of negative lenses, be a negative lens located second from the object, and following conditional expression (9) be satisfied:

−10<ν_{31N}−ν_{32N}<40 (9)

where,

ν_{31N} denotes an Abbe number for the first negative lens, and

ν_{32N} denotes an Abbe number for the second negative lens.

As mentioned above, in the case in which conditional expression (1) is satisfied, the effect in which a light beam converged becomes strong in the lens component located nearer the object of the third lens unit. Consequently, there is a possibility that securing the desired back focus becomes difficult or there is a possibility that correction of the spherical aberration becomes difficult. Moreover, in some cases, it becomes difficult to correct the longitudinal chromatic aberration and the chromatic aberration of magnification at the same time.

By satisfying conditional expression (9), even in the case in which conditional expression (1) is satisfied, it is possible to secure the desired back focus or it is possible to correct favorably not only the spherical aberration but also the longitudinal chromatic aberration and the chromatic aberration of magnification at the same time.

In a case in which a value exceeds an upper limit value of conditional expression (9), the longitudinal chromatic aberration is susceptible to have a tendency to be corrected inadequately or the chromatic aberration of magnification is susceptible to have a tendency to be corrected excessively. In a case in which the value falls below a lower limit value of conditional expression (9), the longitudinal chromatic aberration is susceptible to have a tendency to be corrected inadequately or the chromatic aberration of magnification is susceptible to have a tendency to be corrected excessively. In both cases, it is disadvantageous from a viewpoint of realization of a wide-angle optical system having a high resolution. Moreover, even when an image sensor with a large number of pixels is used, it is advantageous from a viewpoint of acquiring a sharp image corresponding to the large number of pixels.

It is preferable that following conditional expression (9′) be satisfied instead of conditional expression (9).

−7<ν_{31N}−ν_{32N}<40 (9′)

Moreover, it is more preferable that following conditional expression (9″) be satisfied instead of conditional expression (9).

−4<μ_{31N}−ν_{32N}<40 (9″)

An optical system which satisfied conditional expression (9) has a value larger than a lower limit value. As the value in the optical system becomes larger, it becomes easier to correct more favorably the longitudinal chromatic aberration and the chromatic aberration of magnification in that optical system.

For conditional expression (9), it is possible to set a favorable lower limit value. It is preferable to set the lower limit value to any of −9.46, −5.0, 0.0, and 5.0. Moreover, from 10.0 up to 40.0 can be said to be the most suitable range for conditional expression (9).

In the wide-angle optical system of the present embodiment, it is preferable that the third lens unit include not less than three positive lenses on the image side of a negative lens component which is nearest to the image.

As mentioned above, in the case in which conditional expression (1) is satisfied, the effect in which a light beam is converged becomes strong in the lens component located nearer the object of the third lens unit. Consequently, there is a possibility that securing the desired back focus becomes difficult or there is a possibility that correction of the spherical aberration becomes difficult. Moreover, in some cases, it becomes difficult to correct the curvature of field and the chromatic aberration. In correction of the chromatic aberration, particularly, correction of the chromatic aberration of magnification becomes difficult.

By including not less than three positive lenses on the image side of the negative lens component which is nearest to the image, it is possible to secure the desired back focus more easily without making the light-ray height high. Or, it is possible to correct not only the spherical aberration but also the curvature of field and the chromatic aberration more favorably without making the light-ray height high. In the correction of the chromatic aberration, it is possible to correct, particularly, the chromatic aberration of magnification more favorably.

It is preferable that the wide-angle optical system of the present embodiment include a second air lens, wherein the second air lens be an air lens which satisfies following conditional expression (10), and the third lens unit be provided with the second air lens:

−3.0<SF_{RA}<5.0 (10)

where,

SF _{RA}=(R_{RAF}+R_{RAR})/(R_{RAF}−R_{RAR}),

R_{RAF} denotes a radius of curvature of a surface on the object side of the second air lens, and

R_{RAR} denotes a radius of curvature of a surface on the image side of the second air lens.

As mentioned above, the air layer is formed between the two adjacent lenses. The refractive index of the air layer is smaller than the refractive index of two lenses. Accordingly, the air layer functions as a lens. The air layer is an air lens. The surface on the object side of the air lens is a lens surface of a lens located on the object side of the air layer. A surface on the image side of the air layer is a lens surface of a lens located on the image side of the air layer.

However, in the second air lens, the lens located on the object side and the lens located on the image side are a single lens or a cemented lens. An air layer is formed also between a lens and a plane parallel plate. Such air layer is not included in the second air lens.

As mentioned above, in the case in which conditional expression (1) is satisfied, the effect in which a light beam is converged becomes strong in the lens component located nearer the object of the third lens unit. Consequently, there is a possibility that securing the desired back focus becomes difficult or there is a possibility that correction of the spherical aberration becomes difficult. Moreover, in some cases, it becomes difficult to correct an astigmatism and the coma.

By satisfying conditional expression (10), even in the case in which conditional expression (1) is satisfied, it is possible to secure the desired back focus or it is possible to correct not only the spherical aberration but also the astigmatism and the coma favorably.

In a case in which a value exceeds an upper limit value of conditional expression (10), it is susceptible to be disadvantageous from a viewpoint of correction of the astigmatism and the coma, and in a case in which the value falls below a lower limit value, it is susceptible to be disadvantageous from a viewpoint of suppressing the light-ray height to be low.

A plurality of air layers is formed in the third lens unit. At least one of the plurality of air layers may be the second air lens.

The second air lens may be an air layer having a biconcave shape or an air layer having a meniscus shape. Or, the second air lens may be an air layer located fourth from the object side or an air layer located fifth from the object side.

It is preferable that following conditional expression (10′) be satisfied instead of conditional expression (10).

−2.0 <SF_{RA}<4.0 (10′)

Moreover, it is more preferable that following conditional expression (10″) be satisfied instead of conditional expression (10).

−1.5<SF_{RA}<3.0 (10″)

An optical system which satisfies conditional expression (10) has a value smaller than the upper limit value. As the value in the optical system becomes smaller, it becomes easier to correct the astigmatism and the coma more favorably in that optical system.

For conditional expression (10), it is possible to set a favorable upper limit value. It is preferable to set the upper limit value to any of 1.72684, 1.4, 1.2, and 1.0. Moreover, from −0.7 up to 1.0 can be said to be the most suitable range for conditional expression (10).

In the wide-angle optical system of the present embodiment, it is preferable that the third lens unit be fixed at the time of focal-position adjustment.

The number of lens components is large in the third lens unit. Moreover, in the third lens unit, there is a strong tendency of a manufacturing-error sensitivity becoming high. Therefore, it is preferable to make the third lens unit fixed at the time of focal-position adjustment.

As mentioned above, by satisfying conditional expression (1) or by satisfying any of conditional expressions (2) to (5) in addition to conditional expression (1), it is possible to suppress the light-ray height to be low over the predetermined range without various aberrations being deteriorated.

Preferable arrangements and conditional expressions for the first lens unit and preferable arrangements and conditional expressions for the second lens unit will be described below.

In the wide-angle optical system of the present embodiment, it is preferable that following conditional expression (11) be satisfied:

−50<(R21F+R21R)/(R21F−R21R)<−1.0 (11)

where,

R21F denotes a radius of curvature of a surface on the object side of a predetermined lens component,

R21R denotes a radius of curvature of a surface on the image side of the predetermined lens component, and

the predetermined lens component is a lens component located nearest to the object in the second lens unit.

In a case in which a value exceeds an upper limit value of conditional expression (11), a variation in the spherical aberration at the time of focal-position adjustment or a variation in the astigmatism is susceptible to become large. In a case in which the value falls below a lower limit value of conditional expression (11), a deterioration of the astigmatism and a deterioration of the coma due to decentering are susceptible to occur. As mentioned above, the decentering occurs due to a movement of the second lens unit.

It is preferable that following conditional expression (11′) be satisfied instead of conditional expression (11).

−40<(R21F+R21R)/(R21F−R21R)<−1.5 (11′)

Moreover, it is more preferable that following conditional expression (11″) be satisfied instead of conditional expression (11).

−30<(R21F+R21R)/(R21F−R21R)<−2.5 (11″)

An optical system which satisfies conditional expression (11) has a value smaller than the upper limit value. As the value in the optical system becomes smaller, it becomes easier to correct the spherical aberration or the astigmatism at the time of focal-position adjustment more favorably in that optical system.

For conditional expression (11), it is possible to set a favorable upper limit value. It is preferable to set the upper limit value to any of −4.89211, −5.0, −6.0, and −7.0. Moreover, from −30.0 up to −8.0 can be said to be the most suitable range for conditional expression (11)

In the wide-angle optical system of the present embodiment, it is preferable that following conditional expression (12) be satisfied:

0.0<D21/fL<3.0 (12)

where,

D21 denotes a distance on an optical axis between a surface nearest to the object and a surface nearest to the image of the second lens unit, and

fL denotes the focal length of the wide-angle optical system at the first position.

In a case in which a value exceeds an upper limit value of conditional expression (12), a weight of the second lens unit increases or the light-ray height becomes high. As just described, it is susceptible to become disadvantageous from a viewpoint of suppressing the increase in the weight of the second lens unit or suppressing the increase in the light-ray height.

In a case in which the value falls below a lower limit value of conditional expression (12), it becomes difficult to achieve two controls. One control is suppressing the variation in the spherical aberration at the time of focal-position adjustment or suppressing the variation in the astigmatism. The other control is suppressing the deterioration of the coma due to decentering or suppressing the deterioration of the astigmatism. The decentering occurs due to a movement of a moving unit at the time of focal-position adjustment.

It is preferable that following conditional expression (12′) be satisfied instead of conditional expression (12).

0.2<D21/fL<2.5 (12′)

Moreover, it is more preferable that following conditional expression (12″) be satisfied instead of conditional expression (12).

0.4<D21/fL<2.0 (12″)

An optical system which satisfies conditional expression (12) has a value larger than the lower limit value. As the value in the optical system becomes larger, it becomes easier to achieve both of the abovementioned controls in that optical system.

For conditional expression (12), it is preferable to set a favorable lower limit value. It is preferable to set the lower limit value to any of 0.416786, 0.42, 0.43, and 0.44. Moreover, from 0.45 up to 2.0 can be said to be the most suitable range for conditional expression (12).

In the wide-angle optical system of the present embodiment, it is preferable that following conditional expression (13) be satisfied:

1.01<β2F<1.35 (13)

where,

β2F denotes a magnification of the second lens unit at the first position.

In a case in which a value exceeds an upper limit value of conditional expression (13), an amount of focus movement with respect to the amount of movement of the second lens unit (hereinafter, referred to as ‘focusing sensitivity’) becomes excessively high. In this case, an accuracy at the time of stopping the second lens unit (hereinafter, referred to as ‘stopping accuracy’) becomes excessively high. Consequently, a moving mechanism becomes complicated.

In a case in which a value falls below a lower limit value of conditional expression (13), the focusing sensitivity is susceptible to become low. In this case, since the amount of movement of the second lens unit increases, a space for the movement has to be made wide. Consequently, an optical unit becomes large.

It is preferable that following conditional expression (13′) be satisfied instead of conditional expression (13).

1.03<β2F<1.30 (13′)

Moreover, it is more preferable that following conditional expression (13″) be satisfied instead of conditional expression (13″).

1.05<β2F<1.25 (13″)

In the wide-angle optical system of the present embodiment, it is preferable that following conditional expression (14) be satisfied:

1.01<β2N/β2F<1.15 (14)

where,

β2F denotes the magnification of the second lens unit at the first position, and

β2N denotes a magnification of the second lens unit at the second position.

In a case in which conditional expression (14) is satisfied, since a focal length at a far point becomes short, it is possible to secure a wide angle of view at a far point. Moreover, since a focal length at a near point becomes long, it is possible to achieve a high magnification at a near point.

An optical system having a wide angle of view at a far point and a high magnification at a near point is appropriate for an optical system of an endoscope. Therefore, it is possible to use the wide-angle optical system of the present embodiment as an optical system for an endoscope.

In an endoscope, for instance, by observing a wide range, it is checked if there is a lesion part. Moreover, when it is confirmed that there is a lesion part, the lesion part is magnified and observed in detail. Therefore, it is preferable that an optical system of an endoscope have a wide angle of view for a far-point observation, and have a high magnification for a near-point observation.

Moreover, in the near-point observation, it is necessary to observe a lesion part in detail. Therefore, in an optical system for an endoscope, it is preferable to have an ability to focus with a high accuracy.

In a case in which a value exceeds an upper limit value of conditional expression (14), the focusing sensitivity at a near-point side becomes high. In this case, the stopping accuracy at the near-point side becomes high. Consequently, it becomes difficult to focus with high accuracy. In a case in which the value falls below a lower limit value of conditional expression (14), securing a wide-angle of view in the far-point observation and securing a high magnification in the near-point observation become difficult. Consequently, it becomes inappropriate for an optical system of an endoscope.

It is preferable that following conditional expression (14′) be satisfied instead of conditional expression (14).

1.02<β2N/β2F<1.12 (14′)

Moreover, it is more preferable that following conditional expression (14″) be satisfied instead of conditional expression (14).

1.03<β2N/β2F<1.09 (14″)

In the wide-angle optical system of the present embodiment, it is preferable that following conditional expression (15) be satisfied:

0.10<(1β2F²)×β3F²<0.35 (15)

where,

β2F denotes the magnification of the second lens unit at the first position, and

β3F denotes a magnification of the third lens unit at the first position.

In a case in which a value exceeds an upper limit value of conditional expression (15), the focusing sensitivity at the far-point side becomes excessively high. In this case, the stopping accuracy at the far-point side becomes high. In a case in which the value falls below a lower limit value of conditional expression (15), the focusing sensitivity at the far-point side is susceptible to become low. In this case, since the amount of movement of the second lens unit increases, the space for the movement has to be made wide. Consequently, the optical unit becomes large.

It is preferable that following conditional expression (15′) be satisfied instead of conditional expression (15).

0.10<(1−β2F²)×β3F²<0.30 (15′)

Moreover, it is more preferable that following conditional expression (15″) be satisfied instead of conditional expression (15).

0.10<(1β2F²)×β3F²<0.25 (15″)

In the wide-angle optical system of the present embodiment, it is preferable that following conditional expression (16) be satisfied:

0.20<(1β2N²)×β3N²<0.50 (16)

where,

β2N denotes the magnification of the second lens unit at the second position, and

β3N denotes a magnification of the third lens unit at the second position.

In a case in which a value exceeds an upper limit value of conditional expression (16), the focusing sensitivity at the near-point side becomes excessively high. In this case, the stopping accuracy at the near-point side becomes high. In a case in which the value falls below a lower limit value of conditional expression (16), the focusing sensitivity at the near-point side is susceptible to become low. In this case, since the amount of movement of the second lens unit increases, the space for the movement has to be made wide.

It is preferable that following conditional expression (16′) be satisfied instead of conditional expression (16).

0.20<(1−β2N²)×β3N²<0.45 (16′)

Moreover, it is more preferable that following conditional expression (16″) be satisfied instead of conditional expression (16).

0.20<(1−β2N²)×β3N²<0.40 (16″)

In the wide-angle optical system of the present embodiment, it is preferable that the second lens unit have a positive refractive power.

By making such arrangement, it is possible to reduce the variation in the astigmatism at the time of focal-position adjustment.

In the wide-angle optical system of the present embodiment, it is preferable that the first lens unit include a plurality of negative lenses.

It is not necessary to dispose an actuator in the first lens unit. However, for securing a wide angle of view, an outer diameter of the first lens unit is susceptible to become large. For making the outer diameter of the first lens unit small, a negative refractive power of the first lens unit is to be made large. When the negative refractive power of the first lens unit is made large, an off-axis aberration, particularly the astigmatism, is susceptible to occur.

By disposing the plurality of negative lenses in the first lens unit, it is possible to distribute the negative refractive power of the first lens unit to the plurality of negative lenses. As a result, even when the negative refractive power of the first lens unit is made large, it is possible to correct the off-axis aberration, particularly the astigmatism, favorably.

In the wide-angle optical system of the present embodiment, it is preferable that the first lens unit include a plurality of negative lens components, the plurality of negative lens components include a first negative lens component and a second negative lens component, and the second negative lens component, among the plurality of negative lens components, be a negative lens component located second from an object.

By disposing the plurality of negative lens components in the first lens unit, it is possible to distribute the negative refractive power of the first lens unit to the plurality of negative lens components. As a result, even when the negative refractive power of the first lens unit is made strong, it is possible to correct the off-axis aberration, particularly the astigmatism, favorably.

In the wide-angle optical system of the present embodiment, it is preferable that the first lens unit include a plurality of negative lens components and a positive lens component, or include a plurality of negative lens components, the plurality of negative lens components include a first negative lens component and a second negative lens component, the second negative lens component, among the plurality of negative lens components, be a negative lens component located second from the object.

By making such arrangement, it is possible to correct favorably the off-axis aberration, particularly the astigmatism and the chromatic aberration of magnification, while reducing the outer diameter of the first lens unit.

For securing a wide angle of view and for suppressing the light-ray height in an optical system to be low, it is necessary to impart a large negative refractive power to the first lens unit. In a case in which the first lens unit includes a plurality of negative lens components and a positive lens component, by disposing the plurality of negative lens components on the object side of the positive lens components, it is possible to suppress the light-ray height to be lower. As a result, it is possible to make small the outer diameter of the first lens unit.

In the wide-angle optical system of the present embodiment, it is possible to locate an optical element which does not have a refractive power, such as an optical filter, on the object side of the optical system or in the optical system. In a case of disposing the optical filter on the object side of the optical system, an outer diameter of the optical filter become almost same as the outer diameter of the first lens unit. As mentioned above, in the wide-angle optical system of the present embodiment, it is possible to make the outer diameter of the first lens unit small. Accordingly, it is possible to make the outer diameter of the optical filter small.

In the wide-angle optical system of the present embodiment, it is preferable that the first lens unit include a plurality of negative lens components, the plurality of negative lens components include a first negative lens component and a second negative lens component, the first negative lens component, among the plurality of negative lens component, be a negative lens component located nearest to the object, and the second negative lens component, among the plurality of negative lens components, be a negative lens component located second from the object.

For securing a wide angle of view and for suppressing the light-ray height in an optical system to be low, it is necessary to impart a large negative refractive power to the first lens unit. By disposing the first negative lens component and the second negative lens component in the first lens unit, it is possible to distribute the negative refractive power of the first lens unit to the two negative lens components. As a result, even when the negative refractive power of the first lens unit is made large, it is possible to correct the off-axis aberration, particularly the astigmatism, favorably.

The second negative lens component, for instance, is a single lens having a negative refractive power located second from the object or a cemented lens having a negative refractive power located second from the object. In a case in which the second negative lens component is a cemented lens, the cemented lens is formed by a positive lens and a negative lens. The positive lens may be located on the object side and the negative lens may be located on the object side.

In the wide-angle optical system of the present embodiment, it is preferable that following conditional expression (17) be satisfied:

−2.0<fL/R12F<5.0 (17)

where,

R12F denotes a radius of curvature of a surface on the object side of the second negative lens component, and

fL denotes the focal length of the wide-angle optical system at the first position.

In a case in which a value exceeds an upper limit value of conditional expression (17), the light-ray height in the first lens unit is susceptible to become high. In a case in which the value falls below a lower limit value of conditional expression (17), the astigmatism is susceptible to occur.

It is preferable that following conditional expression (17′) be satisfied instead of conditional expression (17).

−1.5<fL/R12F<4.6 (17′)

Moreover, it is more preferable that following conditional expression (17″) be satisfied instead of conditional expression (17).

−1.0<fL/R12F<4.2 (17″)

An optical system which satisfies conditional expression (17) has a value smaller than the upper limit value. As the value in the optical system becomes smaller, it becomes easier to suppress the light-ray height to be lower in that optical system.

For conditional expression (17), it is possible to set a favorable upper limit value. It is preferable to set the upper limit value to any of 4.158095, 3.0, 1.5, and 0.0. Moreover, from −0.5 up to −0.1 can be said to be the most suitable range for conditional expression (17).

For securing a wide angle of view and correcting an aberration favorably, it is preferable to make a lens surface located nearest to the object in the optical system a flat surface or a surface convex toward the object side. Moreover, an optical system which has such lens surface is appropriate as an optical system for an endoscope.

In a case in which the lens surface located nearest to the object is made the flat surface or the surface convex toward the object side, it is preferable to make an object-side surface of the second negative lens component a strong diverging surface. By satisfying conditional expression (17), it is possible to make the object-side surface of the second negative lens component a strong diverging surface.

In the wide-angle optical system of the present embodiment, it is preferable that following conditional expression (18) be satisfied:

100×|f_{fin}|<|R_{fin}| (18)

where,

f_{fin} denotes a focal length of an image-side lens component, and

R_{fin} denotes a radius of curvature of a surface on the image side of the image-side lens component, and

the image-side lens component, among the plurality of lens components, is a lens component located nearest to the image.

In the wide-angle optical system, the light-ray height is suppressed to be low in the predetermined range and moreover, an angle of incidence of a group of off-axis rays on an image plane is suppressed to be small. Therefore, an arrangement of refractive power in the third lens unit may be made a positive refractive power, a negative refractive power, and a positive refractive power from the object side, for instance.

In a case in which a value falls below a lower limit value of conditional expression (18), the astigmatism is deteriorated. Therefore, in a case in which the third lens unit has the abovementioned refractive power arrangement, particularly, it is desirable to satisfy conditional expression (18).

It is preferable that the wide-angle optical system of the present embodiment include the image-side lens component and an optical element having zero refractive power, wherein the image-side lens component, among the plurality of lens components, be located nearest to the image, the optical element be located on the image side of the image-side lens component, and the image-side lens component and the optical element be cemented.

In an optical system, an optical element having a zero refractive power is disposed between an image-side lens component and an image plane in many cases. An optical element having zero refractive power is an optical filter or a prism, for example. By cementing the image-side lens component and the optical element, it is possible to prevent degradation of an imaging performance due to decentering.

In the wide-angle optical system of the present embodiment, it is preferable that following conditional expression (19) be satisfied:

2×yₘₐₓ<fL×tan ωₘₐₓ (19)

where,

yₘₐₓ denotes a maximum image height,

ωₘₐₓ denotes an angle of view corresponding to the maximum image height, and

fL denotes the focal length of the wide-angle optical system at the first position.

The wide-angle optical system of the present embodiment is an optical system which has a high resolution and a small outer diameter, and an actuator necessary for the focal-position adjustment disposed therein. Accordingly, it is possible to use the wide-angle optical system of the present embodiment for an optical system of an endoscope.

For using the wide-angle optical system of the present embodiment for an optical system of an endoscope, it is preferable that an angle of view of not less than 100 degrees be secured, for instance. In an optical system having an angle of view of not less than 100 degrees, an occurrence of a distortion is acceptable. Accordingly, such optical system does not satisfy following expression (A). Expression (A) is a condition with no distortion.

Yₘₐₓ=fL×tan ωₘₐₓ (A)

Instead, the wide-angle optical system of the present embodiment satisfies conditional expression (19). By satisfying conditional expression (19), it is possible to make an outer diameter of an optical unit small while securing a wide angle of view. Accordingly, it is possible to use the wide-angle optical system of the present embodiment for an optical system of an endoscope.

In the wide-angle optical system of the present embodiment, it is preferable that following conditional expression (20) be satisfied:

ER<4×fL/F_{EX} (20)

where,

ER denotes an effective radius of a surface nearest to the image of the negative cemented lens,

F_{EX} denotes an effective F-value at the first position, and

fL denotes the focal length of the wide-angle optical system at the first position.

Conditional expression (20) is a conditional expression related to the light-ray height. By satisfying conditional expression (20), it is possible to use the wide-angle optical system of the present embodiment for an optical system of an endoscope. The effective radius is determined by the height of an outermost light ray in a plane.

An image pickup apparatus of the present embodiment includes an optical system, and an image sensor which is disposed on an image plane, wherein the image sensor has an image pickup surface, and converts an image formed on the image pickup surface by the optical system to an electric signal, and the optical system is the abovementioned wide-angle optical system.

According to the image pickup apparatus of the present embodiment, even when an image sensor with a large number of pixels is used, it is possible to acquire a sharp image corresponding to the large number of pixels.

Embodiments and examples of a wide-angle optical system will be described below in detail by referring to the accompanying diagrams. However, the present disclosure is not restricted to the embodiments and the examples described below.

Lens cross-sectional views of each example will be described below.

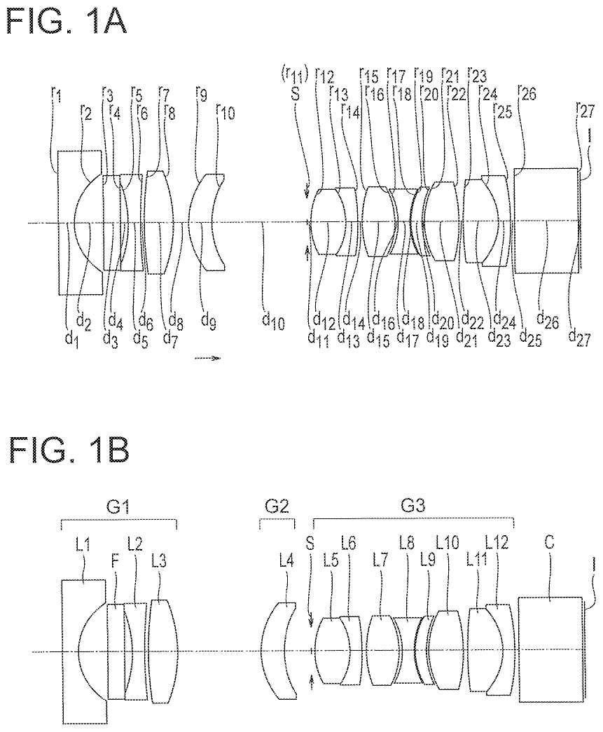

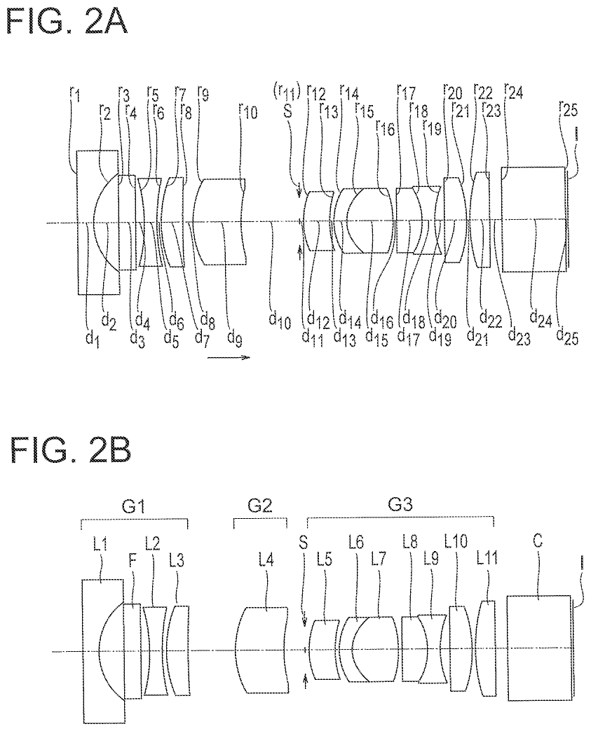

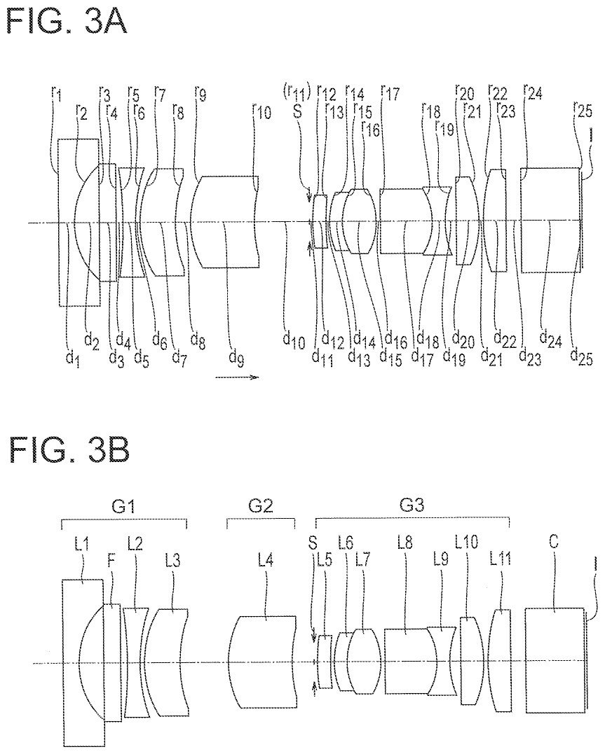

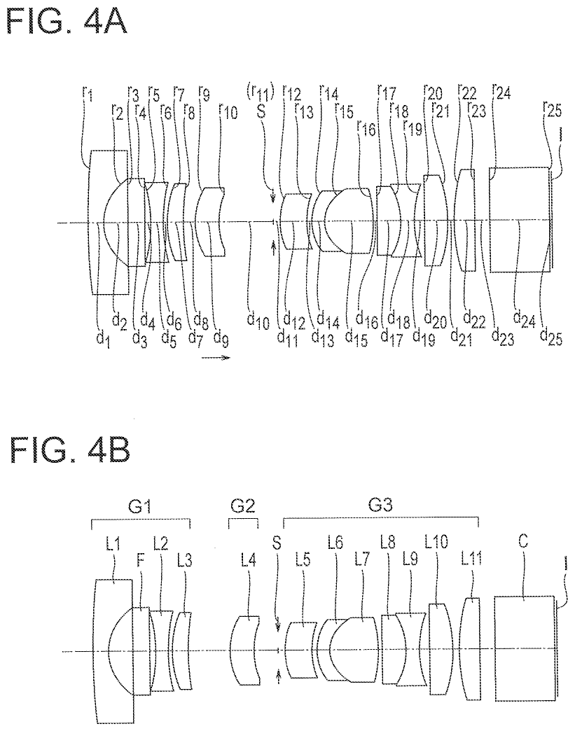

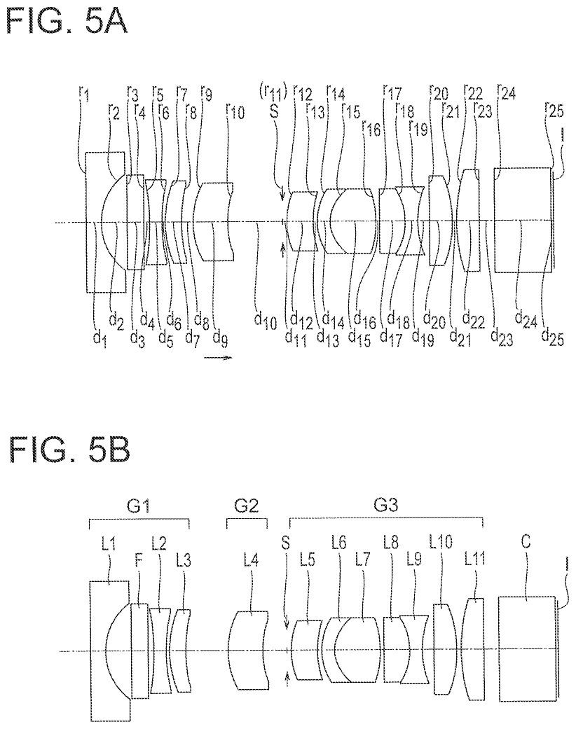

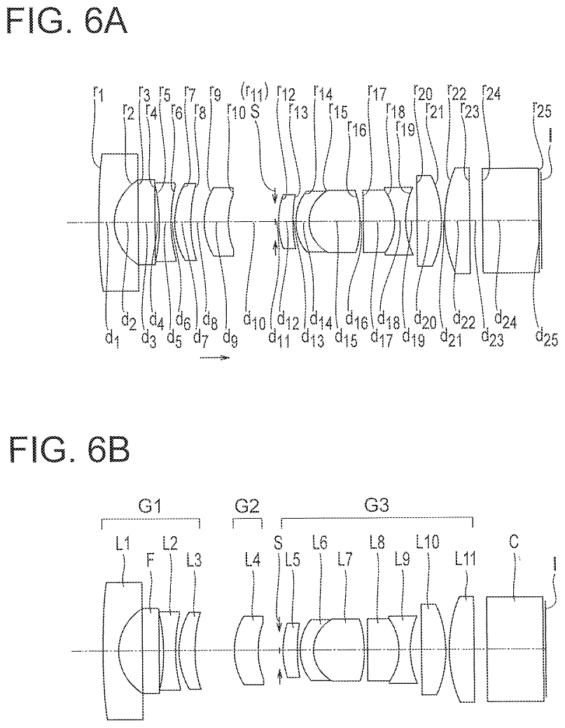

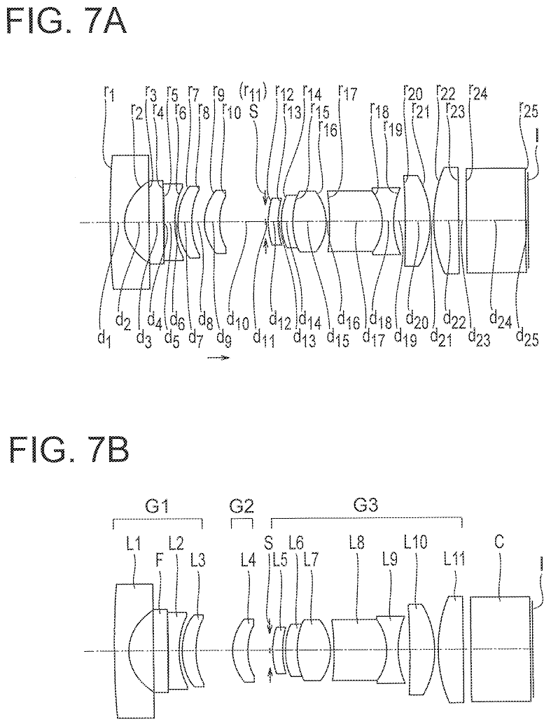

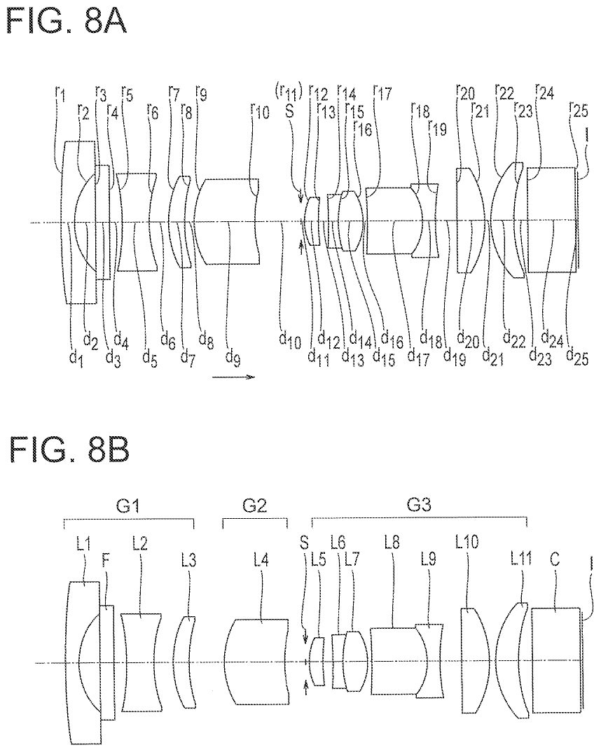

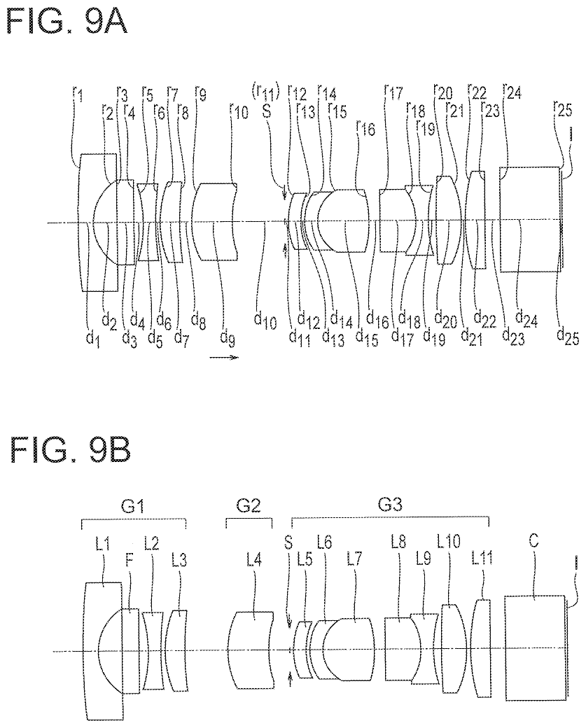

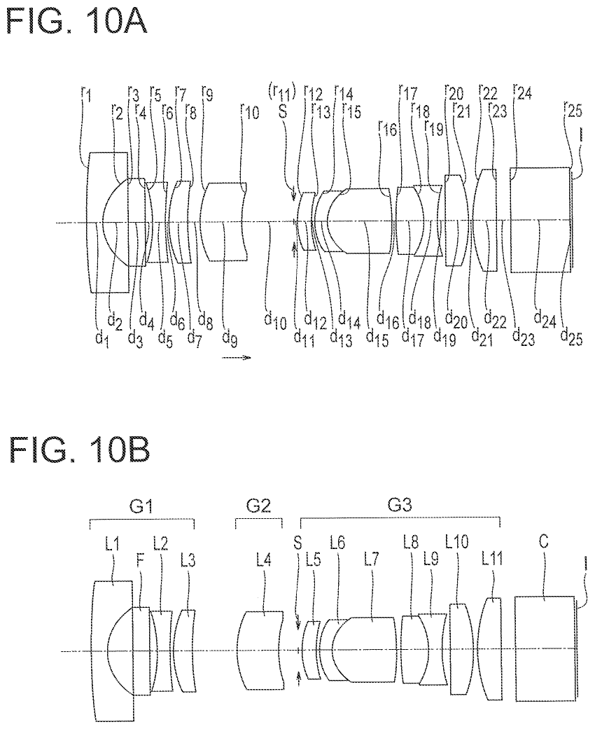

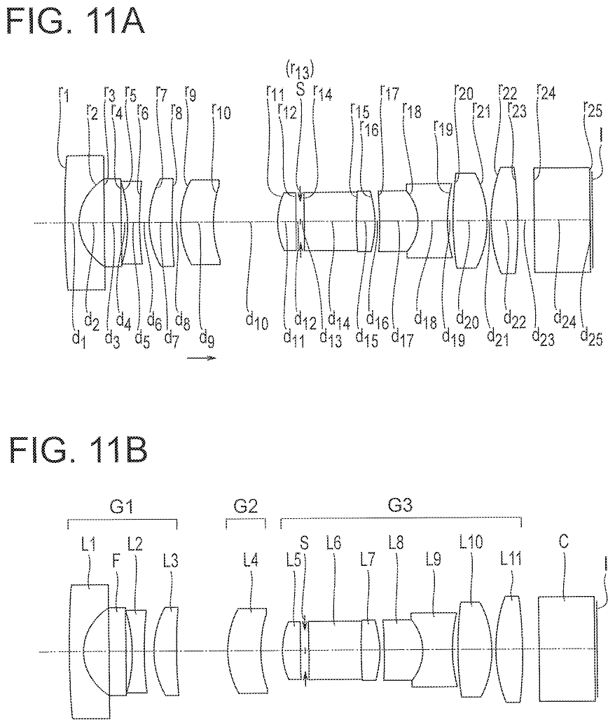

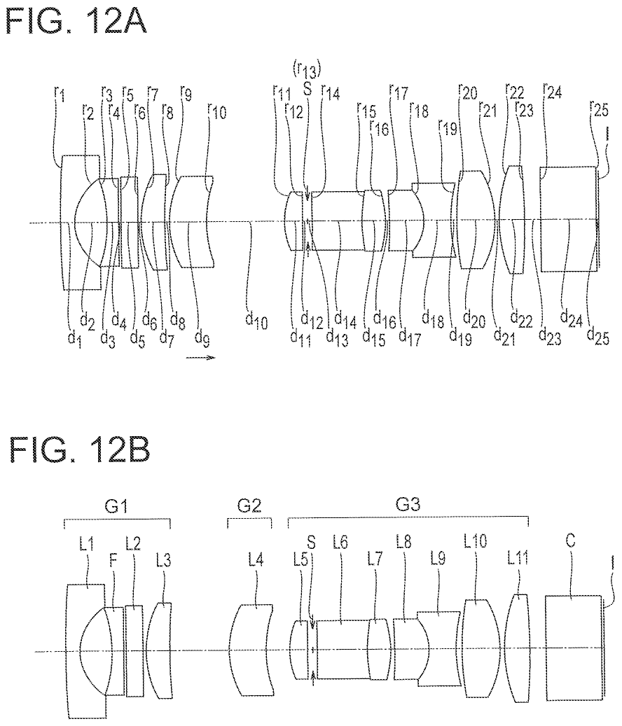

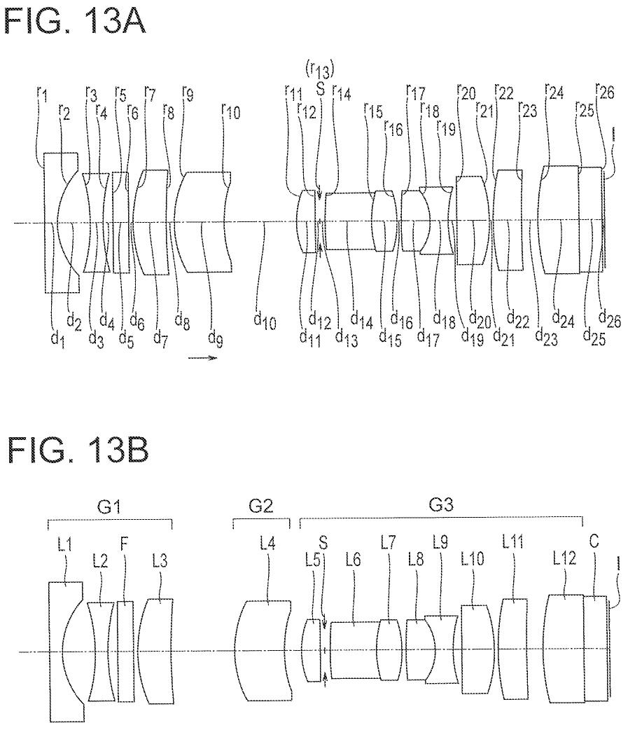

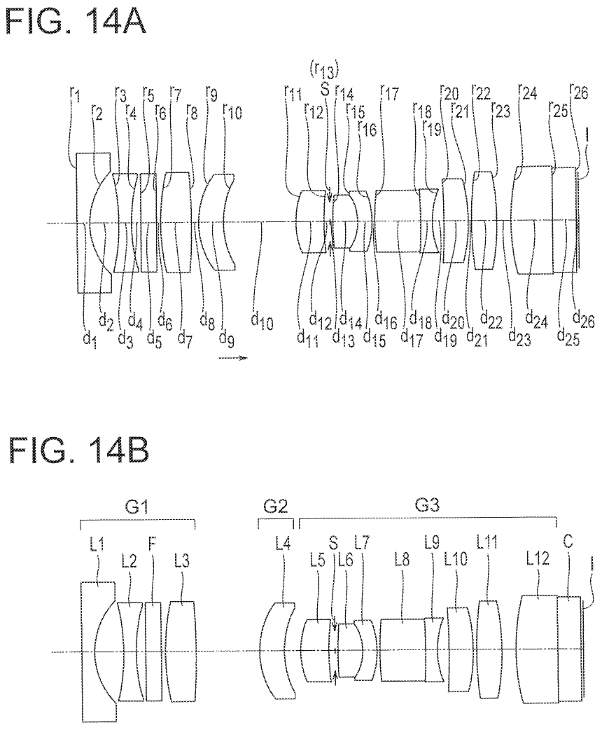

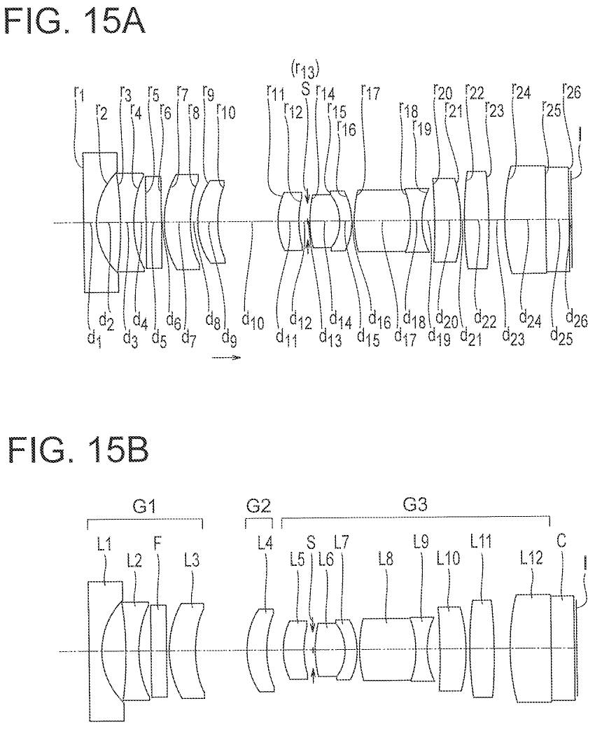

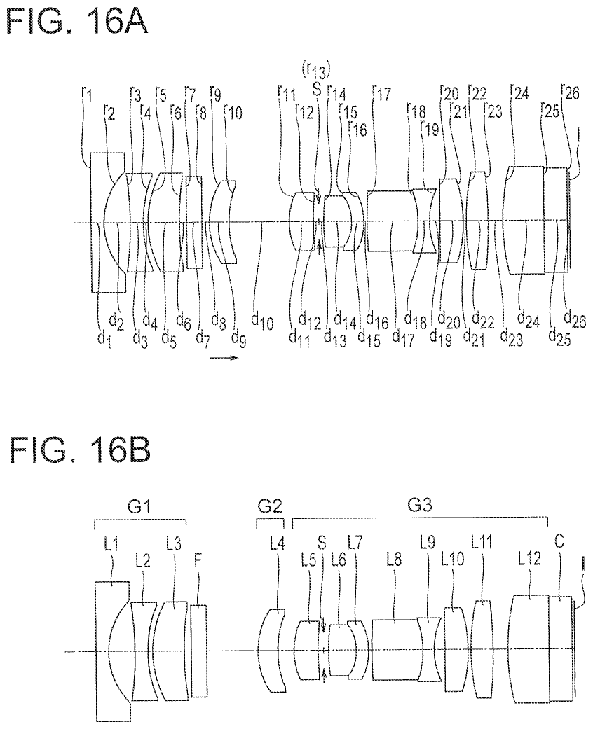

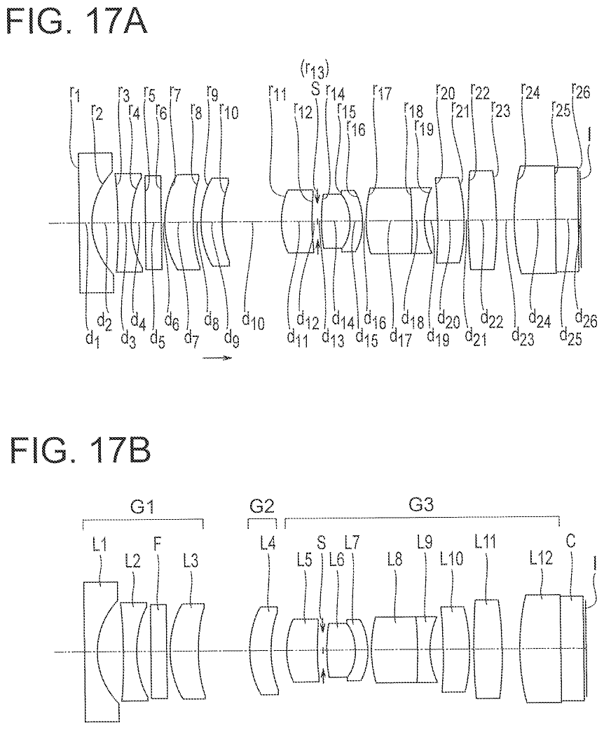

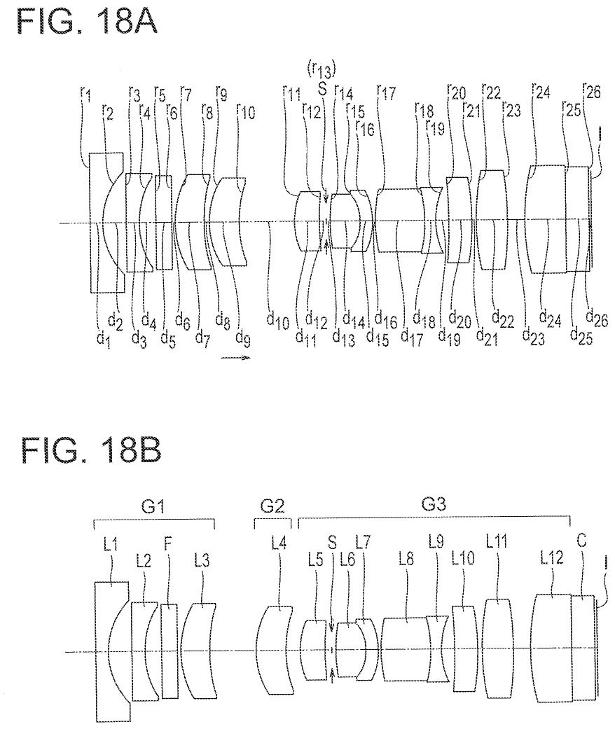

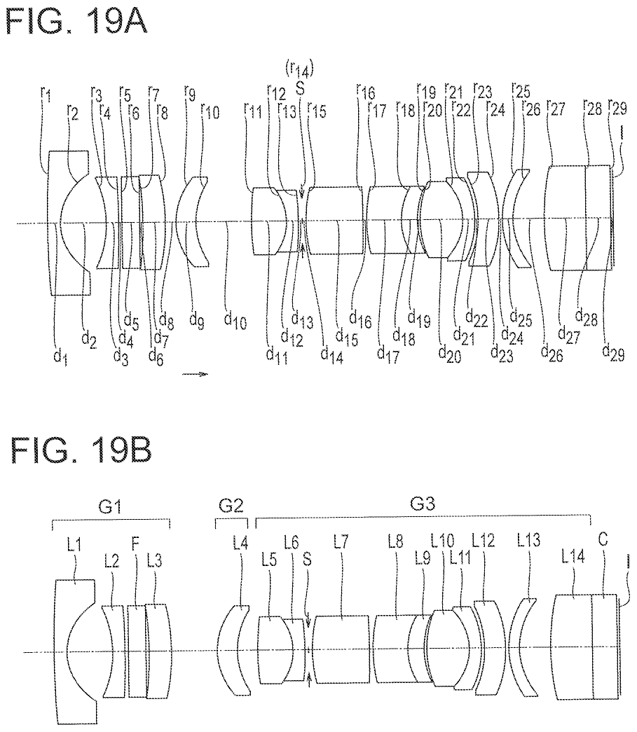

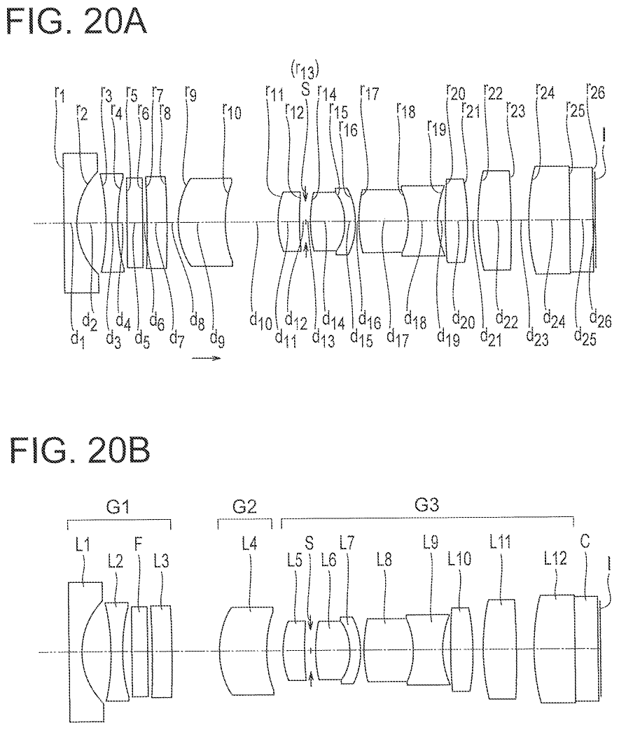

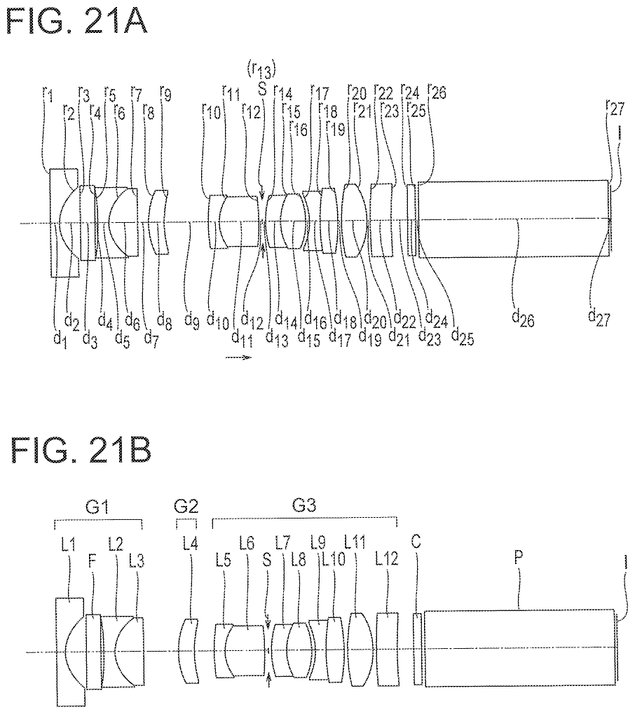

FIG. 1A, FIG. 2A, FIG. 3A, FIG. 4A, FIG. 5A, FIG. 6A, FIG. 7A, FIG. 8A, FIG. 9A, FIG. 10A, FIG. 11A, FIG. 12A, FIG. 13A, FIG. 14A, FIG. 15A, FIG. 16A, FIG. 17A, FIG. 18A, FIG. 19A, FIG. 20A, and FIG. 21A are cross-sectional views at a far point.

FIG. 1B, FIG. 2B, FIG. 3B, FIG. 4B, FIG. 5B, FIG. 6B, FIG. 7B, FIG. 8B, FIG. 9B, FIG. 10B, FIG. 11B, FIG. 12B, FIG. 13B, FIG. 14B, FIG. 15B, FIG. 16B, FIG. 17B, FIG. 18B, FIG. 19B, FIG. 20B, and FIG. 21B are cross-sectional views at a near point.

A first lens unit is denoted by G1, a second lens unit is denoted by G2, a third lens unit is denoted by G3, an aperture stop is denoted by S, a filter is denoted by F, a cover glass is denoted by C, a prism is denoted by P, and an image plane (image pickup surface) is denoted by I.

Aberration diagrams of each example will be described below. Aberration diagrams are indicated in order of aberration diagrams at a far point and aberration diagrams at a near point.

Aberration diagrams at a far point are as follow.

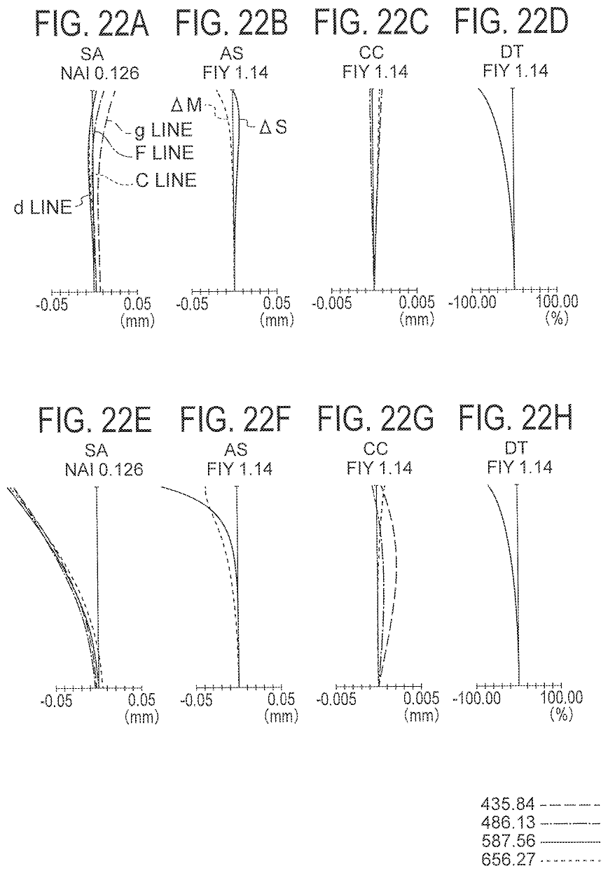

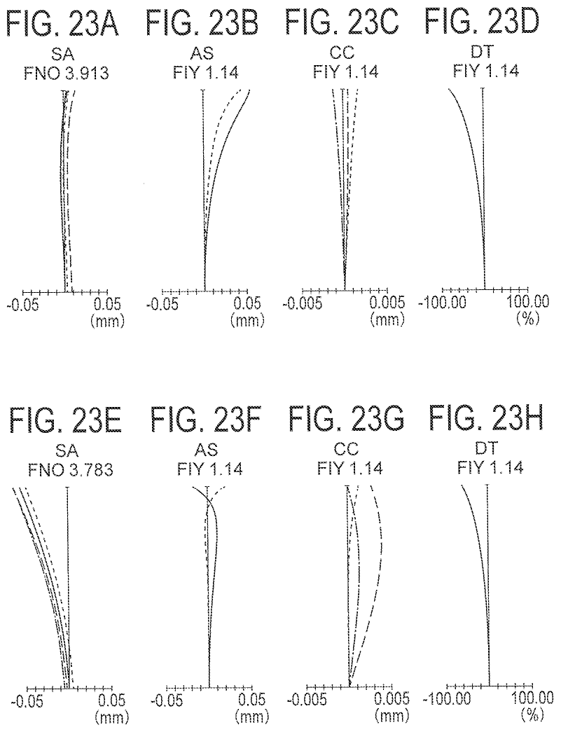

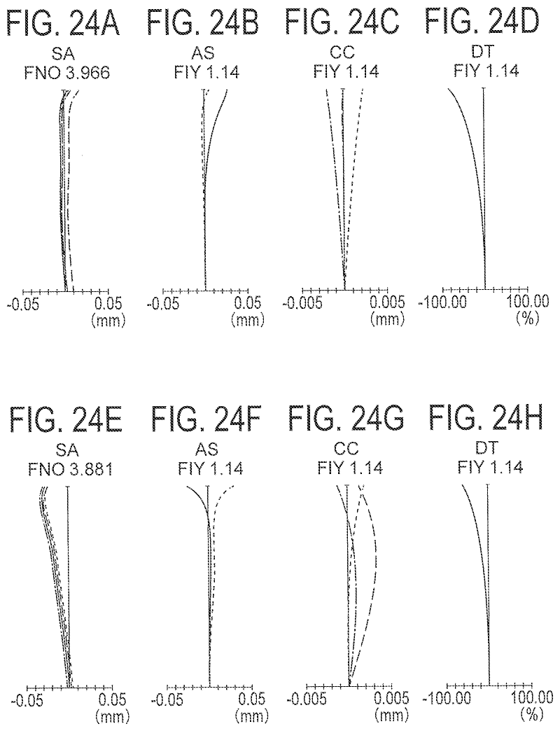

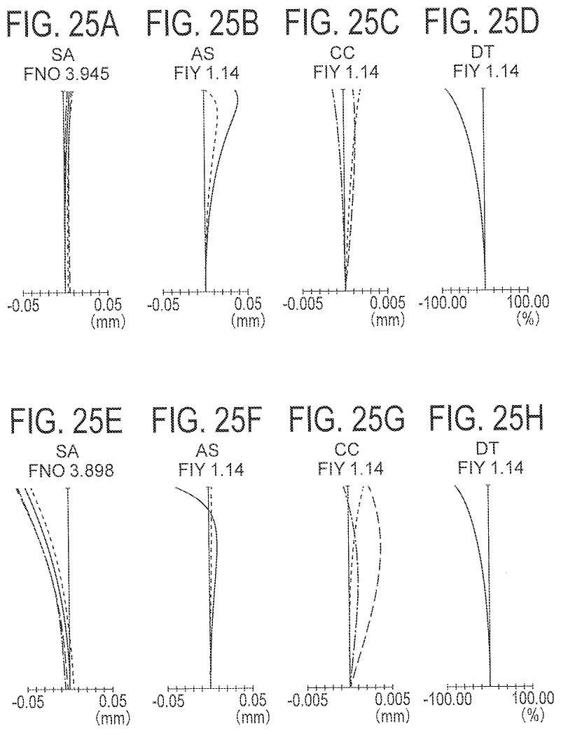

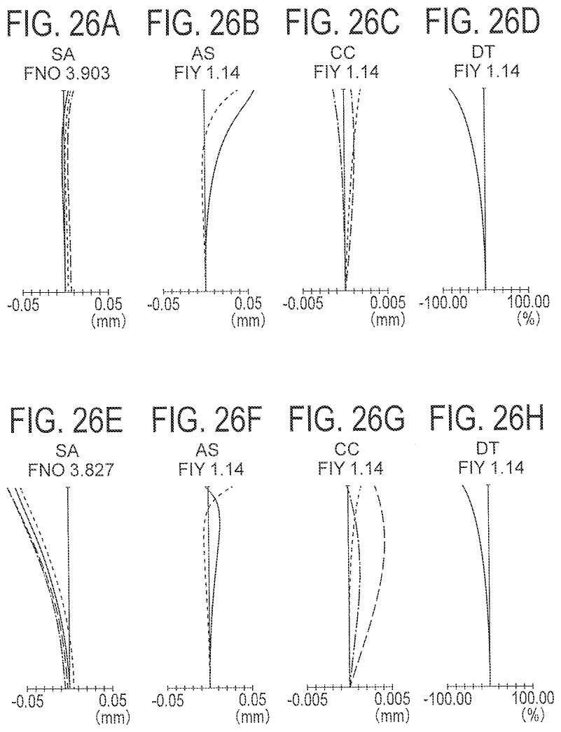

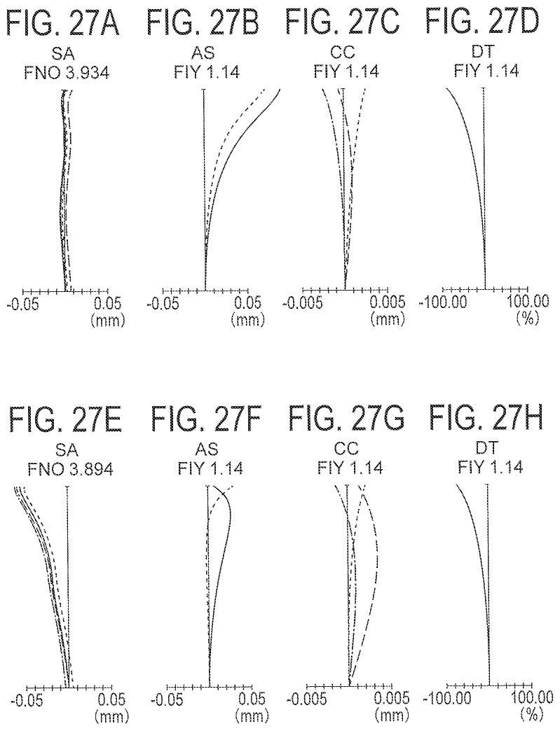

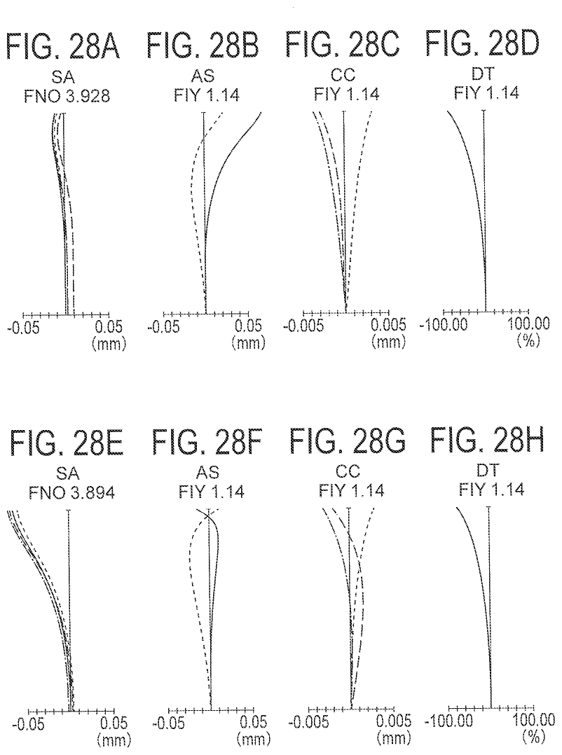

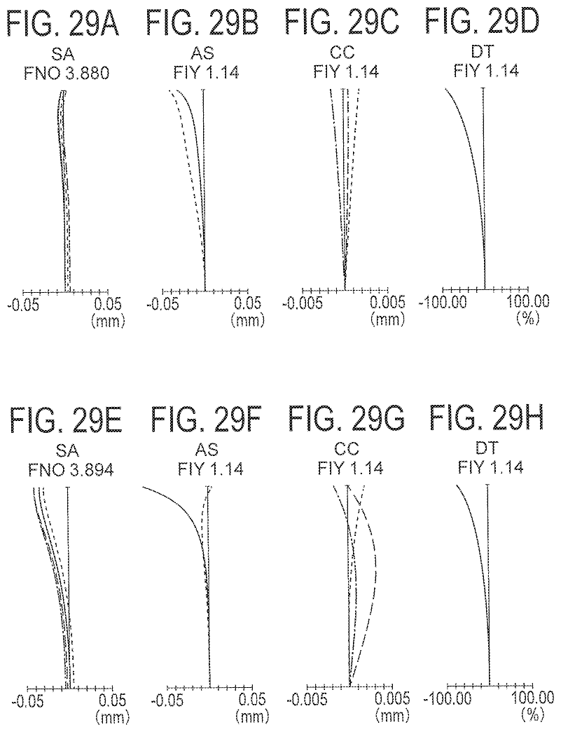

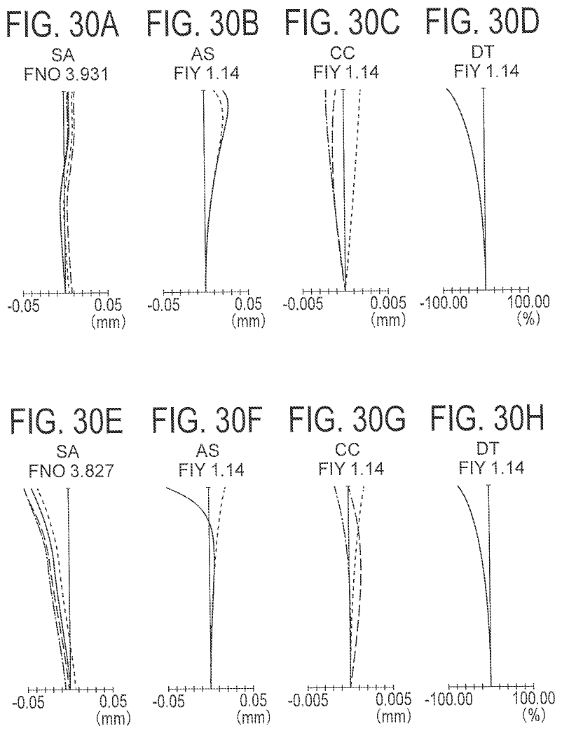

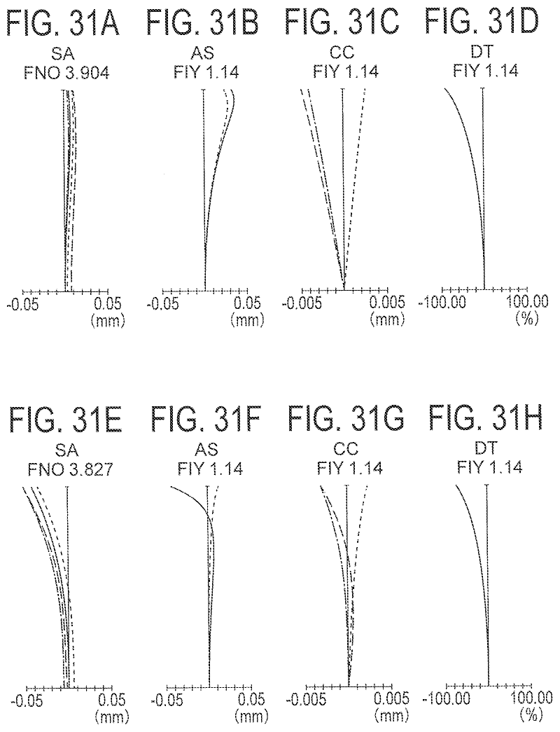

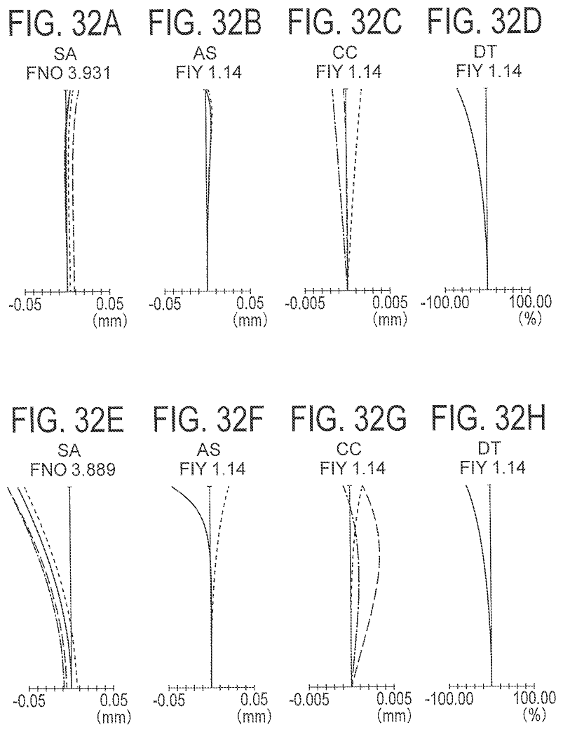

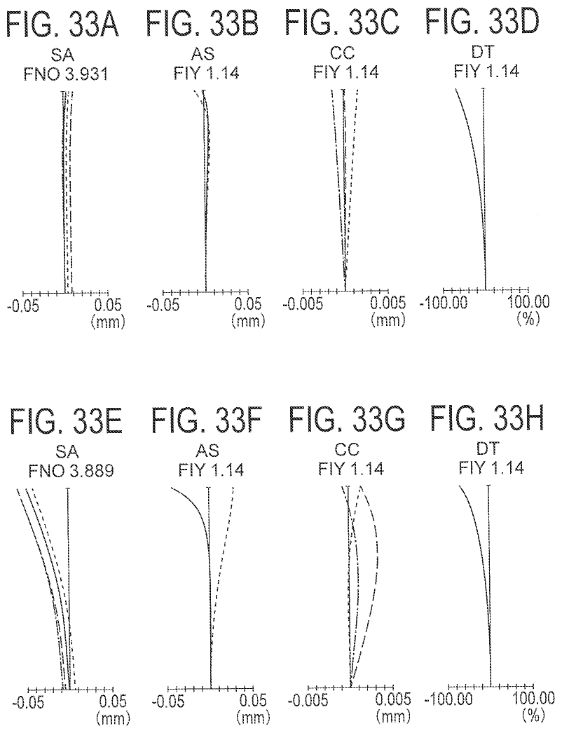

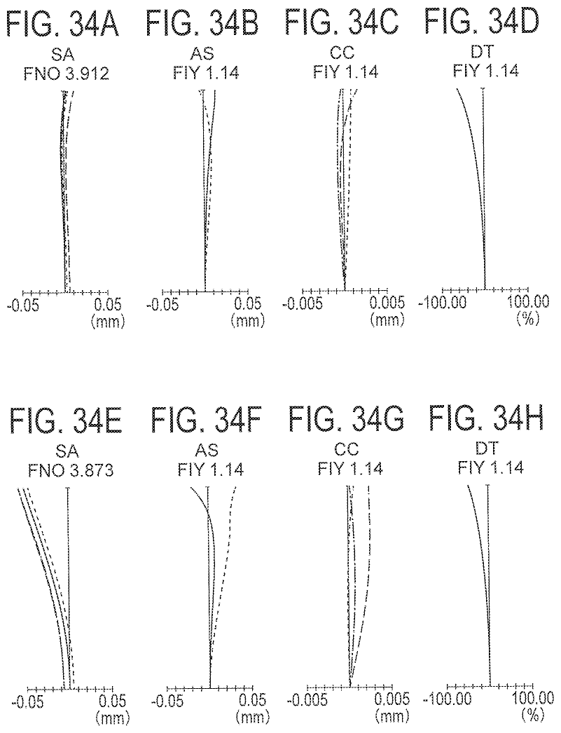

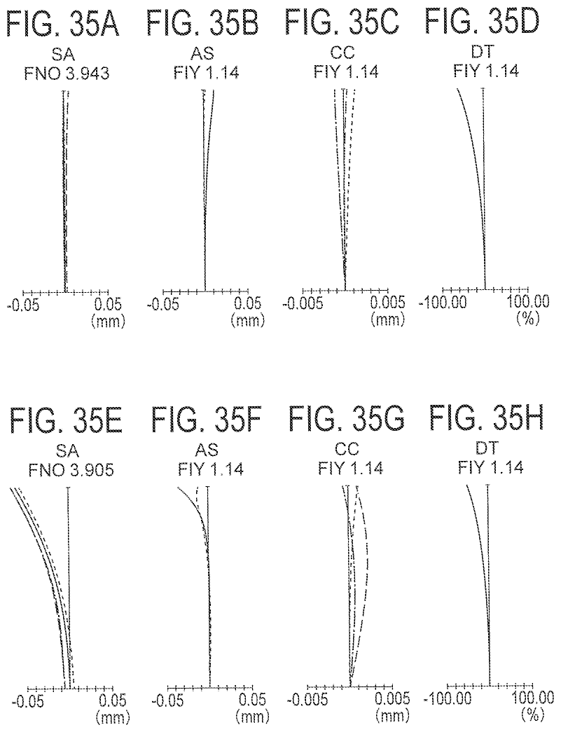

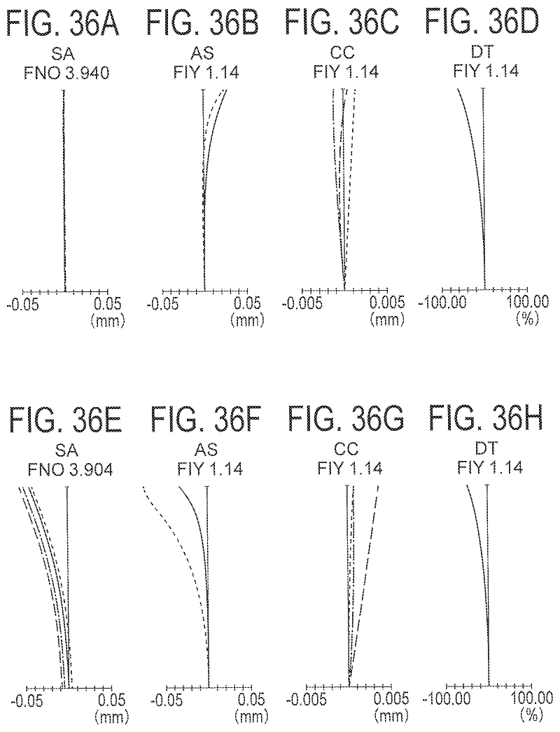

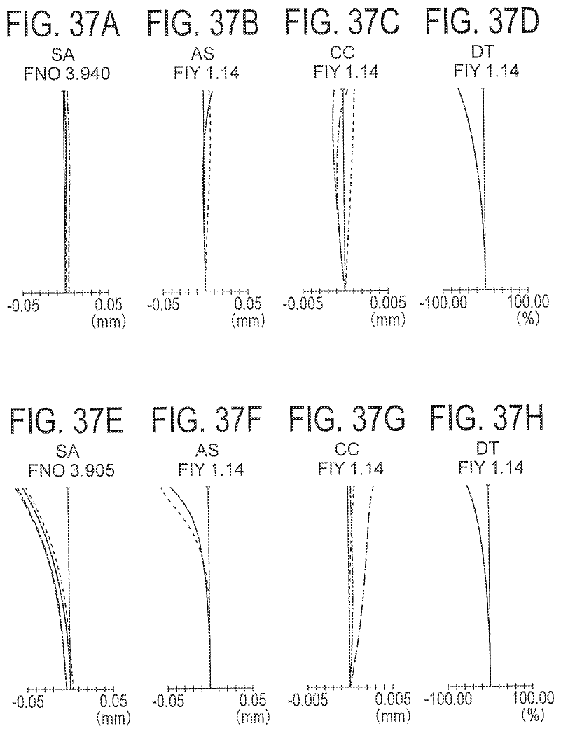

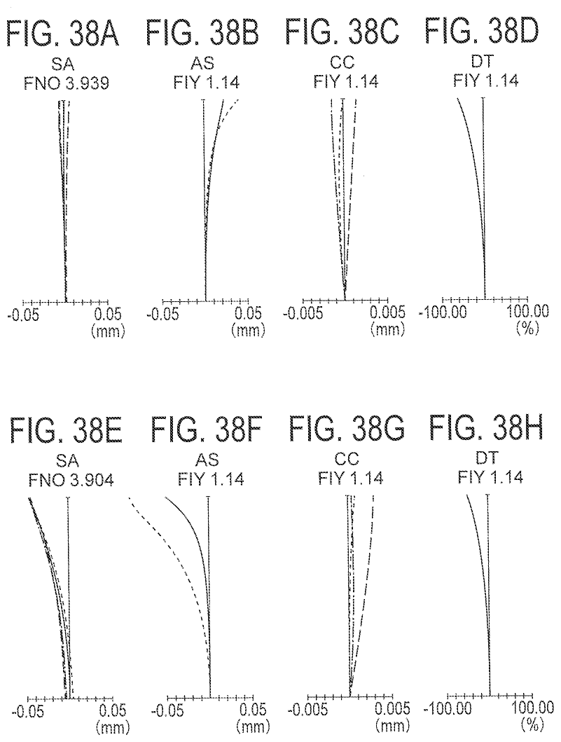

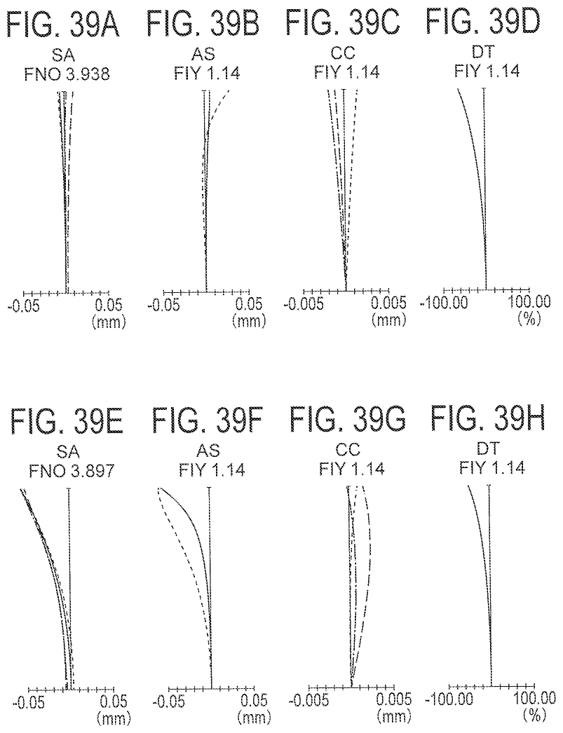

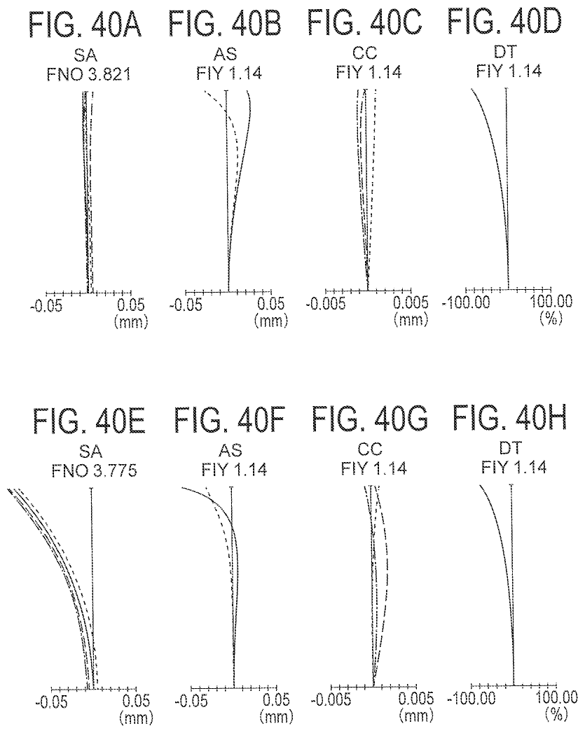

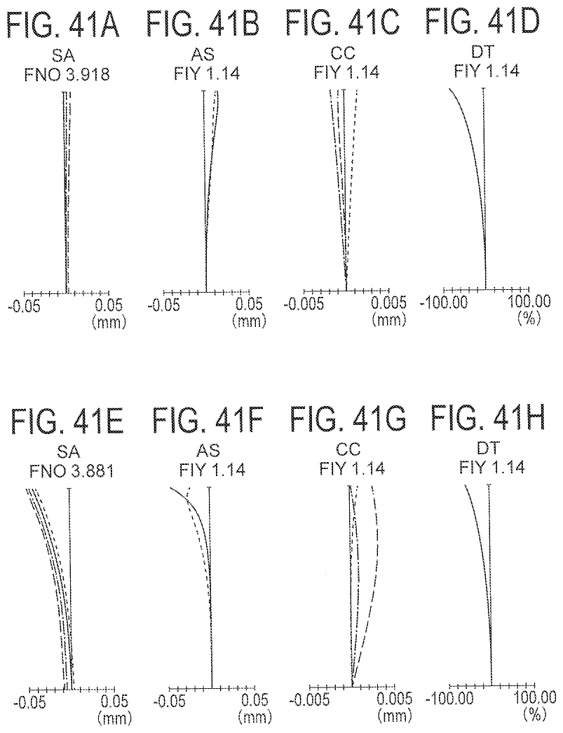

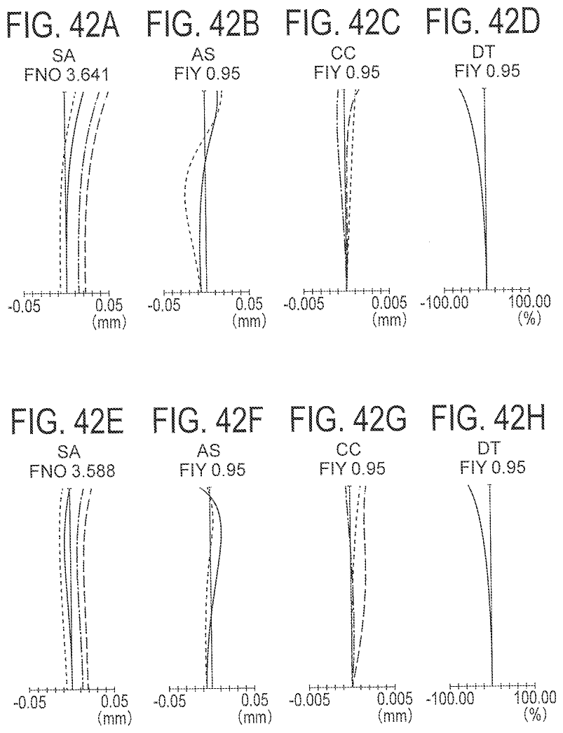

FIG. 22A, FIG. 23A, FIG. 24A, FIG. 25A, FIG. 26A, FIG. 27A, FIG. 28A, FIG. 29A, FIG. 30A, FIG. 31A, FIG. 32A, FIG. 33A, FIG. 34A, FIG. 35A, FIG. 36A, FIG. 37A, FIG. 38A, FIG. 39A, FIG. 40A, FIG. 41A, and FIG. 42A show a spherical aberration (SA).

FIG. 22B, FIG. 23B, FIG. 24B, FIG. 25B, FIG. 26B, FIG. 27B, FIG. 28B, FIG. 29B, FIG. 30B, FIG. 31B, FIG. 32B, FIG. 33B, FIG. 34B, FIG. 35B, FIG. 36B, FIG. 37B, FIG. 38B, FIG. 39B, FIG. 40B, FIG. 41B, and FIG. 42B show an astigmatism (AS).

FIG. 22C, FIG. 23C, FIG. 24C, FIG. 25C, FIG. 26C, FIG. 27C, FIG. 28C, FIG. 29C, FIG. 30C, FIG. 31C, FIG. 32C, FIG. 33C, FIG. 34C, FIG. 35C, FIG. 36C, FIG. 37C, FIG. 38C, FIG. 39C, FIG. 40C, FIG. 41C, and FIG. 42C show a chromatic aberration of magnification (CC).

FIG. 22D, FIG. 23D, FIG. 24D, FIG. 25D, FIG. 26D, FIG. 27D, FIG. 28D, FIG. 29D, FIG. 30D, FIG. 31D, FIG. 32D, FIG. 33D, FIG. 34D, FIG. 35D, FIG. 36D, FIG. 37D, FIG. 38D, FIG. 39D, FIG. 40D, FIG. 41D, and FIG. 42D show a distortion (DT).

Aberration diagrams at a near point are as follow.

FIG. 22E, FIG. 23E, FIG. 24E, FIG. 25E, FIG. 26E, FIG. 27E, FIG. 28E, FIG. 29E, FIG. 30E, FIG. 31E, FIG. 32E, FIG. 33E, FIG. 34E, FIG. 35E, FIG. 36E, FIG. 37E, FIG. 38E, FIG. 39E, FIG. 40E, FIG. 41E, and FIG. 42E show a spherical aberration (SA).

FIG. 22F, FIG. 23F, FIG. 24F, FIG. 25F, FIG. 26F, FIG. 27F, FIG. 28F, FIG. 29F, FIG. 30F, FIG. 31F, FIG. 32F, FIG. 33F, FIG. 34F, FIG. 35F, FIG. 36F, FIG. 37F, FIG. 38F, FIG. 39F, FIG. 40F, FIG. 41F, and FIG. 42F show an astigmatism (AS).

FIG. 22G, FIG. 23G, FIG. 24G, FIG. 25G, FIG. 26G, FIG. 27G, FIG. 28G, FIG. 29G, FIG. 30G, FIG. 31G, FIG. 32G, FIG. 33G, FIG. 34G, FIG. 35G, FIG. 36G, FIG. 37G, FIG. 38G, FIG. 39G, FIG. 40G, FIG. 41G, and FIG. 42G show a chromatic aberration of magnification (CC).

FIG. 22H, FIG. 23H, FIG. 24H, FIG. 25H, FIG. 26H, FIG. 27H, FIG. 28H, FIG. 29H, FIG. 30H, FIG. 31H, FIG. 32H, FIG. 33H, FIG. 34H, FIG. 35H, FIG. 36H, FIG. 37H, FIG. 38H, FIG. 39H, FIG. 40H, FIG. 41H, and FIG. 42H show a distortion (DT).

A wide-angle optical system of an example 1 includes in order from an object side, a first lens unit G1 having a negative refractive power, a second lens unit G2 having a positive refractive power, and a third lens unit G3 having a positive refractive power.

The first lens unit G1 includes a planoconcave negative lens L1, a biconcave negative lens L2, and a biconvex positive lens L3.

The second lens unit G2 includes a positive meniscus lens L4 having a convex surface directed toward the object side.

The third lens unit G3 includes a biconvex positive lens L5, a negative meniscus lens L6 having a convex surface directed toward an image side, a biconvex positive lens L7, a biconcave negative lens L8, a negative meniscus lens L9 having a convex surface directed toward the object side, a biconvex positive lens L10, a biconvex positive lens L11, and a negative meniscus lens L12 having a convex surface directed toward the image side.

The biconvex positive lens L5 and the negative meniscus lens L6 are cemented. The biconvex positive lens L11 and the negative meniscus lens L12 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 2 includes in order from an object side, a first lens unit G1 having a negative refractive power, a second lens unit G2 having a positive refractive power, and a third lens unit G3 having a positive refractive power.

The first lens unit G1 includes a planoconcave negative lens L1, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a negative meniscus lens L6 having a convex surface directed toward the object side, a biconvex positive lens L7, a positive meniscus lens L8 having a convex surface directed toward an image side, a biconcave negative lens L9, a biconvex positive lens L10, and a positive meniscus lens L11 having a convex surface directed toward the object side.

The negative meniscus lens L6 and the biconvex positive lens L7 are cemented. The positive meniscus lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 3 includes in order from an object side, a first lens unit G1 having a negative refractive power, a second lens unit G2 having a positive refractive power, and a third lens unit G3 having a positive refractive power.

The first lens unit G1 includes a planoconcave negative lens L1, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a negative meniscus lens L6 having a convex surface directed toward the object side, a biconvex positive lens L7, a positive meniscus lens L8 having a convex surface directed toward an image side, a biconcave negative lens L9, a positive meniscus lens L10 having a convex surface directed toward the image side, and a biconvex positive lens L11.

The negative meniscus lens L6 and the biconvex positive lens L7 are cemented. The positive meniscus lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 4 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a negative meniscus lens L6 having a convex surface directed toward the object side, a biconvex positive lens L7, a biconvex positive lens L8, a biconcave negative lens L9, a positive meniscus lens L10 having a convex surface directed toward an image side, and a biconvex positive lens L11.

The negative meniscus lens L6 and the biconvex positive lens L7 are cemented. The biconvex positive lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 5 includes in order from an object side, a first lens unit G1 having a negative refractive power, a second lens unit G2 having a positive refractive power, and a third lens unit G3 having a positive refractive power.

The first lens unit G1 includes a planoconcave negative lens L1, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a negative meniscus lens L6 having a convex surface directed toward the object side, a biconvex positive lens L7, a positive meniscus lens L8 having a convex surface directed toward an image side, a biconcave negative lens L9, a positive meniscus lens L10 having a convex surface directed toward the image side, and a biconvex positive lens L11.

The negative meniscus lens L6 and the biconvex positive lens L7 are cemented. The positive meniscus lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 6 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a negative meniscus lens L6 having a convex surface directed toward the object side, a biconvex positive lens L7, a positive meniscus lens L8 having a convex surface directed toward an image side, a biconcave negative lens L9, a biconvex positive lens L10, and a biconvex positive lens L11.

The negative meniscus lens L6 and the biconvex positive lens L7 are cemented. The positive meniscus lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 7 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a positive meniscus lens L6 having a convex surface directed toward the object side, a biconvex positive lens L7, a positive meniscus lens L8 having a convex surface directed toward an image side, biconcave negative lens L9, a positive meniscus lens L10 having a convex surface directed toward the image side, and a biconvex positive lens L11.

The positive meniscus lens L6 and the biconvex positive lens L7 are cemented. The positive meniscus lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 8 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a biconcave negative lens L6, a biconvex positive lens L7, a positive meniscus lens L8 having a convex surface directed toward an image side, a biconcave negative lens L9, a biconvex positive lens L10, and a positive meniscus lens L11 having a convex surface directed toward the object side.

The biconcave negative lens L6 and the biconvex positive lens L7 are cemented. The positive meniscus lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 9 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a negative meniscus lens L6 having a convex surface directed toward the object side, a biconvex positive lens L7, a biconvex positive lens L8, a biconcave negative lens L9, a biconvex positive lens L10, and a positive meniscus lens L11 having a convex surface directed toward the object side.

The negative meniscus lens L6 and the biconvex positive lens L7 are cemented. The biconvex positive lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 10 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a negative meniscus lens L6 having a convex surface directed toward the object side, a biconvex positive lens L7, a biconvex positive lens L8, a biconcave negative lens L9, a biconvex positive lens L10, and a positive meniscus lens L11 having a convex surface directed toward the object side.

The negative meniscus lens L6 and the biconvex positive lens L7 are cemented. The biconvex positive lens L8 and the biconcave negative lens L9 are cemented.

A filter F is disposed in the first lens unit G1. An aperture stop S is disposed between the second lens unit G2 and the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 11 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a biconvex positive lens L5, a biconcave negative lens L6, a biconvex positive lens L7, a positive meniscus lens L8 having a convex surface directed toward an image side, a biconcave negative lens L9, a biconvex positive lens L10, and a positive meniscus lens L11 having a convex surface directed toward the object side.

The biconcave negative lens L6 and the biconvex positive lens L7 are cemented. The positive meniscus lens L8 and the biconcave negative lens L9 are cemented.

A filter F is disposed in the first lens unit G1. An aperture stop S is disposed in the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 12 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a biconvex positive lens L5, a biconcave negative lens L6, a biconvex positive lens L7, a biconvex positive lens L8, a biconcave negative lens L9, a biconvex positive lens L10, and a biconvex positive lens L11.

The biconcave negative lens L6 and the biconvex positive lens L7 are cemented. The biconvex positive lens L8 and the biconcave negative lens L9 are cemented.

A filter F is disposed in the first lens unit G1. An aperture stop S is disposed in the third lens unit G3. A cover glass C is disposed on an image side of the third lens unit G3.

In an adjustment of a focal position, the second lens unit G2 is moved. At the time of adjustment from a far point to a near point, the second lens unit G2 is moved toward the image side.

A wide-angle optical system of an example 13 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a negative meniscus lens L6 having a convex surface directed toward the object side, a biconvex positive lens L7, a biconvex positive lens L8, a biconcave negative lens L9, a biconvex positive lens L10, a positive meniscus lens L11 having a convex surface directed toward the object side, and a planoconvex positive lens L12.

The negative meniscus lens L6 and the biconvex positive lens L7 are cemented. The biconvex positive lens L8 and the biconcave negative lens L9 are cemented.

A filter F is disposed in the first lens unit G1. An aperture stop S is disposed in the third lens unit G3. A cover glass C is disposed on an image side of the third lens unit G3. The planoconvex positive lens L12 and the cover glass C are cemented.

In an adjustment of a focal position, the second lens unit G2 is moved. At the time of adjustment from a far point to a near point, the second lens unit G2 is moved toward the image side.

A wide-angle optical system of an example 14 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a biconvex positive lens L3.

The second lens unit G2 includes a positive meniscus lens L4 having a convex surface directed toward the object side.

The third lens unit G3 includes a positive meniscus lens L5 having a convex surface directed toward the object side, a biconvex positive lens L6, a negative meniscus lens L7 having a convex surface directed toward an image side, a biconvex positive lens L8, a biconcave negative lens L9, a positive meniscus lens L10 having a convex surface directed toward the image side, a biconvex positive lens L11, and a planoconvex positive lens L12.

The biconvex positive lens L6 and the negative meniscus lens L7 are cemented. The biconvex positive lens L8 and the biconcave negative lens L9 are cemented.

A filter F is disposed in the first lens unit G1. An aperture stop S is disposed in the third lens unit G3. A cover glass C is disposed on an image side of the third lens unit G3. The planoconvex positive lens L12 and the cover glass C are cemented.

In an adjustment of a focal position, the second lens unit G2 is moved. At the time of adjustment from a far point to a near point, the second lens unit G2 is moved toward the image side.

A wide-angle optical system of an example 15 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a biconvex positive lens L6, a negative meniscus lens L7 having a convex surface directed toward an image side, a biconvex positive lens L8, a biconcave negative lens L9, a positive meniscus lens L10 having a convex surface directed toward the image side, a biconvex positive lens L11, and a planoconvex positive lens L12.

The biconvex positive lens L6 and the negative meniscus lens L7 are cemented. The biconvex positive lens L8 and the biconcave negative lens L9 are cemented.

A filter F is disposed in the first lens unit G1. An aperture stop S is disposed in the third lens unit G3. A cover glass C is disposed on an image side of the third lens unit G3. The planoconvex positive lens L12 and the cover glass C are cemented.

In an adjustment of a focal position, the second lens unit G2 is moved. At the time of adjustment from a far point to a near point, the second lens unit G2 is moved toward the image side.

A wide-angle optical system of an example 16 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a biconvex positive lens L6, a negative meniscus lens L7 having a convex surface directed toward an image side, a biconvex positive lens L8, a biconcave negative lens L9, a positive meniscus lens L10 having a convex surface directed toward the image side, a biconvex positive lens L11, and a planoconvex positive lens L12.

The biconvex positive lens L6 and the negative meniscus lens L7 are cemented. The biconvex positive lens L8 and the biconcave negative lens L9 are cemented.

A filter F is disposed between the first lens unit G1 and the second lens unit G2. An aperture stop S is disposed in the third lens unit G3. A cover glass C is disposed on an image side of the third lens unit G3. The planoconvex positive lens L12 and the cover glass C are cemented.

In an adjustment of a focal position, the second lens unit G2 is moved. At the time of adjustment from a far point to a near point, the second lens unit G2 is moved toward the image side.

A wide-angle optical system of an example 17 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a biconvex positive lens L6, a negative meniscus lens L7 having a convex surface directed toward an image side, a biconvex positive lens L8, a biconcave negative lens L9, a positive meniscus lens L10 having a convex surface directed toward the image side, a biconvex positive lens L11, and a planoconvex positive lens L12.

The biconvex positive lens L6 and the negative meniscus lens L7 are cemented. The biconvex positive lens L8 and the biconcave negative lens L9 are cemented.

A filter F is disposed in the first lens unit G1. An aperture stop S is disposed in the third lens unit G3. A cover glass C is disposed on an image side of the third lens unit G3. The planoconvex positive lens L12 and the cover glass C are cemented.

In an adjustment of a focal position, the second lens unit G2 is moved. At the time of adjustment from a far point to a near point, the second lens unit G2 is moved toward the image side.

A wide-angle optical system of an example 18 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a biconcave negative lens L2, and a positive meniscus lens L3 having a convex surface directed toward the object side.

The second lens unit G2 includes a positive meniscus lens L4 having a convex surface directed toward the object side.

The third lens unit G3 includes a positive meniscus lens L5 having a convex surface directed toward the object side, a biconvex positive lens L6, a negative meniscus lens L7 having a convex surface directed toward an image side, a biconvex positive lens L8, a biconcave negative lens L9, a negative meniscus lens L10 having a convex surface directed toward the image side, a biconvex positive lens L11, and a planoconvex positive lens L12.

The biconvex positive lens L6 and the negative meniscus lens L7 are cemented. The biconvex positive lens L8 and the biconcave negative lens L9 are cemented.

A filter F is disposed in the first lens unit G1. An aperture stop S is disposed in the third lens unit G3. A cover glass C is disposed on an image side of the third lens unit G3. The planoconvex positive lens L12 and the cover glass C are cemented.

In an adjustment of a focal position, the second lens unit G2 is moved. At the time of adjustment from a far point to a near point, the second lens unit G2 is moved toward the image side.

A wide-angle optical system of an example 19 includes in order from an object side, a first lens unit G1 having a negative refractive power, a second lens unit G2 having a positive refractive power, and a third lens unit G3 having a positive refractive power.

The first lens unit G1 includes a negative meniscus lens L1 having a convex surface directed toward the object side, a negative meniscus lens L2 having a convex surface directed toward an image side, and a positive meniscus lens L3 having a convex surface directed toward the image side.

The second lens unit G2 includes a positive meniscus lens L4 having a convex surface directed toward the object side.

The third lens unit G3 includes a biconvex positive lens L5, a negative meniscus lens L6 having a convex surface directed toward the image side, a biconvex positive lens L7, a negative meniscus lens L8 having a convex surface directed toward the object side, a positive meniscus lens L9 having a convex surface directed toward the object side, a biconvex positive lens L10, a negative meniscus lens L11 having a convex surface directed toward the image side, a negative meniscus lens L12 having a convex surface directed toward the image side, a negative meniscus lens L13 having a convex surface directed toward the object side, and a planoconvex positive lens L14.

The biconvex positive lens L5 and the negative meniscus lens L6 are cemented. The negative meniscus lens L8 and the positive meniscus lens L9 are cemented. The biconvex positive lens L10 and the negative meniscus lens L11 are cemented.

A filter F is disposed in the first lens unit G1. An aperture stop S is disposed in the third lens unit G3. A cover glass C is disposed on an image side of the third lens unit G3. The planoconvex positive lens L14 and the cover glass C are cemented.

In an adjustment of a focal position, the second lens unit G2 is moved. At the time of adjustment from a far point to a near point, the second lens unit G2 is moved toward the image side.

A wide-angle optical system of an example 20 includes in order from an object side, a first lens unit G1 having a negative refractive power, a second lens unit G2 having a positive refractive power, and a third lens unit G3 having a positive refractive power.

The first lens unit G1 includes a planoconcave negative lens L1, a biconcave negative lens L2, and a negative meniscus lens L3 having a convex surface directed toward an image side.

The second lens unit G2 includes a positive meniscus lens L4 having a convex surface directed toward the object side.

The third lens unit G3 includes a positive meniscus lens L5 having a convex surface directed toward the object side, a biconvex positive lens 16, a negative meniscus lens L7 having a convex surface directed toward the image side, a biconvex positive lens L8, a biconcave negative lens L9, a biconvex positive lens L10, a biconvex positive lens L11, and a planoconvex positive lens L12.

The biconvex positive lens L6 and the negative meniscus lens L7 are cemented. The biconvex positive lens L8 and the biconcave negative lens L9 are cemented.

A filter F is disposed in the first lens unit G1. An aperture stop S is disposed in the third lens unit G3. A cover glass C is disposed on an image side of the third lens unit G3. The planoconvex positive lens L12 and the cover glass C are cemented.

In an adjustment of a focal position, the second lens unit G2 is moved. At the time of adjustment from a far point to a near point, the second lens unit G2 is moved toward the image side.

A wide-angle optical system of an example 21 includes in order from an object side, a first lens unit G1 having a negative refractive power, a second lens unit G2 having a positive refractive power, and a third lens unit G3 having a positive refractive power.

The first lens unit G1 includes a planoconcave negative lens L1, a biconcave negative lens L2, and a positive meniscus lens L3 having a convex surface directed toward the object side. The biconcave negative lens L2 and the positive meniscus lens L3 are cemented.

The second lens unit G2 includes a positive meniscus lens L4 having a convex surface directed toward the object side.

The third lens unit G3 includes a negative meniscus lens L5 having a convex surface directed toward the object side, a biconvex positive lens L6, a negative meniscus lens L7 having a convex surface directed toward the object side, a biconvex positive lens L8, a biconcave negative lens L9, a biconvex positive lens L10, a biconvex positive lens L11, and a negative meniscus lens L12 having a convex surface directed toward the object side.

The negative meniscus lens L5 and the biconvex positive lens L6 are cemented. The negative meniscus lens L7 and the biconvex positive lens L8 are cemented. The biconcave negative lens L9 and the biconvex positive lens L10 are cemented.

A filter F is disposed in the first lens unit G1. An aperture stop S is disposed in the third lens unit G3. A cover glass C and a prism P are disposed on an image side of the third lens unit G3.

In an adjustment of a focal position, the second lens unit G2 is moved. At the time of adjustment from a far point to a near point, the second lens unit G2 is moved toward the image side.

Numerical data of each example described above is shown below. In Surface data, r denotes radius of curvature of each lens surface, d denotes a distance between respective lens surfaces, nd denotes a refractive index of each lens for a d-line, vd denotes an Abbe number for each lens and * denotes an aspherical surface. A stop is an aperture stop.

Moreover, in Various data, OBJ denotes an object distance, FL denotes a focal length of the entire system, MG denotes a magnification of the entire system, NAI denotes a numerical aperture, FNO. denotes an F number, FIY and FIM denote an image height, LTL denotes a lens total length of the optical system, and FB denotes a back focus. The back focus is a unit which is expressed upon air conversion of a distance from a rearmost lens surface to a paraxial image surface. The lens total length is a distance from a frontmost lens surface to the rearmost lens surface plus back focus. Moreover, β1 denotes a magnification of the first lens unit, β2 denotes a magnification of the second lens unit, β3 denotes a magnification of the third lens unit.

Further, in Unit focal length, each of f1, f2 . . . is a focal length of each lens unit.

A shape of an aspherical surface is defined by the following expression where the direction of the optical axis is represented by z, the direction orthogonal to the optical axis is represented by y, a conical coefficient is represented by K, aspherical surface coefficients are represented by A4, A6, A8, A10, A12 . . .

Z=(y²/r)/[1+{1−(1+k)(y/r)²}^{1/2}]+A4y⁴+A⁶y⁶+A8y⁸+A10y⁸+A12y¹²+

Further, in the aspherical surface coefficients, ‘E−n’ (where, n is an integral number) indicates ‘10⁻ⁿ’. Moreover, these symbols are commonly used in the following numerical data for each example.

### EXAMPLE 1

Unit mm
Surface data

| Surface no. | r | d | nd | νd | ER |
|---|---|---|---|---|---|
| Object plane | ∞ | 21.0000 | 1. | | |
| 1 | ∞ | 0.3700 | 1.88300 | 40.76 | 1.598 |
| 2 | 1.3365 | 0.7000 | 1. | | 1.054 |
| 3 | ∞ | 0.4000 | 1.51633 | 64.14 | 1.020 |
| 4 | ∞ | 0.2000 | 1. | | 0.970 |
| 5 | −2.4149 | 0.2932 | 1.88300 | 40.76 | 0.971 |
| 6 | 11.5245 | 0.0905 | 1. | | 1.030 |
| 7 | 9.8202 | 0.6960 | 1.78472 | 25.68 | 1.061 |
| 8 | −3.2386 | d8 | 1. | | 1.110 |
| 9 | 1.7471 | 0.5591 | 1.49700 | 81.54 | 1.033 |
| 10 | 1.8893 | d10 | 1. | | 0.904 |
| 11(Stop) | ∞ | 0.1000 | 1. | | 0.570 |
| 12 | 1.6617 | 0.8323 | 1.58913 | 61.14 | 0.648 |
| 13 | −1.3612 | 0.2948 | 1.83400 | 37.16 | 0.665 |
| 14 | −4.5054 | 0.0944 | 1. | | 0.706 |
| 15 | 2.3887 | 0.7740 | 1.58913 | 61.14 | 0.720 |
| 16 | −1.6464 | 0.0861 | 1. | | 0.676 |
| 17 | −1.3548 | 0.2847 | 1.88300 | 40.76 | 0.642 |
| 18 | 1.6199 | 0.0148 | 1. | | 0.669 |
| 19 | 1.5740 | 0.2830 | 1.69895 | 30.13 | 0.689 |
| 20 | 1.8348 | 0.0446 | 1. | | 0.712 |
| 21 | 1.9198 | 0.8306 | 1.51742 | 52.43 | 0.739 |
| 22 | −3.6617 | 0.0887 | 1. | | 0.828 |
| 23 | 9.6091 | 0.8470 | 1.51633 | 64.14 | 0.852 |
| 24 | −1.4071 | 0.2937 | 1.88300 | 40.76 | 0.873 |
| 25 | −4.5032 | 0.0856 | 1. | | 0.961 |
| 26 | ∞ | 1.5000 | 1.51633 | 64.14 | 0.988 |
| 27 | ∞ | 0.0700 | 1. | | 1.129 |
| Image plane | ∞ | 0. | | | |

Various data

| | |
|---|---|
| Far Point | Near point |

| | | |
|---|---|---|
| OBJ | 21.0000 | 2.9000 |
| FL | 1.08640 | 1.03636 |
| MG | −0.049360 | −0.266448 |
| NAI | 0.1264 | 0.1262 |
| FIY | 1.140 | 1.140 |
| LTL | 12.4438 | 12.4438 |
| FB | 0.01637 | −0.20614 |
| d8 | 0.36201 | 1.95324 |
| d10 | 2.24872 | 0.65748 |
| β1 | 0.06727 | 0.33940 |
| β2 | 1.12363 | 1.20217 |
| β3 | −0.65304 | −0.65304 |

Unit focal length
f1 = −1.51854, f2 = 20.26060, f3 = 2.68873

### EXAMPLE 2

Unit mm
Surface data

| Surface no. | r | d | nd | νd | ER |
|---|---|---|---|---|---|
| Object plane | ∞ | 21.0000 | 1. | | |
| 1 | ∞ | 0.3700 | 1.88300 | 40.76 | 1.584 |
| 2 | 1.4231 | 0.6000 | 1. | | 1.063 |
| 3 | ∞ | 0.4000 | 1.51633 | 64.14 | 1.028 |
| 4 | ∞ | 0.2050 | 1. | | 0.956 |
| 5 | −3.7179 | 0.2996 | 1.88300 | 40.76 | 0.932 |
| 6 | 4.2255 | 0.0981 | 1. | | 0.923 |
| 7 | 2.9010 | 0.5052 | 1.72825 | 28.46 | 0.950 |
| 8 | 20.4171 | d8 | 1. | | 0.932 |
| 9 | 2.0936 | 1.1355 | 1.49700 | 81.54 | 0.908 |
| 10 | 2.7535 | d10 | 1. | | 0.713 |
| 11(Stop) | ∞ | 0.0886 | 1. | | 0.515 |
| 12* | 1.8293 | 0.6269 | 1.88300 | 40.76 | 0.585 |
| 13* | 2.7993 | 0.0918 | 1. | | 0.591 |
| 14 | 1.3249 | 0.3000 | 1.88300 | 40.76 | 0.647 |
| 15 | 0.8904 | 1.0892 | 1.51633 | 64.14 | 0.603 |
| 16 | −2.5698 | 0.0930 | 1. | | 0.656 |
| 17 | −38.7851 | 0.5991 | 1.51633 | 64.14 | 0.650 |
| 18 | −1.3191 | 0.2903 | 1.84666 | 23.78 | 0.643 |
| 19 | 1.9173 | 0.2418 | 1. | | 0.694 |
| 20 | 29.3218 | 0.5187 | 1.74400 | 44.78 | 0.774 |
| 21 | −2.9683 | 0.0875 | 1. | | 0.891 |
| 22 | 4.2647 | 0.4510 | 1.88300 | 40.76 | 1.000 |
| 23 | 45.6521 | 0.3000 | 1. | | 1.014 |
| 24 | ∞ | 1.5000 | 1.51633 | 64.14 | 1.042 |
| 25 | ∞ | 0.0244 | 1. | | 1.139 |
| Image plane | ∞ | 0. | | | |

Aspherical surface data
12th surface
K = 0.
A2 = 0.0000E+00, A4 = 3.1271E−02, A6 = −3.7563E−02, A8 = 1.1200E−01,
A10 = −1.3167E−01
13th surface
K = 0.
A2 = 0.0000E+00, A4 = 8.5718E−02, A6 = −2.3429E−02, A8 = 1.3415E−01,
A10 = −1.8436E−01
Various data

| | Far Point | Near point |
|---|---|---|
| OBJ | 21.0000 | 2.9000 |
| FL | 1.00129 | 0.99830 |
| MG | −0.045292 | −0.251004 |
| FNO | 3.9133 | 3.7830 |
| FIY | 1.140 | 1.140 |
| LTL | 11.5624 | 11.5624 |
| FB | −0.02093 | −0.22616 |
| d8 | 0.25232 | 1.13571 |
| d10 | 1.39431 | 0.51092 |
| β1 | 0.04530 | 0.23409 |
| β2 | 1.09150 | 1.17047 |
| β3 | −0.91608 | −0.91608 |

Unit focal length
f1 = −1.01657, f2 = 11.18632, f3 = 2.55795

### EXAMPLE 3

Unit mm
Surface data

| Surface no. | r | d | nd | νd | ER |
|---|---|---|---|---|---|
| Object plane | ∞ | 21.0000 | 1. | | |
| 1 | ∞ | 0.3700 | 1.88300 | 40.76 | 1.881 |
| 2 | 1.8089 | 0.6000 | 1. | | 1.306 |
| 3 | ∞ | 0.4000 | 1.51633 | 64.14 | 1.293 |
| 4 | ∞ | 0.1633 | 1. | | 1.209 |
| 5 | −7.7140 | 0.2984 | 1.88300 | 40.76 | 1.185 |
| 6 | 3.9041 | 0.0965 | 1. | | 1.135 |
| 7 | 2.4546 | 0.8446 | 1.92286 | 18.90 | 1.157 |
| 8 | 3.1566 | d8 | 1. | | 1.013 |
| 9 | 2.2403 | 1.5268 | 1.49700 | 81.54 | 0.981 |
| 10 | 3.3915 | d10 | 1. | | 0.697 |
| 11(Stop) | ∞ | 0.0783 | 1. | | 0.460 |
| 12* | 4.0614 | 0.3192 | 1.88300 | 40.76 | 0.485 |
| 13* | 11.1597 | 0.0830 | 1. | | 0.526 |
| 14 | 2.0140 | 0.3000 | 1.88300 | 40.76 | 0.578 |
| 15 | 1.5060 | 0.8356 | 1.51742 | 52.43 | 0.586 |
| 16 | −1.5170 | 0.0934 | 1. | | 0.663 |
| 17 | −10.3264 | 1.2276 | 1.51633 | 64.14 | 0.654 |
| 18 | −1.3625 | 0.2968 | 1.84666 | 23.78 | 0.649 |
| 19 | 1.8989 | 0.2849 | 1. | | 0.704 |
| 20 | −48.9192 | 0.5397 | 1.72916 | 54.68 | 0.805 |
| 21 | −2.6727 | 0.0956 | 1. | | 0.941 |
| 22 | 3.6698 | 0.5463 | 1.88300 | 40.76 | 1.093 |
| 23 | −86.8018 | 0.3500 | 1. | | 1.101 |
| 24 | ∞ | 1.4000 | 1.51633 | 64.14 | 1.111 |
| 25 | ∞ | 0.0757 | 1. | | 1.137 |
| Image plane | ∞ | 0. | | | |

Aspherical surface data
12th surface
K = 0.
A2 = 0.0000E+00, A4 = 2.2626E−02, A6 = −1.5521E−01, A8 = 7.9970E−01,
A10 = −1.6090E+00, A12 = −1.8424E−01, A14 = 1.3225E+00,
A16 = 0.0000E+00, A18 = 0.0000E+00, A20 = 0.0000E+00
13th surface
K = 0.
A2 = 0.0000E+00, A4 = 5.9775E−02, A6 = −3.6261E−02, A8 = 2.2828E−01,
A10 = −3.7908E−01, A12 = 7.3652E−02, A14 = −4.9792E−01,
A16 = 0.0000E+00, A18 = 0.0000E+00, A20 = 0.0000E+00
Various data

| | |
|---|---|
| Far Point | Near point |

| | | |
|---|---|---|
| OBJ | 21.0000 | 2.9000 |
| FL | 0.95940 | 0.97543 |
| MG | −0.042789 | −0.227651 |
| FNO | 3.9659 | 3.8809 |
| FIY | 1.140 | 1.140 |
| LTL | 12.4974 | 12.4974 |
| FB | 0.03465 | −0.14635 |
| d8 | 0.37036 | 1.16143 |
| d10 | 1.30128 | 0.51021 |
| β1 | 0.04739 | 0.23415 |
| β2 | 1.11562 | 1.20142 |
| β3 | −0.80926 | −0.80926 |

Unit focal length
f1 = −1.07556, f2 = 9.21973, f3 = 2.80485

### EXAMPLE 4

Unit mm
Surface data

| Surface no. | r | d | nd | νd | ER |
|---|---|---|---|---|---|
| Object plane | ∞ | 17.0000 | 1. | | |
| 1 | 15.3102 | 0.3700 | 1.88300 | 40.76 | 1.599 |
| 2 | 1.1966 | 0.6000 | 1. | | 0.984 |
| 3 | ∞ | 0.4000 | 1.51633 | 64.14 | 0.954 |
| 4 | ∞ | 0.1237 | 1. | | 0.861 |
| 5 | −4.3493 | 0.2945 | 1.88300 | 40.76 | 0.847 |
| 6 | 3.9526 | 0.0997 | 1. | | 0.808 |
| 7 | 2.6757 | 0.3827 | 1.92286 | 18.90 | 0.812 |
| 8 | 4.8533 | d8 | 1. | | 0.769 |
| 9 | 1.5638 | 0.5492 | 1.49700 | 81.54 | 0.722 |
| 10 | 1.8857 | d10 | 1. | | 0.608 |
| 11(Stop) | ∞ | 0.1894 | 1. | | 0.440 |
| 12* | 1.7762 | 0.6337 | 1.88300 | 40.76 | 0.531 |
| 13* | 2.5057 | 0.1195 | 1. | | 0.545 |
| 14 | 1.2102 | 0.3000 | 1.88300 | 40.76 | 0.624 |
| 15 | 0.8291 | 1.1497 | 1.51633 | 64.14 | 0.581 |
| 16 | −3.2685 | 0.0842 | 1. | | 0.655 |
| 17 | 27.1281 | 0.5645 | 1.51633 | 64.14 | 0.661 |
| 18 | −1.5659 | 0.2994 | 1.84666 | 23.78 | 0.673 |
| 19 | 2.1539 | 0.2692 | 1. | | 0.736 |
| 20 | −44.8577 | 0.5767 | 1.72916 | 54.68 | 0.827 |
| 21 | −2.4177 | 0.0958 | 1. | | 0.965 |
| 22 | 3.9931 | 0.5206 | 1.88300 | 40.76 | 1.102 |
| 23 | −539.6992 | 0.3500 | 1. | | 1.106 |
| 24 | ∞ | 1.4000 | 1.51633 | 64.14 | 1.115 |
| 25 | ∞ | 0.0637 | 1. | | 1.136 |
| Image plane | ∞ | 0. | | | |

Aspherical surface data
12th surface
K = 0.
A2 = 0.0000E+00, A4 = 5.3854E−02, A6 = −4.3114E−02, A8 = 1.4366E−02,
A10 = −1.9032E−01
13th surface
K = 0.
A2 = 0.0000E+00, A4 = 1.3081E−02, A6 = −1.9736E−03, A8 = 1.8859E−01,
A10 = −2.5241E−01
Various data

| | Far Point | Near point |
|---|---|---|
| OBJ | 17.0000 | 3.0000 |
| FL | 0.90903 | 0.91374 |
| MG | −0.050175 | −0.222882 |
| FNO | 3.9445 | 3.8983 |
| FIY | 1.140 | 1.140 |
| LTL | 10.9752 | 10.9752 |
| FB | 0.01805 | −0.14000 |
| d8 | 0.29022 | 0.97306 |
| d10 | 1.24881 | 0.56597 |
| β1 | 0.04790 | 0.20199 |
| β2 | 1.08825 | 1.14628 |
| β3 | −0.96262 | −0.96262 |

Unit focal length
f1 = −0.87897, f2 = 11.76596, f3 = 2.85173

### EXAMPLE 5

Unit mm
Surface data

| Surface no. | r | d | nd | νd | ER |
|---|---|---|---|---|---|
| Object plane | ∞ | 17.0000 | 1. | | |
| 1 | ∞ | 0.3700 | 1.88300 | 40.76 | 1.552 |
| 2 | 1.4427 | 0.6000 | 1. | | 1.048 |
| 3 | ∞ | 0.4000 | 1.51633 | 64.14 | 1.002 |
| 4 | ∞ | 0.1419 | 1. | | 0.922 |
| 5 | −5.0092 | 0.2947 | 1.88300 | 40.76 | 0.903 |
| 6 | 4.0068 | 0.0930 | 1. | | 0.871 |
| 7 | 2.6817 | 0.3753 | 1.92286 | 18.90 | 0.881 |
| 8 | 4.0950 | d8 | 1. | | 0.840 |
| 9 | 1.8092 | 0.8256 | 1.49700 | 81.54 | 0.818 |
| 10 | 2.3066 | d10 | 1. | | 0.671 |
| 11(Stop) | ∞ | 0.0969 | 1. | | 0.488 |
| 12* | 1.9634 | 0.6546 | 1.88300 | 40.76 | 0.561 |
| 13* | 3.5168 | 0.0901 | 1. | | 0.584 |
| 14 | 1.2927 | 0.3000 | 1.88300 | 40.76 | 0.648 |
| 15 | 0.8839 | 1.0754 | 1.51633 | 64.14 | 0.603 |
| 16 | −2.7768 | 0.0915 | 1. | | 0.656 |
| 17 | −21.0091 | 0.6278 | 1.51633 | 64.14 | 0.652 |
| 18 | −1.3658 | 0.2927 | 1.84666 | 23.78 | 0.651 |
| 19 | 1.8952 | 0.2823 | 1. | | 0.706 |
| 20 | −41.9161 | 0.5461 | 1.72916 | 54.68 | 0.805 |
| 21 | −2.5714 | 0.0899 | 1. | | 0.943 |
| 22 | 3.7819 | 0.5408 | 1.88300 | 40.76 | 1.094 |
| 23 | −51.6584 | 0.3500 | 1. | | 1.103 |
| 24 | ∞ | 1.4000 | 1.51633 | 64.14 | 1.113 |
| 25 | ∞ | 0.0498 | 1. | | 1.139 |
| Image plane | ∞ | 0. | | | |

Aspherical surface data
12th surface
K = 0.
A2 = 0.0000E+00, A4 = 4.3391E−02, A6 = −2.6969E−02, A8 = 9.7138E−02,
A10 = −1.2694E−01
13th surface
K = 0.
A2 = 0.0000E+00, A4 = 9.8705E−02, A6 = −4.0824E−03, A8 = 1.1194E−01,
A10 = −1.5093E−01
Various data

| | Far Point | Near point |
|---|---|---|
| OBJ | 17.0000 | 3.0000 |
| FL | 0.98300 | 0.99238 |
| MG | −0.054168 | −0.240762 |
| FNO | 3.9032 | 3.8269 |
| FIY | 1.140 | 1.140 |
| LTL | 11.1729 | 11.1729 |
| FB | −0.00342 | −0.18910 |
| d8 | 0.27395 | 1.03962 |
| d10 | 1.31040 | 0.54473 |
| β1 | 0.04986 | 0.20803 |
| β2 | 1.07626 | 1.14662 |
| β3 | −1.00936 | −1.00936 |

Unit focal length
f1 = −0.91815, f2 = 10.88320, f3 = 2.78827

### EXAMPLE 6

Unit mm
Surface data

| Surface no. | r | d | nd | νd | ER |
|---|---|---|---|---|---|
| Object plane | ∞ | 17.0000 | 1. | | |
| 1 | 20.0000 | 0.3700 | 1.88300 | 40.76 | 1.562 |
| 2 | 1.2067 | 0.6000 | 1. | | 0.977 |
| 3 | ∞ | 0.4000 | 1.51633 | 64.14 | 0.943 |
| 4 | ∞ | 0.1010 | 1. | | 0.858 |
| 5 | −5.0015 | 0.2886 | 1.88300 | 40.76 | 0.848 |
| 6 | 2.9519 | 0.0923 | 1. | | 0.809 |
| 7 | 1.8550 | 0.3815 | 1.92286 | 18.90 | 0.826 |
| 8 | 2.6141 | d8 | 1. | | 0.770 |
| 9 | 1.6760 | 0.5923 | 1.49700 | 81.54 | 0.741 |
| 10 | 2.0720 | d10 | 1. | | 0.633 |
| 11(Stop) | ∞ | 0.0830 | 1. | | 0.467 |
| 12* | 2.2198 | 0.3481 | 1.88300 | 40.76 | 0.540 |
| 13* | 5.1027 | 0.0877 | 1. | | 0.557 |
| 14 | 1.2752 | 0.3000 | 1.88300 | 40.76 | 0.619 |
| 15 | 0.8381 | 1.2698 | 1.51633 | 64.14 | 0.576 |
| 16 | −2.6992 | 0.0857 | 1. | | 0.654 |
| 17 | −12.8077 | 0.7528 | 1.51633 | 64.14 | 0.653 |
| 18 | −1.3481 | 0.2875 | 1.84666 | 23.78 | 0.661 |
| 19 | 1.9079 | 0.2786 | 1. | | 0.727 |
| 20 | 1813.5266 | 0.5922 | 1.72916 | 54.68 | 0.840 |
| 21 | −2.5422 | 0.0839 | 1. | | 0.995 |
| 22 | 3.2963 | 0.6109 | 1.88300 | 40.76 | 1.188 |
| 23 | −74.5199 | 0.3000 | 1. | | 1.186 |
| 24 | ∞ | 1.4000 | 1.51633 | 64.14 | 1.178 |
| 25 | ∞ | 0.0758 | 1. | | 1.155 |
| Image plane | ∞ | 0. | | | |

Aspherical surface data
12th surface
K = 0.
A2 = 0.0000E+00, A4 = 9.4238E−02, A6 = −1.3465E−01, A8 = 6.9001E−01,
A10 = −1.1061E+00
13th surface
K = 0.
A2 = 0.0000E+00, A4 = 1.2940E−01, A6 = −2.9245E−02, A8 = 3.1386E−01,
A10 = −5.4631E−01
Various data

| | Far Point | Near point |
|---|---|---|
| OBJ | 17.0000 | 3.0000 |
| FL | 0.90631 | 0.91421 |
| MG | −0.050070 | −0.223755 |
| FNO | 3.9341 | 3.8945 |
| FIY | 1.140 | 1.140 |
| LTL | 10.8752 | 10.8752 |
| FB | 0.03039 | −0.12879 |
| d8 | 0.34193 | 0.98043 |
| d10 | 1.15150 | 0.51300 |
| β1 | 0.04307 | 0.18324 |
| β2 | 1.07292 | 1.12708 |
| β3 | −1.08345 | −1.08345 |

Unit focal length
f1 = −0.78833, f2 = 11.79037, f3 = 2.97621

### EXAMPLE 7

Unit mm
Surface data

| Surface no. | r | d | nd | νd | ER |
|---|---|---|---|---|---|
| Object plane | ∞ | 17.0000 | 1. | | |
| 1 | 20.0000 | 0.3700 | 1.88300 | 40.76 | 1.565 |
| 2 | 1.1942 | 0.6000 | 1. | | 0.975 |
| 3 | ∞ | 0.3600 | 1.51633 | 64.14 | 0.945 |
| 4 | ∞ | 0.0180 | 1. | | 0.872 |
| 5 | −39.2627 | 0.2712 | 1.88300 | 40.76 | 0.869 |
| 6 | 2.1856 | 0.0689 | 1. | | 0.804 |
| 7 | 1.5180 | 0.3499 | 1.92286 | 18.90 | 0.813 |
| 8 | 1.8920 | d8 | 1. | | 0.744 |
| 9 | 1.3113 | 0.3642 | 1.49700 | 81.54 | 0.700 |
| 10 | 1.5503 | d10 | 1. | | 0.619 |
| 11(Stop) | ∞ | 0.0540 | 1. | | 0.428 |
| 12* | 2.4371 | 0.2640 | 1.88300 | 40.76 | 0.451 |
| 13* | 2.7511 | 0.0751 | 1. | | 0.472 |
| 14 | 1.6332 | 0.3000 | 1.88300 | 40.76 | 0.530 |
| 15 | 1.8390 | 0.8427 | 1.51633 | 64.14 | 0.553 |
| 16 | −1.2298 | 0.0861 | 1. | | 0.653 |
| 17 | −4.6698 | 1.3113 | 1.51633 | 64.14 | 0.643 |
| 18 | −1.3468 | 0.2905 | 1.84666 | 23.78 | 0.663 |
| 19 | 1.9205 | 0.2998 | 1. | | 0.732 |
| 20 | −19.8757 | 0.6269 | 1.72916 | 54.68 | 0.848 |
| 21 | −2.1528 | 0.0818 | 1. | | 1.016 |
| 22 | 3.4557 | 0.6199 | 1.88300 | 40.76 | 1.217 |
| 23 | −28.5947 | 0.2000 | 1. | | 1.213 |
| 24 | ∞ | 1.5000 | 1.51633 | 64.14 | 1.201 |
| 25 | ∞ | 0.0640 | 1. | | 1.148 |
| Image plane | ∞ | 0. | | | |

Aspherical surface data
12th surface
K = 0.
A2 = 0.0000E+00, A4 = 2.3881E−01, A6 = 7.1261E−02, A8 = −4.0179E−01,
A10 = 0.0000E+00
13th surface
K = 0.
A2 = 0.0000E+00, A4 = 3.5728E−01, A6 = 1.7739E−01, A8 = −2.8920E−01,
A10 = 0.0000E+00
Various data

| | Far Point | Near point |
|---|---|---|
| OBJ | 17.0000 | 3.0000 |
| FL | 0.87488 | 0.88419 |
| MG | −0.048244 | −0.214621 |
| FNO | 3.9284 | 3.8945 |
| FIY | 1.140 | 1.140 |
| LTL | 10.5175 | 10.5175 |
| FB | 0.02181 | −0.12575 |
| d8 | 0.32999 | 0.94108 |
| d10 | 1.16920 | 0.55811 |
| β1 | 0.04475 | 0.18971 |
| β2 | 1.08766 | 1.14143 |
| β3 | −0.99113 | −0.99113 |

Unit focal length
f1 = −0.81998, f2 = 11.36494, f3 = 3.10154

### EXAMPLE 8

Unit mm
Surface data

| Surface no. | r | d | nd | νd | ER |
|---|---|---|---|---|---|
| Object plane | ∞ | 17.0000 | 1. | | |
| 1 | 20.0000 | 0.3700 | 1.88300 | 40.76 | 2.170 |
| 2 | 1.8355 | 0.6000 | 1. | | 1.438 |
| 3 | ∞ | 0.4000 | 1.51633 | 64.14 | 1.482 |
| 4 | ∞ | 0.3651 | 1. | | 1.367 |
| 5 | −6.0073 | 0.7484 | 1.88300 | 40.76 | 1.260 |
| 6 | 3.8110 | 0.5388 | 1. | | 1.141 |
| 7 | 2.9102 | 0.4410 | 1.92286 | 18.90 | 1.179 |
| 8 | 4.0476 | d8 | 1. | | 1.118 |
| 9 | 2.4287 | 1.7001 | 1.49700 | 81.54 | 1.088 |
| 10 | 3.4681 | d10 | 1. | | 0.763 |
| 11(Stop) | ∞ | 0.0944 | 1. | | 0.501 |
| 12* | 1.7041 | 0.3825 | 1.88300 | 40.76 | 0.600 |
| 13* | 5.1778 | 0.2781 | 1. | | 0.590 |
| 14 | −29.8880 | 0.3000 | 1.88300 | 40.76 | 0.629 |
| 15 | 2.9929 | 0.6826 | 1.51633 | 64.14 | 0.668 |
| 16 | −1.6314 | 0.1268 | 1. | | 0.749 |
| 17 | −8.7698 | 1.5571 | 1.51633 | 64.14 | 0.757 |
| 18 | −1.4188 | 0.3403 | 1.84666 | 23.78 | 0.820 |
| 19 | 4.3711 | 0.6288 | 1. | | 0.933 |
| 20 | 264.1515 | 0.7659 | 1.72916 | 54.68 | 1.240 |
| 21 | −2.7702 | 0.1844 | 1. | | 1.362 |
| 22 | 2.3631 | 0.6206 | 1.88300 | 40.76 | 1.495 |
| 23 | 3.9331 | 0.4000 | 1. | | 1.392 |
| 24 | ∞ | 1.4000 | 1.51633 | 64.14 | 1.358 |
| 25 | ∞ | 0.0411 | 1. | | 1.147 |
| Image plane | ∞ | 0. | | | |

Aspherical surface data
12th surface
K = 0.
A2 = 0.0000E+00, A4 = 5.2580E−02, A6 = 5.3691E−02, A8 = −3.8939E−03,
A10 = 0.0000E+00
13th surface
K = 0.
A2 = 0.0000E+00, A4 = 1.2458E−01, A6 = 7.6091E−02, A8 = 4.8603E−02,
A10 = 0.0000E+00
Various data

| | Far Point | Near point |
|---|---|---|
| OBJ | 17.0000 | 3.0000 |
| FL | 0.96374 | 0.99290 |
| MG | −0.051712 | −0.215244 |
| FNO | 3.8797 | 3.8945 |
| FIY | 1.140 | 1.140 |
| LTL | 14.5440 | 14.5440 |
| FB | −0.00878 | −0.17266 |
| d8 | 0.28712 | 1.03089 |
| d10 | 1.29110 | 0.54733 |
| β1 | 0.06071 | 0.23796 |
| β2 | 1.13728 | 1.20767 |
| β3 | −0.74900 | −0.74900 |

Unit focal length
f1 = −1.14099, f2 = 10.56718, f3 = 4.20765

### EXAMPLE 9

Unit mm
Surface data

| Surface no. | r | d | nd | νd | ER |
|---|---|---|---|---|---|
| Object plane | ∞ | 17.0000 | 1. | | |
| 1 | 18.6062 | 0.3700 | 1.88300 | 40.76 | 1.550 |
| 2 | 1.1634 | 0.6000 | 1. | | 0.954 |
| 3 | ∞ | 0.4000 | 1.51633 | 64.14 | 0.921 |
| 4 | ∞ | 0.2106 | 1. | | 0.839 |
| 5 | −2.9012 | 0.2987 | 1.88300 | 40.76 | 0.816 |
| 6 | 6.6566 | 0.0969 | 1. | | 0.825 |
| 7 | 2.2651 | 0.4862 | 1.67270 | 32.10 | 0.857 |
| 8 | 7.9728 | d8 | 1. | | 0.830 |
| 9 | 2.1192 | 0.9855 | 1.49700 | 81.54 | 0.806 |
| 10 | 2.7662 | d10 | 1. | | 0.651 |
| 11(Stop) | ∞ | 0.0820 | 1. | | 0.510 |
| 12* | 1.5966 | 0.3119 | 1.88300 | 40.76 | 0.557 |
| 13* | 1.8942 | 0.0923 | 1. | | 0.547 |
| 14 | 1.2718 | 0.3000 | 1.88300 | 40.76 | 0.588 |
| 15 | 0.8534 | 1.2563 | 1.51742 | 52.43 | 0.549 |
| 16 | −2.5219 | 0.2499 | 1. | | 0.650 |
| 17 | 263.2306 | 0.8622 | 1.49700 | 81.54 | 0.650 |
| 18 | −1.3145 | 0.3172 | 1.92286 | 18.90 | 0.650 |
| 19 | 2.8013 | 0.1794 | 1. | | 0.733 |
| 20 | 17.9648 | 0.6025 | 1.78472 | 25.68 | 0.806 |
| 21 | −2.5539 | 0.0985 | 1. | | 0.937 |
| 22 | 4.4647 | 0.4767 | 1.78472 | 25.68 | 1.044 |
| 23 | 837.6148 | 0.3500 | 1. | | 1.056 |
| 24 | ∞ | 1.5000 | 1.51633 | 64.14 | 1.078 |
| 25 | ∞ | 0.0239 | 1. | | 1.140 |
| Image plane | ∞ | 0. | | | |

Aspherical surface data
12th surface
K = 0.
A2 = 0.0000E+00, A4 = 5.4679E−02, A6 = −7.3153E−02, A8 = 1.8821E−01,
A10 = −2.6187E−01
13th surface
K = 0.
A2 = 0.0000E+00, A4 = 1.1151E−01, A6 = −2.3505E−02, A8 = 4.5913E−02,
A10 = −1.4874E−01
Various data

| | Far Point | Near point |
|---|---|---|
| OBJ | 17.0000 | 3.0000 |
| FL | 0.95516 | 0.95802 |
| MG | −0.052812 | −0.235620 |
| FNO | 3.9309 | 3.8269 |
| FIY | 1.140 | 1.140 |
| LTL | 11.7045 | 11.7045 |
| FB | −0.02656 | −0.20184 |
| d8 | 0.28665 | 1.04021 |
| d10 | 1.26710 | 0.51353 |
| β1 | 0.05086 | 0.21466 |
| β2 | 1.08934 | 1.15157 |
| β3 | −0.95317 | −0.95317 |

Unit focal length
f1 = −0.93319, f2 = 12.10818, f3 = 2.86916

### EXAMPLE 10

Unit mm
Surface data

| Surface no. | r | d | nd | νd | ER |
|---|---|---|---|---|---|
| Object plane | ∞ | 17.0000 | 1. | | |
| 1 | 19.8742 | 0.3700 | 1.88300 | 40.76 | 1.550 |
| 2 | 1.2066 | 0.6000 | 1. | | 0.974 |
| 3 | ∞ | 0.4000 | 1.51633 | 64.14 | 0.939 |
| 4 | ∞ | 0.1870 | 1. | | 0.853 |
| 5 | −2.9762 | 0.2940 | 1.88300 | 40.76 | 0.830 |
| 6 | 6.6868 | 0.0846 | 1. | | 0.831 |
| 7 | 2.2551 | 0.4504 | 1.67270 | 32.10 | 0.858 |
| 8 | 5.6876 | d8 | 1. | | 0.827 |
| 9 | 2.1401 | 0.9736 | 1.49700 | 81.54 | 0.808 |
| 10 | 2.8349 | d10 | 1. | | 0.659 |
| 11(Stop) | ∞ | 0.0913 | 1. | | 0.510 |
| 12* | 1.7102 | 0.3314 | 1.88300 | 40.76 | 0.573 |
| 13* | 2.9335 | 0.0899 | 1. | | 0.569 |
| 14 | 1.3932 | 0.3000 | 1.88300 | 40.76 | 0.607 |
| 15 | 0.8725 | 1.4839 | 1.51742 | 52.43 | 0.566 |
| 16 | −8.1462 | 0.0937 | 1. | | 0.650 |
| 17 | 5.6790 | 0.6732 | 1.49700 | 81.54 | 0.650 |
| 18 | −1.3074 | 0.2989 | 1.92286 | 18.90 | 0.650 |
| 19 | 2.5588 | 0.1958 | 1. | | 0.743 |
| 20 | 26.2276 | 0.5615 | 1.78472 | 25.68 | 0.819 |
| 21 | −2.8090 | 0.0958 | 1. | | 0.952 |
| 22 | 3.1496 | 0.5535 | 1.78472 | 25.68 | 1.107 |
| 23 | 40.7148 | 0.3500 | 1. | | 1.108 |
| 24 | ∞ | 1.4000 | 1.51633 | 64.14 | 1.117 |
| 25 | ∞ | 0.0707 | 1. | | 1.141 |
| Image plane | ∞ | 0. | | | |

Aspherical surface data
12th surface
K = 0.
A2 = 0.0000E+00, A4 = 4.1428E−02, A6 = 0.0000E+00, A8 = 0.0000E+00, A10 = 0.0000E+00
13th surface
K = 0.
A2 = 0.0000E+00, A4 = 8.6016E−02, A6 = 0.0000E+00, A8 = 0.0000E+00, A10 = 0.0000E+00
Various data

| | Far Point | Near point |
|---|---|---|
| OBJ | 17.0000 | 3.0000 |
| FL | 0.96353 | 0.96607 |
| MG | −0.053262 | −0.237339 |
| FNO | 3.9044 | 3.8269 |
| FIY | 1.140 | 1.140 |
| LTL | 11.4798 | 11.4798 |
| FB | 0.01936 | −0.15861 |
| d8 | 0.30098 | 1.04502 |
| d10 | 1.22970 | 0.48566 |
| β1 | 0.04947 | 0.20848 |
| β2 | 1.08330 | 1.14536 |
| β3 | −0.99393 | −0.99393 |

Unit focal length
f1 = −0.90795, f2 = 11.99039, f3 = 2.80477

### EXAMPLE 11

Unit mm
Surface data

| Surface no. | r | d | nd | νd | ER |
|---|---|---|---|---|---|
| Object plane | ∞ | 17.0000 | 1. | | |
| 1 | 20.9620 | 0.3700 | 1.88300 | 40.76 | 1.550 |
| 2 | 1.2338 | 0.6000 | 1. | | 0.999 |
| 3 | ∞ | 0.4000 | 1.51633 | 64.14 | 0.976 |
| 4 | ∞ | 0.1830 | 1. | | 0.911 |
| 5 | −3.1562 | 0.2965 | 1.88300 | 40.76 | 0.898 |
| 6 | 10.4925 | 0.2368 | 1. | | 0.908 |
| 7 | 2.2707 | 0.5569 | 1.49700 | 81.54 | 0.978 |
| 8 | 11.8822 | d8 | 1. | | 0.958 |
| 9 | 2.1589 | 0.8171 | 1.49700 | 81.54 | 0.943 |
| 10 | 2.5943 | d10 | 1. | | 0.810 |
| 11* | 2.0204 | 0.4822 | 1.88300 | 40.76 | 0.638 |
| 12* | −16.3846 | 0.1054 | 1. | | 0.558 |
| 13(Stop) | ∞ | 0.1017 | 1. | | 0.509 |
| 14 | −7.2907 | 1.2809 | 1.88300 | 40.76 | 0.514 |
| 15 | 11.3314 | 0.4763 | 1.59270 | 35.31 | 0.607 |
| 16 | −2.5210 | 0.0896 | 1. | | 0.650 |
| 17 | −31.0499 | 0.9626 | 1.49700 | 81.54 | 0.650 |
| 18 | −1.1421 | 0.6997 | 1.92286 | 18.90 | 0.653 |
| 19 | 3.5946 | 0.1370 | 1. | | 0.824 |
| 20 | 7.8641 | 0.8422 | 1.59270 | 35.31 | 0.889 |
| 21 | −2.4643 | 0.0946 | 1. | | 1.069 |
| 22 | 4.0200 | 0.6714 | 1.59270 | 35.31 | 1.196 |
| 23 | −8.1303 | 0.4000 | 1. | | 1.207 |
| 24 | ∞ | 1.4000 | 1.51633 | 64.14 | 1.185 |
| 25 | ∞ | 0.0455 | 1. | | 1.143 |
| Image plane | ∞ | 0. | | | |

Aspherical surface data
11th surface
A2 = 0.0000E+00, A4 = 5.2048E−03, A6 = 0.0000E+00, A8 = 0.0000E+00,
A10 = 0.0000E+00
12th surface
K = 0.
A2 = 0.0000E+00, A4 = 3.4430E−02, A6 = 0.0000E+00, A8 = 0.0000E+00,
A10 = 0.0000E+00
Various data

| | Far Point | Near point |
|---|---|---|
| OBJ | 17.0000 | 3.0000 |
| FL | 1.03814 | 1.05251 |
| MG | −0.057025 | −0.251642 |
| FNO | 3.9308 | 3.8892 |
| FIY | 1.140 | 1.140 |
| LTL | 13.0128 | 13.0128 |
| FB | −0.01369 | −0.21935 |
| d8 | 0.19947 | 1.25695 |
| d10 | 1.56410 | 0.50662 |
| β1 | 0.05863 | 0.24372 |
| β2 | 1.07788 | 1.14419 |
| β3 | −0.90240 | −0.90240 |

Unit focal length
f1 = −1.08076, f2 = 15.94753, f3 = 3.93285

### EXAMPLE 12

Unit mm
Surface data

| Surface no. | r | d | nd | νd | ER |
|---|---|---|---|---|---|
| Object plane | ∞ | 17.0000 | 1. | | |
| 1 | 21.9386 | 0.3700 | 1.88300 | 40.76 | 1.550 |
| 2 | 1.2258 | 0.8000 | 1. | | 0.992 |
| 3 | −2.8566 | 0.3000 | 1.88300 | 40.76 | 0.960 |
| 4 | 174.3190 | 0.0516 | 1. | | 0.982 |
| 5 | ∞ | 0.4000 | 1.51633 | 64.14 | 0.987 |
| 6 | ∞ | 0.0975 | 1. | | 1.012 |
| 7 | 2.4564 | 0.5721 | 1.49700 | 81.54 | 1.061 |
| 8 | 11.4461 | d8 | 1. | | 1.037 |
| 9 | 2.3896 | 0.9090 | 1.49700 | 81.54 | 1.021 |
| 10 | 2.8557 | d10 | 1. | | 0.868 |
| 11* | 2.0968 | 0.4728 | 1.88300 | 40.76 | 0.635 |
| 12* | −34.9927 | 0.1181 | 1. | | 0.555 |
| 13(Stop) | ∞ | 0.1124 | 1. | | 0.509 |
| 14 | −16.2807 | 1.2187 | 1.88300 | 40.76 | 0.516 |
| 15 | 3.0415 | 0.5676 | 1.59270 | 35.31 | 0.590 |
| 16 | −2.5084 | 0.0933 | 1. | | 0.650 |
| 17 | 238.5588 | 0.8354 | 1.49700 | 81.54 | 0.650 |
| 18 | −1.2016 | 0.6861 | 1.92286 | 18.90 | 0.653 |
| 19 | 3.2106 | 0.1311 | 1. | | 0.814 |
| 20 | 6.0640 | 0.9639 | 1.59270 | 35.31 | 0.881 |
| 21 | −2.3130 | 0.0947 | 1. | | 1.086 |
| 22 | 3.5666 | 0.6298 | 1.59270 | 35.31 | 1.208 |
| 23 | −21.6855 | 0.4000 | 1. | | 1.205 |
| 24 | ∞ | 1.4000 | 1.51633 | 64.14 | 1.185 |
| 25 | ∞ | 0.0454 | 1. | | 1.142 |
| Image plane | ∞ | 0. | | | |

Aspherical surface data
11th surface
K = 0.
A2 = 0.0000E+00, A4 = 3.4520E−03, A6 = 0.0000E+00, A8 = 0.0000E+00,
A10 = 0.0000E+00
12th surface
K = 0.
A2 = 0.0000E+00, A4 = 2.7958E−02, A6 = 0.0000E+00, A8 = 0.000E+00,
A10 = 0.0000E+00
Various data

| | Far Point | Near point |
|---|---|---|
| OBJ | 17.0000 | 3.0000 |
| FL | 1.03354 | 1.05290 |
| MG | −0.056751 | −0.251722 |
| FNO | 3.9308 | 3.8892 |
| FIY | 1.140 | 1.140 |
| LTL | 13.3185 | 13.3185 |
| FB | −0.01328 | −0.21967 |
| d8 | 0.12592 | 1.49850 |
| d10 | 1.92320 | 0.55062 |
| β1 | 0.06606 | 0.27339 |
| β2 | 1.06944 | 1.14620 |
| β3 | −0.80330 | −0.80330 |

Unit focal length
f1 = −1.21950, f2 = 17.88097, f3 = 4.00725

### EXAMPLE 13

Unit mm
Surface data

| Surface no. | r | d | nd | νd | ER |
|---|---|---|---|---|---|
| Object plane | ∞ | 17.0000 | 1. | | |
| 1 | 4593.5725 | 0.3000 | 1.88300 | 40.76 | 1.590 |
| 2 | 1.8010 | 0.8127 | 1. | | 1.169 |
| 3 | −3.7788 | 0.3000 | 1.88300 | 40.76 | 1.086 |
| 4 | 4.3823 | 0.2246 | 1. | | 1.066 |
| 5 | ∞ | 0.4000 | 1.51633 | 64.14 | 1.081 |
| 6 | ∞ | 0.0929 | 1. | | 1.123 |
| 7 | 3.2739 | 0.8162 | 1.69895 | 30.13 | 1.173 |
| 8 | 14.5436 | d8 | 1. | | 1.130 |
| 9 | 2.5871 | 1.2160 | 1.49700 | 81.54 | 1.107 |
| 10 | 3.1622 | d10 | 1. | | 0.897 |
| 11* | 2.0474 | 0.4563 | 1.80625 | 40.91 | 0.650 |
| 12* | 74.2204 | 0.1053 | 1. | | 0.570 |
| 13(Stop) | ∞ | 0.1297 | 1. | | 0.530 |
| 14 | 12.3207 | 1.1009 | 1.88300 | 40.76 | 0.545 |
| 15 | 2.6317 | 0.6127 | 1.49700 | 81.54 | 0.590 |
| 16 | −2.3609 | 0.0973 | 1. | | 0.640 |
| 17 | 7.4791 | 0.6955 | 1.49700 | 81.54 | 0.646 |
| 18 | −1.2395 | 0.4408 | 1.84666 | 23.78 | 0.640 |
| 19 | 2.3864 | 0.2108 | 1. | | 0.715 |
| 20 | 38.1959 | 0.7959 | 1.69895 | 30.13 | 0.777 |
| 21 | −3.1050 | 0.0956 | 1. | | 0.963 |
| 22 | 5.7534 | 0.6818 | 1.69895 | 30.13 | 1.056 |
| 23 | 18.7580 | 0.3966 | 1. | | 1.101 |
| 24 | 5.0000 | 1.0000 | 1.88300 | 40.76 | 1.186 |
| 25 | ∞ | 0.6000 | 1.51633 | 64.14 | 1.162 |
| 26 | ∞ | 0.0446 | 1. | | 1.140 |
| Image plane | ∞ | 0. | | | |

Aspherical surface data
11th surface
K = −1.0011
A2 = 0.0000E+00, A4 = 1.4360E−02, A6 = 0.0000E+00, A8 = 0.0000E+00,
A10 = 0.0000E+00
12th surface
K = 0.
A2 = 0.0000E+00, A4 = 2.4606E−02, A6 = 0.000E+00, A8 = 0.000E+00,
A10 = 0.0000E+00
Various data

| | Far Point | Near point |
|---|---|---|
| OBJ | 17.0000 | 3.0000 |
| FL | 1.06491 | 1.08873 |
| MG | −0.058085 | −0.253210 |
| FNO | 3.9121 | 3.8728 |
| FIY | 1.140 | 1.140 |
| LTL | 13.5917 | 13.5917 |
| FB | −0.01730 | −0.23112 |
| d8 | 0.19271 | 1.57621 |
| d10 | 1.77286 | 0.38935 |
| β1 | 0.06905 | 0.27961 |
| β2 | 1.07444 | 1.15671 |
| β3 | −0.78290 | −0.78290 |

Unit focal length
f1 = −1.28375, f2 = 16.81637, f3 = 4.06497

### EXAMPLE 14

Unit mm
Surface data

| Surface no. | r | d | nd | νd | ER |
|---|---|---|---|---|---|
| Object plane | ∞ | 17.0000 | 1. | | |
| 1 | 183.0435 | 0.3000 | 1.88300 | 40.76 | 1.567 |
| 2 | 1.6351 | 0.7418 | 1. | | 1.130 |
| 3 | −5.3532 | 0.3000 | 1.88300 | 40.76 | 1.072 |
| 4 | 3.7334 | 0.2526 | 1. | | 1.037 |
| 5 | ∞ | 0.4000 | 1.51633 | 64.14 | 1.052 |
| 6 | ∞ | 0.0928 | 1. | | 1.089 |
| 7 | 5.8272 | 0.7897 | 1.84666 | 23.78 | 1.118 |
| 8 | −16.3104 | d8 | 1. | | 1.108 |
| 9 | 1.8976 | 0.6133 | 1.49700 | 81.54 | 1.061 |
| 10 | 2.1276 | d10 | 1. | | 0.926 |
| 11* | 2.3773 | 0.6982 | 1.88300 | 40.76 | 0.638 |
| 12* | 5.3212 | 0.1365 | 1. | | 0.492 |
| 13(Stop) | ∞ | 0.0718 | 1. | | 0.456 |
| 14 | 3.6709 | 0.6305 | 1.49700 | 81.54 | 0.482 |
| 15 | −1.1294 | 0.3600 | 1.83400 | 37.16 | 0.539 |
| 16 | −1.8384 | 0.0709 | 1. | | 0.617 |
| 17 | 6.9948 | 1.1545 | 1.49700 | 81.54 | 0.631 |
| 18 | −8.6783 | 0.2803 | 1.84666 | 23.78 | 0.649 |
| 19 | 1.7726 | 0.3091 | 1. | | 0.660 |
| 20 | −8.4255 | 0.6106 | 1.53172 | 48.84 | 0.731 |
| 21 | −3.3806 | 0.0794 | 1. | | 0.901 |
| 22 | 9.4522 | 0.6243 | 1.53172 | 48.84 | 0.992 |
| 23 | −5.5446 | 0.3682 | 1. | | 1.077 |
| 24 | 5.0000 | 1.0000 | 1.88300 | 40.76 | 1.184 |
| 25 | ∞ | 0.6000 | 1.51633 | 64.14 | 1.163 |
| 26 | ∞ | 0.0447 | 1. | | 1.144 |
| Image plane | ∞ | 0. | | | |

Aspherical surface data
11th surface
K = 0.0300
A2 = 0.0000E+00, A4 = 2.1472E−02, A6 = 0.0000E+00, A8 = 0.0000E+00, A10 = 0.0000E+00
12th surface
K = 0.
A2 = 0.0000E+00, A4 = 5.2265E−02, A6 = 0.0000E+00, A8 = 0.0000E+00, A10 = 0.0000E+00
Various data

| | Far Point | Near point |
|---|---|---|
| OBJ | 17.0000 | 3.0000 |
| FL | 1.04844 | 1.04957 |
| MG | −0.057353 | −0.246984 |
| FNO | 3.9434 | 3.9046 |
| FIY | 1.140 | 1.140 |
| LTL | 12.5475 | 12.5475 |
| FB | −0.01543 | −0.21453 |
| d8 | 0.18482 | 1.58836 |
| d10 | 1.83356 | 0.43002 |
| β1 | 0.07999 | 0.32292 |
| β2 | 1.12377 | 1.19870 |
| β3 | −0.63806 | −0.63806 |

Unit focal length
f1 = −1.48851, f2 = 18.73235, f3 = 3.81683

### EXAMPLE 15

Unit mm
Surface data

| Surface no. | r | d | nd | νd | ER |
|---|---|---|---|---|---|
| Object plane | ∞ | 17.0000 | 1. | | |
| 1 | 109.4062 | 0.3000 | 1.88300 | 40.76 | 1.551 |
| 2 | 1.6962 | 0.5868 | 1. | | 1.127 |
| 3 | −8.1478 | 0.3000 | 1.72916 | 54.68 | 1.096 |
| 4 | 2.7443 | 0.2935 | 1. | | 1.015 |
| 5 | ∞ | 0.4000 | 1.51633 | 64.14 | 1.018 |
| 6 | ∞ | 0.0561 | 1. | | 1.029 |
| 7 | 2.3860 | 0.6327 | 1.84666 | 23.78 | 1.040 |
| 8 | 2.9940 | d8 | 1. | | 0.934 |
| 9 | 1.9938 | 0.4728 | 1.49700 | 81.54 | 0.911 |
| 10 | 2.3810 | d10 | 1. | | 0.822 |
| 11* | 1.6998 | 0.5078 | 1.78472 | 25.68 | 0.600 |
| 12* | 2.5418 | 0.2147 | 1. | | 0.484 |
| 13(Stop) | ∞ | 0.0551 | 1. | | 0.438 |
| 14 | 2.5945 | 0.7314 | 1.49700 | 81.54 | 0.469 |
| 15 | −1.0062 | 0.2745 | 1.88300 | 40.76 | 0.545 |
| 16 | −1.6216 | 0.0551 | 1. | | 0.619 |
| 17 | 3.5079 | 1.3333 | 1.49700 | 81.54 | 0.641 |
| 18 | −2.3662 | 0.2906 | 1.84666 | 23.78 | 0.640 |
| 19 | 1.7389 | 0.3044 | 1. | | 0.666 |
| 20 | −13.4498 | 0.6304 | 1.88300 | 40.76 | 0.754 |
| 21 | −3.6032 | 0.0823 | 1. | | 0.918 |
| 22 | 10.1934 | 0.5970 | 1.84666 | 23.78 | 1.006 |
| 23 | −15.3963 | 0.3722 | 1. | | 1.073 |
| 24 | 5.0000 | 1.0000 | 1.88300 | 40.76 | 1.175 |
| 25 | ∞ | 0.6000 | 1.51633 | 64.14 | 1.159 |
| 26 | ∞ | 0.0443 | 1. | | 1.145 |
| Image plane | ∞ | 0. | | | |

Aspherical surface data
11th surface
K = −0.1219
A2 = 0.0000E+00, A4 = 3.5195E−02, A6 = 0.0000E+00, A8 = 0.0000E+00, A10 = 0.0000E+00
12th surface
K = 0.
A2 = 0.0000E+00, A4 = 8.3710E−02, A6 = 0.0000E+00, A8 = 0.0000E+00, A10 = 0.0000E+00
Various data

| | Far Point | Near point |
|---|---|---|
| OBJ | 17.0000 | 3.0000 |
| FL | 1.01620 | 1.02009 |
| MG | −0.055639 | −0.240427 |
| FNO | 3.9395 | 3.9038 |
| FIY | 1.140 | 1.140 |
| LTL | 11.7970 | 11.7970 |
| FB | −0.01219 | −0.20091 |
| d8 | 0.18893 | 1.28033 |
| d10 | 1.47307 | 0.38167 |
| β1 | 0.06103 | 0.24942 |
| β2 | 1.08409 | 1.14627 |
| β3 | −0.84092 | −0.84092 |

Unit focal length
f1 = −1.13126, f2 = 17.55152, f3 = 3.56675

### EXAMPLE 16

Unit mm
Surface data

| Surface no. | r | d | nd | νd | ER |
|---|---|---|---|---|---|
| Object plane | ∞ | 17.0000 | 1. | | |
| 1 | 167.9781 | 0.3000 | 1.88300 | 40.76 | 1.564 |
| 2 | 1.6545 | 0.7012 | 1. | | 1.131 |
| 3 | −5.5183 | 0.3000 | 1.88300 | 40.76 | 1.082 |
| 4 | 3.1744 | 0.0871 | 1. | | 1.041 |
| 5 | 2.5804 | 0.7814 | 1.84666 | 23.78 | 1.066 |
| 6 | 6.9505 | 0.1577 | 1. | | 0.996 |
| 7 | ∞ | 0.4000 | 1.51633 | 64.14 | 0.988 |
| 8 | ∞ | d8 | 1. | | 0.965 |
| 9 | 1.8888 | 0.4616 | 1.49700 | 81.54 | 0.928 |
| 10 | 2.1977 | d10 | 1. | | 0.836 |
| 11* | 1.8361 | 0.5888 | 1.80625 | 40.91 | 0.610 |
| 12* | 6.3888 | 0.1529 | 1. | | 0.483 |
| 13(Stop) | ∞ | 0.1033 | 1. | | 0.434 |
| 14 | 7.9548 | 0.7137 | 1.49700 | 81.54 | 0.462 |
| 15 | −0.9463 | 0.2804 | 1.88300 | 50.15 | 0.534 |
| 16 | −1.4714 | 0.0811 | 1. | | 0.610 |
| 17 | 7.9058 | 1.2449 | 1.49700 | 81.54 | 0.624 |
| 18 | −1.8551 | 0.2802 | 1.84666 | 23.78 | 0.640 |
| 19 | 1.8960 | 0.2604 | 1. | | 0.682 |
| 20 | −28.2916 | 0.5750 | 1.69895 | 40.19 | 0.759 |
| 21 | −3.3461 | 0.0701 | 1. | | 0.916 |
| 22 | 6.3282 | 0.5457 | 1.69895 | 30.13 | 1.024 |
| 23 | −12.4763 | 0.3661 | 1. | | 1.083 |
| 24 | 5.0000 | 1.0000 | 1.88300 | 40.76 | 1.182 |
| 25 | ∞ | 0.6000 | 1.51633 | 64.14 | 1.162 |
| 26 | ∞ | 0.0441 | 1. | | 1.145 |
| Image plane | ∞ | 0. | | | |

Aspherical surface data
11th surface
K = 0.4228
A2 = 0.0000E+00, A4 = 1.9118E−02, A6 = 0.0000E+00, A8 = 0.0000E+00,
A10 = 0.0000E+00
12th surface
K = 0.
A2 = 0.0000E+00, A4 = 8.0725E−02, A6 = 0.0000E+00, A8 = 0.0000E+00,
A10 = 0.0000E+00
Various data

| | Far Point | Near point |
|---|---|---|
| OBJ | 17.0000 | 3.0000 |
| FL | 1.01557 | 1.01923 |
| MG | −0.055562 | −0.239423 |
| FNO | 3.9399 | 3.9046 |
| FIY | 1.140 | 1.140 |
| LTL | 11.7980 | 11.7980 |
| FB | −0.01230 | −0.19990 |
| d8 | 0.18900 | 1.30877 |
| d10 | 1.51315 | 0.39339 |
| β1 | 0.06224 | 0.25370 |
| β2 | 1.08568 | 1.14764 |
| β3 | −0.82231 | −0.82231 |

Unit focal length
f1 = −1.15452, f2 = 18.07196, f3 = 3.62238

### EXAMPLE 17

Unit mm
Surface data

| Surface no. | r | d | nd | νd | ER |
|---|---|---|---|---|---|
| Object plane | ∞ | 17.0000 | 1. | | |
| 1 | 570.2528 | 0.3000 | 1.88300 | 40.76 | 1.569 |
| 2 | 1.6989 | 0.6628 | 1. | | 1.141 |
| 3 | −9.9142 | 0.3000 | 1.72916 | 54.68 | 1.086 |
| 4 | 2.4092 | 0.3475 | 1. | | 1.005 |
| 5 | ∞ | 0.4000 | 1.51633 | 64.14 | 1.017 |
| 6 | ∞ | 0.0697 | 1. | | 1.040 |
| 7 | 2.5643 | 0.7035 | 1.84666 | 23.78 | 1.067 |
| 8 | 4.0799 | d8 | 1. | | 0.974 |
| 9 | 2.2132 | 0.5217 | 1.49700 | 81.54 | 0.950 |
| 10 | 2.7183 | d10 | 1. | | 0.856 |
| 11* | 1.9603 | 0.7195 | 1.78472 | 25.68 | 0.640 |
| 12* | 3.5896 | 0.1644 | 1. | | 0.483 |
| 13(Stop) | ∞ | 0.0964 | 1. | | 0.443 |
| 14 | 3.5686 | 0.7078 | 1.49700 | 81.54 | 0.483 |
| 15 | −1.0867 | 0.2930 | 1.80518 | 25.42 | 0.561 |
| 16 | −1.7528 | 0.0831 | 1. | | 0.635 |
| 17 | 3.9399 | 1.1370 | 1.49700 | 81.54 | 0.660 |
| 18 | −9.6703 | 0.2896 | 1.84666 | 23.78 | 0.667 |
| 19 | 1.7800 | 0.3318 | 1. | | 0.676 |
| 20 | −8.6141 | 0.6415 | 1.75500 | 52.32 | 0.752 |
| 21 | −4.2554 | 0.0926 | 1. | | 0.918 |
| 22 | 13.4999 | 0.6906 | 1.84666 | 23.78 | 0.997 |
| 23 | −10.4259 | 0.4223 | 1. | | 1.082 |
| 24 | 5.0000 | 1.0000 | 1.88300 | 40.76 | 1.190 |
| 25 | ∞ | 0.6000 | 1.51633 | 64.14 | 1.167 |
| 26 | ∞ | 0.0444 | 1. | | 1.148 |
| Image plane | ∞ | 0. | | | |

Aspherical surface data
11th surface
K = −1.0059
A2 = 0.0000E+00, A4 = 3.7793E−02, A6 = 0.0000E+00, A8 = 0.0000E+00,
A10 = 0.0000E+00
12th surface
K = 0.
A2 = 0.0000E+00, A4 = 6.9483E−02, A6 = 0.0000E+00, A8 = 0.0000E+00,
A10 = 0.0000E+00
Various data

| | Far Point | Near point |
|---|---|---|
| OBJ | 17.0000 | 3.0000 |
| FL | 1.05130 | 1.04935 |
| MG | −0.057518 | −0.246458 |
| FNO | 3.9388 | 3.9038 |
| FIY | 1.140 | 1.140 |
| LTL | 12.2474 | 12.2474 |
| FB | −0.01608 | −0.21424 |
| d8 | 0.18025 | 1.25248 |
| d10 | 1.44799 | 0.37575 |
| β1 | 0.06596 | 0.26811 |
| β2 | 1.11062 | 1.17070 |
| β3 | −0.78521 | −0.78521 |

Unit focal length
f1 = −1.22465, f2 = 17.84495, f3 = 3.74506

### EXAMPLE 18

Unit mm
Surface data

| Surface no. | r | d | nd | νd | ER |
|---|---|---|---|---|---|
| Object plane | ∞ | 17.0000 | 1. | | |
| 1 | 566.9242 | 0.3000 | 1.88300 | 40.76 | 1.585 |
| 2 | 1.6884 | 0.5793 | 1. | | 1.151 |
| 3 | −122.2277 | 0.3000 | 1.72916 | 54.68 | 1.111 |
| 4 | 2.0272 | 0.4102 | 1. | | 1.008 |
| 5 | ∞ | 0.4000 | 1.51633 | 64.14 | 1.023 |
| 6 | ∞ | 0.0621 | 1. | | 1.049 |
| 7 | 2.2941 | 0.6638 | 1.84666 | 23.78 | 1.083 |
| 8 | 3.1369 | d8 | 1. | | 0.981 |
| 9 | 2.1697 | 0.7295 | 1.49700 | 81.54 | 0.964 |
| 10 | 2.7544 | d10 | 1. | | 0.834 |
| 11* | 1.8025 | 0.6122 | 1.78472 | 25.68 | 0.631 |
| 12* | 3.5193 | 0.1730 | 1. | | 0.493 |
| 13(Stop) | ∞ | 0.0990 | 1. | | 0.451 |
| 14 | 4.3233 | 0.7478 | 1.49700 | 81.54 | 0.489 |
| 15 | −1.0008 | 0.2944 | 1.80518 | 25.42 | 0.573 |
| 16 | −1.5911 | 0.0685 | 1. | | 0.653 |
| 17 | 4.4399 | 1.1951 | 1.49700 | 81.54 | 0.674 |
| 18 | −2.9231 | 0.2706 | 1.84666 | 23.78 | 0.678 |
| 19 | 2.0846 | 0.3197 | 1. | | 0.700 |
| 20 | −6.1013 | 0.5623 | 1.75500 | 52.32 | 0.770 |
| 21 | −6.7472 | 0.0911 | 1. | | 0.939 |
| 22 | 5.3016 | 0.7688 | 1.84666 | 23.78 | 1.058 |
| 23 | −11.2680 | 0.4184 | 1. | | 1.132 |
| 24 | 5.0000 | 1.0000 | 1.88300 | 40.76 | 1.220 |
| 25 | ∞ | 0.6000 | 1.51633 | 64.14 | 1.181 |
| 26 | ∞ | 0.0440 | 1. | | 1.148 |
| Image plane | ∞ | 0. | | | |

Aspherical surface data
11th surface
K = −0.9999
A2 = 0.0000E+00, A4 = 5.3400E−02, A6 = 0.0000E+00, A8 = 0.0000E+00,
A10 = 0.0000E+00
12th surface
K = 0.
A2 = 0.0000E+00, A4 = 9.1183E−02, A6 = 0.0000E+00, A8 = 0.0000E+00,
A10 = 0.0000E+00
Various data

| | Far Point | Near point |
|---|---|---|
| OBJ | 17.0000 | 3.0000 |
| FL | 1.08605 | 1.09139 |
| MG | −0.059432 | −0.256855 |
| FNO | 3.9384 | 3.8969 |
| FIY | 1.140 | 1.140 |
| LTL | 12.2313 | 12.2313 |
| FB | −0.02052 | −0.23630 |
| d8 | 0.17563 | 1.15608 |
| d10 | 1.34570 | 0.36525 |
| β1 | 0.06418 | 0.26155 |
| β2 | 1.11364 | 1.18106 |
| β3 | −0.83148 | −0.83148 |

Unit focal length
f1 = −1.19076, f2 = 14.54187, f3 = 3.73379

### EXAMPLE 19

Unit mm
Surface data

| Surface | | | | | |
|---|---|---|---|---|---|
| no. | r | d | nd | νd | ER |
| Object | ∞ | 23.0000 | 1. | | |
| plane | | | | | |
| 1 | 23.3351 | 0.3000 | 1.88300 | 40.76 | 1.615 |
| 2 | 1.3180 | 1.0918 | 1. | | 1.065 |
| 3 | −2.3725 | 0.3000 | 1.72916 | 54.68 | 0.965 |
| 4 | −14.0022 | 0.0758 | 1. | | 0.981 |
| 5 | ∞ | 0.4000 | 1.51633 | 64.14 | 0.983 |
| 6 | ∞ | 0.1000 | 1. | | 0.985 |
| 7 | −7.2570 | 0.5313 | 1.84666 | 23.78 | 0.986 |
| 8 | −4.6300 | d8 | 1. | | 1.019 |
| 9 | 1.5542 | 0.4753 | 1.49700 | 81.61 | 0.973 |
| 10 | 1.7441 | d10 | 1. | | 0.867 |
| 11 | 6.3417 | 0.8343 | 1.69895 | 30.13 | 0.700 |
| 12 | −1.2695 | 0.2967 | 1.84666 | 23.78 | 0.632 |
| 13 | −8.2452 | 0.0892 | 1. | | 0.610 |
| 14(Stop) | ∞ | 0.0900 | 1. | | 0.544 |
| 15 | 3.3742 | 1.3677 | 1.84666 | 23.78 | 0.628 |
| 16 | −37.5413 | 0.0916 | 1. | | 0.687 |
| 17 | 3.4999 | 0.8220 | 1.92286 | 18.90 | 0.698 |
| 18 | 1.4223 | 0.3889 | 1.49700 | 81.61 | 0.663 |
| 19 | 1.9638 | 0.0578 | 1. | | 0.700 |
| 20 | 2.2850 | 1.0027 | 1.49700 | 81.61 | 0.718 |
| 21 | −1.2509 | 0.2904 | 1.84666 | 23.78 | 0.794 |
| 22 | −2.1469 | 0.0769 | 1. | | 0.887 |
| 23 | −2.2922 | 0.5036 | 1.80610 | 40.92 | 0.894 |
| 24 | −2.7798 | 0.0825 | 1. | | 1.007 |
| 25 | 2.0361 | 0.2532 | 1.72825 | 28.46 | 1.067 |
| 26 | 1.6933 | 0.7456 | 1. | | 1.011 |
| 27 | 5.5337 | 1.0000 | 1.88300 | 40.76 | 1.122 |
| 28 | ∞ | 0.6000 | 1.51633 | 64.14 | 1.131 |
| 29 | ∞ | 0.0451 | 1. | | 1.138 |
| Image | ∞ | 0. | | | |
| plane | | | | | |

Various data

| | Far Point | Near point |
|---|---|---|
| OBJ | 23.0000 | 3.5000 |
| FL | 1.01803 | 1.00996 |
| MG | −0.042133 | −0.217390 |
| FNO | 3.8210 | 3.7550 |
| FIY | 1.140 | 1.140 |
| LTL | 13.4982 | 13.4982 |
| FB | 0.00220 | −0.17446 |
| d8 | 0.26049 | 1.10362 |
| d10 | 1.32512 | 0.48199 |
| β1 | 0.04971 | 0.24508 |
| β2 | 1.15340 | 1.20715 |
| β3 | −0.73482 | −0.73482 |

Unit focal length
f1 = −1.21606, f2 = 15.68585, f3 = 3.50719

### EXAMPLE 20

Unit mm
Surface data

| Surface no. | r | d | nd | νd | ER |
|---|---|---|---|---|---|
| Object plane | ∞ | 23.0000 | 1. | | |
| 1 | ∞ | 0.3000 | 1.88300 | 40.76 | 1.583 |
| 2 | 1.7269 | 0.6987 | 1. | | 1.137 |
| 3 | −4.9307 | 0.3000 | 1.72916 | 54.68 | 1.072 |
| 4 | 4.3840 | 0.2021 | 1. | | 1.007 |
| 5 | ∞ | 0.4000 | 1.51633 | 64.14 | 1.003 |
| 6 | ∞ | 0.0980 | 1. | | 0.992 |
| 7 | −26.4786 | 0.4796 | 1.92286 | 18.90 | 0.989 |
| 8 | −45.6102 | d8 | 1. | | 0.987 |
| 9 | 2.0140 | 1.1515 | 1.49700 | 81.54 | 0.973 |
| 10 | 2.4988 | d10 | 1. | | 0.781 |
| 11* | 2.6171 | 0.5364 | 1.78472 | 25.68 | 0.636 |
| 12* | 14.2466 | 0.1441 | 1. | | 0.549 |
| 13(Stop) | ∞ | 0.1102 | 1. | | 0.514 |
| 14 | 2.9538 | 0.8289 | 1.49700 | 81.54 | 0.553 |
| 15 | −1.3287 | 0.2711 | 1.88300 | 40.76 | 0.612 |
| 16 | −2.0378 | 0.0825 | 1. | | 0.667 |
| 17 | 9.5107 | 1.2111 | 1.49700 | 81.54 | 0.674 |
| 18 | −1.7947 | 0.7085 | 1.84666 | 23.78 | 0.673 |
| 19 | 2.1692 | 0.1784 | 1. | | 0.746 |
| 20 | 10.4491 | 0.5389 | 1.75500 | 52.32 | 0.790 |
| 21 | −5.2124 | 0.2562 | 1. | | 0.899 |
| 22 | 7.9773 | 0.7946 | 1.80610 | 40.92 | 1.025 |
| 23 | −26.2995 | 0.4284 | 1. | | 1.100 |
| 24 | 5.0000 | 1.0000 | 1.88300 | 40.76 | 1.195 |
| 25 | ∞ | 0.6000 | 1.51633 | 64.14 | 1.167 |
| 26 | ∞ | 0.0440 | 1. | | 1.142 |
| Image plane | ∞ | 0. | | | |

Aspherical surface data
9th surface
K = 0.
A2 = 0.0000E+00, A4 = −7.9705E−03, A6 = 0.0000E+00, A8 = 0.0000E+00,
A10 = 0.0000E+00
11th surface
K = −0.8102
A2 = 0.0000E+00, A4 = 2.7721E−02, A6 = 0.0000E+00, A8 = 0.0000E+00,
A10 = 0.0000E+00
12th surface
K = 0.
A2 = 0.0000E+00, A4 = 4.0853E−02, A6 = 0.0000E+00, A8 = 0.0000E+00,
A10 = 0.0000E+00
Various data

| | Far Point | Near point |
|---|---|---|
| OBJ | 23.0000 | 3.5000 |
| FL | 1.02204 | 1.05587 |
| MG | −0.042130 | −0.223151 |
| FNO | 3.9177 | 3.8814 |
| FIY | 1.140 | 1.140 |
| LTL | 12.9220 | 12.9220 |
| FB | 9.38560E−04 | −0.19162 |
| d8 | 0.27054 | 1.17354 |
| d10 | 1.28822 | 0.38522 |
| β1 | 0.04162 | 0.20559 |
| β2 | 1.06956 | 1.14689 |
| β3 | −0.94641 | −0.94641 |

Unit focal length
f1 = −1.01762, f2 = 11.67815, f3 = 3.90807

### EXAMPLE 21

Unit mm
Surface data

| Surface no. | r | d | nd | νd | ER |
|---|---|---|---|---|---|
| Object plane | ∞ | 13.0000 | 1. | | |
| 1 | ∞ | 0.2500 | 1.88300 | 40.76 | 1.404 |
| 2 | 0.9721 | 0.5998 | 1. | | 0.965 |
| 3 | ∞ | 0.4000 | 1.49400 | 75.01 | 0.945 |
| 4 | ∞ | 0.1025 | 1. | | 0.891 |
| 5 | −7.4090 | 0.3000 | 1.81600 | 46.62 | 0.881 |
| 6 | 1.0886 | 0.7980 | 1.80518 | 25.42 | 0.840 |
| 7 | 76.4205 | d7 | 1. | | 0.820 |
| 8 | 2.2208 | 0.4521 | 1.49700 | 81.54 | 0.786 |
| 9 | 2.9006 | d9 | 1. | | 0.722 |
| 10 | 6.3327 | 0.3000 | 1.83400 | 37.16 | 0.650 |
| 11 | 1.1384 | 1.1031 | 1.64769 | 33.79 | 0.614 |
| 12 | −9.1597 | 0.1000 | 1. | | 0.598 |
| 13(Stop) | ∞ | 0.1000 | 1. | | 0.590 |
| 14 | 2.4331 | 0.4109 | 1.81600 | 46.62 | 0.624 |
| 15 | 1.4835 | 0.6873 | 1.49700 | 81.54 | 0.615 |
| 16 | −1.5523 | 0.1000 | 1. | | 0.650 |
| 17 | −1.7693 | 0.3000 | 1.81600 | 46.62 | 0.643 |
| 18 | 4.9222 | 0.5112 | 1.49700 | 81.54 | 0.711 |
| 19 | −5.5507 | 0.1000 | 1. | | 0.795 |
| 20* | 5.0297 | 0.6920 | 1.49700 | 81.54 | 0.850 |
| 21* | −1.8981 | 0.1000 | 1. | | 0.907 |
| 22 | 16.7852 | 0.5780 | 1.83400 | 37.16 | 0.902 |
| 23 | 9.3753 | 0.4930 | 1. | | 0.882 |
| 24 | ∞ | 0.2000 | 1.51633 | 64.14 | 0.890 |
| 25 | ∞ | 0.1000 | 1. | | 0.892 |
| 26 | ∞ | 5.3000 | 1.63854 | 55.38 | 0.894 |
| 27 | ∞ | 0.0856 | 1. | | 0.950 |
| Image plane | ∞ | 0. | | | |

Aspherical surface data
2nd surface
K = −1.0000
A2 = 0.0000E+00, A4 = −1.6360E−02, A6 = 4.6266E−02, A8 = 0.0000E+00,
A10 = 0.0000E+00
8th surface
K = 0.
A2 = 0.0000E+00, A4 = −5.2700E−02, A6 = 5.4101E−02, A8 = 4.5765E−03,
A10 = 0.0000E+00
9th surface
K = 0.
A2 = 0.0000E+00, A4 = −4.9134E−02, A6 = 6.3791E−02, A8 = 0.0000E+00,
A10 = 0.0000E+00
20th surface
K = 0.
A2 = 0.0000E+00, A4 = −5.9779E−03, A6 = 1.4095E−03, A8 = 0.0000E+00,
A10 = 0.0000E+00
21st surface
K = 0.
A2 = 0.0000E+00, A4 = 2.2880E−02, A6= 3.2241E−03, A8 = 0.0000E+00,
A10 = 0.0000E+00
Various data

| | Far Point | Near point |
|---|---|---|
| OBJ | 13.0000 | 2.4000 |
| FL | 0.80002 | 0.79259 |
| MG | −0.057538 | −0.240455 |
| FNO | 3.6407 | 3.5879 |
| FIM | 0.948 | 0.948 |
| LTL | 15.7036 | 15.7037 |
| FB | 0.03958 | −0.10492 |
| d7 | 0.30000 | 0.98746 |
| d9 | 1.24011 | 0.55265 |
| β1 | 0.06093 | 0.24500 |
| β2 | 1.11789 | 1.16191 |
| β3 | −0.84467 | −0.84469 |

Unit focal length
f1 = −0.85974, f2 = 15.61736, f3 = 2.99266

Next, values of conditional expressions in each example are given below. ‘−’ (hyphen) indicates that there is no corresponding arrangement.

| | Example 1 | Example 2 | Example 3 |
|---|---|---|---|
| (1) fL/R31F | 0.653788289 | 0.547362379 | 0.236223962 |
| (2) (R31F + R31R)/ | −0.4611081 | −4.7717526 | −2.1443303 |
| (R31F − R31R) | | | |
| (3) fL/R3AF | −0.659863946 | 0.522239608 | 0.505239876 |
| (4) (R3AF + R3AR)/ | 10.2921811 | −1.1399259 | −0.9252668 |
| (R3AF − R3AR) | | | |
| (5) D31/fL | 1.836800442 | 3.086318649 | 3.289139045 |
| (6) f3C/fL | 2.610640648 | 2.296237853 | 2.127371274 |
| (7) ν_{31P} − ν_{32P} | 0 | −23.38 | −11.67 |
| (8) ν_{33P} − | −31.01 | 11.69 | 17.545 |
| (ν_{31P} + ν_{32P})/2 | | | |
| (9) ν_{31N} − ν_{32N} | −3.6 | 16.98 | 16.98 |
| (10) SF_{RA} | −0.4481569 | −0.1792341 | −0.1572093 |
| (11) (R21F + R21R)/ | −25.572433 | −7.3452038 | −4.8921126 |
| (R21F − R21R) | | | |
| (12) D21/fL | 0.514635493 | 1.134037092 | 1.591411299 |
| (13) β2F | 1.12363 | 1.0915 | 1.11562 |
| (14) β2N/β2F | 1.069898454 | 1.07234998 | 1.076907908 |
| (15) (1 − β2F²) × | 0.17145198 | 0.175312291 | 0.197951457 |
| β3F² | | | |
| (16) (1 − β2N²) × | 0.290741707 | 0.338949619 | 0.35883399 |
| β3N² | | | |
| (17) fL/R12F | −0.449873701 | −0.269316012 | −0.124371273 |
| (18) 100 × \|f_{fin}\| | 36473.8 | 530.03 | 399.88 |
| \|R_{fin}\| | 4.5032 | 45.6521 | 86.8018 |
| (19) fL × tanωₘₐₓ | 6.284667144 | 6.52431036 | 7.382815092 |
| 2yₘₐₓ | 2.28 | 2.28 | 2.28 |
| (20) ER | 0.961 | 0.694 | 0.704 |
| 4 × fL/F_{EX} | 1.098483316 | 1.016022324 | 0.963736816 |
| | Example 4 | Example 5 | Example 6 |
| (1) fL/R31F | 0.511783583 | 0.500662117 | 0.40828453 |
| (2) (R31F + R31R)/ | −5.8696367 | −3.5278743 | −2.5399771 |
| (R31F − R31R) | | | |
| (3) fL/R3AF | 0.422039092 | 0.518678767 | 0.475030138 |
| (4) (R3AF + R3AR)/ | −0.9083673 | −0.9134835 | −1.0021063 |
| (R3AF − R3AR) | | | |
| (5) D31/fL | 3.466332244 | 3.186266531 | 3.455329854 |
| (6) f3C/fL | 2.512568342 | 2.324008138 | 2.597345279 |
| (7) ν_{31P} − ν_{32P} | −23.38 | −23.38 | −23.38 |
| (8) ν_{33P} − | 11.69 | 11.69 | 11.69 |
| (ν_{31P} + ν_{32P})/2 | | | |
| (9) ν_{31N} − ν_{32N} | 16.98 | 16.98 | 16.98 |
| (10) SF_{RA} | −0.2457416 | −0.1905309 | −0.1291599 |
| (11) (R21F + R21R)/ | −10.716061 | −8.2746281 | −9.4646465 |
| (R21F − R21R) | | | |
| (12) D21/fL | 0.604160479 | 0.839877925 | 0.653529146 |
| (13) β2F | 1.08825 | 1.07626 | 1.07292 |
| (14) β2N/β2F | 1.053324144 | 1.065374538 | 1.050479066 |
| (15) (1 − β2F²) × | 0.177399375 | 0.159817609 | 0.163771405 |
| β3F² | | | |
| (16) (1 − β2N²) × | 0.302222094 | 0.317683367 | 0.29286664 |
| β3N² | | | |
| (17) fL/R12F | −0.209006047 | −0.19623892 | −0.181207638 |
| (18) 100 × \|f_{fin}\| | 449.11 | 400.92 | 358.82 |
| \|R_{fin}\| | 539.6992 | 51.6584 | 74.5199 |
| (19) fL × tanωₘₐₓ | 5.155121854 | 5.693983853 | 5.28502533 |
| 2yₘₐₓ | 2.28 | 2.28 | 2.28 |
| (20) ER | 0.736 | 0.706 | 0.727 |
| 4 × fL/F_{EX} | 0.918908264 | 1.002294163 | 0.918945501 |
| | Example 7 | Example 8 | Example 9 |
| (1) fL/R31F | 0.358984038 | 0.565541928 | 0.598246273 |
| (2) (R31F + R31R)/ | −16.52293 | −1.981144 | −11.729839 |
| (R31F − R31R) | | | |
| (3) fL/R3AF | 0.455548034 | 0.220479971 | 0.340970264 |
| (4) (R3AF + R3AR)/ | −0.8237766 | −1.0336523 | −1.3694793 |
| (R3AF − R3AR) | | | |
| (5) D31/fL | 3.623011156 | 3.805383195 | 3.54893421 |
| (6) f3C/fL | 1.735780907 | 5.545894121 | 2.36557226 |
| (7) ν_{31P} − ν_{32P} | −23.38 | −23.38 | −11.67 |
| (8) ν_{33P} − | 11.69 | 11.69 | 34.945 |
| (ν_{31P} + ν_{32P})/2 | | | |
| (9) ν_{31N} − ν_{32N} | 16.98 | 16.98 | 21.86 |
| (10) SF_{RA} | −0.2323081 | 0.07930571 | −0.272248 |
| (11) (R21F + R21R)/ | −11.973222 | −5.673273 | −7.5508501 |
| (R21F − R21R) | | | |
| (12) D21/fL | 0.416285662 | 1.764064997 | 1.031764312 |
| (13) β2F | 1.08766 | 1.13728 | 1.08934 |
| (14) β2N/β2F | 1.0494364 | 1.061893289 | 1.057126333 |
| (15) (1 − β2F²) × | 0.181381028 | 0.219760943 | 0.177920271 |
| β3F² | | | |
| (16) (1 − β2N²) × | 0.300176055 | 0.343391655 | 0.310841571 |
| β3N² | | | |
| (17) fL/R12F | −0.022282726 | −0.160428146 | −0.329229284 |
| (18) 100 × \|f_{fin}\| | 352.36 | 565.57 | 571.86 |
| \|R_{fin}\| | 28.5947 | 3.9331 | 837.6148 |
| (19) fL × tanωₘₐₓ | 5.093957295 | 5.571857207 | 5.542921362 |
| 2yₘₐₓ | 2.28 | 2.28 | 2.28 |
| (20) ER | 0.732 | 0.933 | 0.733 |
| 4 × fL/F_{EX} | 0.890463104 | 0.994828387 | 0.966761134 |
| | Example 10 | Example 11 | Example 12 |
| (1) fL/R31F | 0.563401941 | 0.513828945 | 0.49291301 |
| (2) (R31F + R31R)/ | −3.7960435 | −0.780451 | −0.886933 |
| (R31F − R31R) | | | |
| (3) fL/R3AF | 0.376555417 | 0.28880543 | 0.321914907 |
| (4) (R3AF + R3AR)/ | −1.2162171 | −2.6838506 | −3.250368 |
| (R3AF − R3AR) | | | |
| (5) D31/fL | 3.394808672 | 4.044155894 | 3.971205759 |
| (6) f3C/fL | 3.480119976 | 8.296954168 | 9.264663196 |
| (7) ν_{31P} − ν_{32P} | −11.67 | 5.45 | 5.45 |
| (8) ν_{33P} − | 34.945 | 43.505 | 43.505 |
| (ν_{31P} + ν_{32P})/2 | | | |
| (9) ν_{31N} − ν_{32N} | 21.86 | 21.86 | 21.86 |
| (10) SF_{RA} | −0.0571611 | −0.239918 | −0.2132118 |
| (11) (R21F + R21R)/ | −7.1603339 | −10.916858 | −11.253594 |
| (R21F − R21R) | | | |
| (12) D21/fL | 1.010451154 | 0.787080741 | 0.879501519 |
| (13) β2F | 1.0833 | 1.07788 | 1.06944 |
| (14) β2N/β2F | 1.057287917 | 1.061518907 | 1.071775883 |
| (15) (1 − β2F²) × | 0.172485509 | 0.146031146 | 0.115435747 |
| β3F² | | | |
| (16) (1 − β2N²) × | 0.309956603 | 0.27899569 | 0.252055008 |
| β3N² | | | |
| (17) fL/R12F | −0.323745044 | −0.328920854 | −0.361807743 |
| (18) 100 × \|f_{fin}\| | 432.22 | 463.38 | 521.6 |
| \|R_{fin}\| | 40.7148 | 8.1303 | 21.6855 |
| (19) fL × tanωₘₐₓ | 5.59638182 | 2.883851502 | 2.870964109 |
| 2yₘₐₓ | 2.28 | 2.28 | 2.28 |
| (20) ER | 0.743 | 0.824 | 0.814 |
| 4 × fL/F_{EX} | 0.981691289 | 1.05341451 | 1.048746829 |
| | Example 13 | Example 14 | Example 15 |
| (1) fL/R31F | 0.520127967 | 0.441021327 | 0.597835039 |
| (2) (R31F + R31R)/ | −1.0567359 | −2.6150684 | −5.0375297 |
| (R31F − R31R) | | | |
| (3) fL/R3AF | 0.4462412 | 0.591470157 | 0.584392432 |
| (4) (R3AF + R3AR)/ | −1.1332831 | −0.6523666 | −0.7710271 |
| (R3AF − R3AR) | | | |
| (5) D31/fL | 3.416720662 | 3.245488535 | 3.407301712 |
| (6) f3C/fL | 6.767144641 | 3.235378276 | 2.813028931 |
| (7) ν_{31P} − ν_{32P} | −40.63 | −40.78 | −55.86 |
| (8) ν_{33P} − | 20.315 | 20.39 | 27.93 |
| (ν_{31P} + ν_{32P})/2 | | | |
| (9) ν_{31N} − ν_{32N} | 16.98 | 13.38 | 16.98 |
| (10) SF_{RA} | 1.72684983 | 0.05164729 | 0.509715 |
| (11) (R21F + R21R)/ | −9.997044 | −17.50087 | −11.298554 |
| (R21F − R21R) | | | |
| (12) D21/fL | 1.141880535 | 0.584964328 | 0.465262744 |
| (13) β2F | 1.07444 | 1.12377 | 1.08409 |
| (14) β2N/β2F | 1.07657012 | 1.066677345 | 1.057356862 |
| (15) (1 − β2F²) × | 0.120896446 | 0.167719822 | 0.147372179 |
| β3F² | | | |
| (16) (1 − β2N²) × | 0.264602995 | 0.278756731 | 0.263994147 |
| β3N² | | | |
| (17) fL/R12F | −0.281811686 | −0.195852948 | −0.124720784 |
| (18) 100 × \|f_{fin}\| | 566.25 | 566.25 | 566.25 |
| \|R_{fin}\| | 99999999 | 99999999 | 99999999 |
| (19) fL × tanωₘₐₓ | 2.954570275 | 2.84233488 | 2.712439845 |
| 2yₘₐₓ | 2.28 | 2.28 | 2.28 |
| (20) ER | 0.715 | 0.660 | 0.666 |
| 4 × fL/F_{EX} | 1.085811879 | 1.060369153 | 1.029063291 |
| | Example 16 | Example 17 | Example 18 |
| (1) fL/R31F | 0.553112576 | 0.536295465 | 0.602524272 |
| (2) (R31F + R31R)/ | −1.8065983 | −3.4063095 | −3.0998369 |
| (R31F − R31R) | | | |
| (3) fL/R3AF | 0.535638186 | 0.590617978 | 0.52098724 |
| (4) (R3AF + R3AR)/ | −0.8743855 | −0.657498 | −0.4906852 |
| (R3AF − R3AR) | | | |
| (5) D31/fL | 3.3924791 | 3.320460382 | 3.186409465 |
| (6) f3C/fL | 3.532498991 | 3.040521259 | 2.912112702 |
| (7) ν_{31P} − ν_{32P} | −40.63 | −55.86 | −55.86 |
| (8) ν_{33P} − | 20.315 | 27.93 | 27.93 |
| (ν_{31P} + ν_{32P})/2 | | | |
| (9) ν_{31N} − ν_{32N} | 26.37 | 1.64 | 1.64 |
| (10) SF_{RA} | 0.4277965 | 0.35173961 | 0.38529629 |
| (11) (R21F + R21R)/ | −13.2292 | −9.7634132 | −8.4215837 |
| (R21F − R21R) | | | |
| (12) D21/fL | 0.454523076 | 0.496242747 | 0.671700198 |
| (13) β2F | 1.08568 | 1.11062 | 1.11364 |
| (14) β2N/β2F | 1.057070223 | 1.05409591 | 1.06054021 |
| (15) (1 − β2F²) × | 0.146947671 | 0.183328306 | 0.199716548 |
| β3F² | | | |
| (16) (1 − β2N²) × | 0.260736056 | 0.290950528 | 0.328353717 |
| β3N² | | | |
| (17) fL/R12F | −0.18403675 | −0.106039822 | −0.008885465 |
| (18) 100 × \|f_{fin}\| | 566.25 | 566.25 | 566.25 |
| \|R_{fin}\| | 99999999 | 99999999 | 99999999 |
| (19) fL × tanωₘₐₓ | 2.747638048 | 2.89635339 | 2.990640205 |
| 2yₘₐₓ | 2.28 | 2.28 | 2.28 |
| (20) ER | 0.682 | 0.676 | 0.700 |
| 4 × fL/F_{EX} | 1.028425316 | 1.064607595 | 1.099797468 |
| | Example 19 | Example 20 | Example 21 |
| (1) fL/R31F | 0.160529511 | 0.390523862 | 0.12633158 |
| (2) (R31F + R31R)/ | −0.1304938 | −1.4500795 | −0.1824766 |
| (R31F − R31R) | | | |
| (3) fL/R3AF | 0.518398004 | 0.471159875 | — |
| (4) (R3AF + R3AR)/ | −13.227895 | −1.5239677 | — |
| (R3AF − R3AR) | | | |
| (5) D31/fL | 3.909904423 | 3.808852882 | — |
| (6) f3C/fL | 10.09754133 | 3.221889554 | 3.030674233 |
| (7) ν_{31P} − ν_{32P} | 6.35 | −55.86 | −47.75 |
| (8) ν_{33P} − | 54.655 | 27.93 | 23.875 |
| (ν_{31P} + ν_{32P})/2 | | | |
| (9) ν_{31N} − ν_{32N} | 4.88 | 16.98 | −9.46 |
| (10) SF_{RA} | 0.15442596 | 0.68050608 | −0.7968132 |
| (11) (R21F + R21R)/ | | | |
| (R21F − R21R) | −17.368615 | −9.3085809 | −7.5336864 |
| (12) D21/fL | 0.466882115 | 1.126668232 | 0.565110872 |
| (13) β2F | 1.1534 | 1.06956 | 1.11789 |
| (14) β2N/β2F | 1.046601353 | 1.072300759 | 1.03937776 |
| (15) (1 − β2F²) × | 0.242734237 | 0.136243853 | 0.21089556 |
| β3F² | | | |
| (16) (1 − β2N²) × | 0.335967877 | 0.298456708 | 0.29567094 |
| β3N² | | | |
| (17) fL/R12F | −0.42909589 | −0.207280913 | −0.1079795 |
| (18) 100 × \|f_{fin}\| | 626.69 | 566.25 | 2640.1 |
| \|R_{fin}\| | 99999999 | 99999999 | 9.3753 |
| (19) fL × tanωₘₐₓ | 4.270169933 | 5.897511831 | 2.46301838 |
| 2yₘₐₓ | 2.28 | 2.28 | 1.896 |
| (20) ER | 0.887 | 0.746 | 0.795 |
| 4 × fL/F_{EX} | 1.061830508 | 1.041834862 | 0.87409997 |

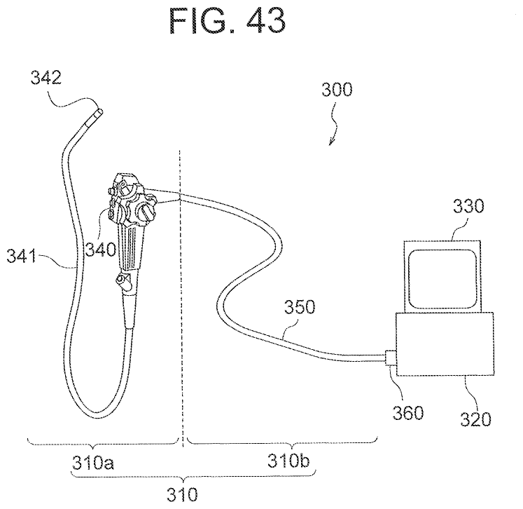

FIG. 43 is an example of an image pickup apparatus. In this example, the image pickup apparatus is an endoscope system. FIG. 43 is a diagram showing a schematic configuration of an endoscope system.

An endoscope system 300 is an observation system in which an electronic endoscope is used. The endoscope system 300 includes an electronic endoscope 310 and an image processing unit 320. The electronic endoscope 310 includes a scope section 310a and a connecting cord section 310b. Moreover, a display unit 330 is connected to the image processing unit 320.

The scope section 310a is mainly divided into an operating portion 340 and an inserting portion 341. The inserting portion 341 is long and slender, and can be inserted into a body cavity of a patient. Moreover, the inserting portion 341 is formed of a flexible member. An observer can carry out various operations by an angle knob that is provided to the operating portion 340.

Moreover, the connecting cord section 310b is extended from the operating portion 340. The connecting cord section 301b includes a universal cord 350. The universal cord 350 is connected to the image processing unit 320 via a connector 360.

The universal cord 350 is used for transceiving of various types of signals. Various types of signals include signals such as a power-supply voltage signal and a CCD (charge coupled device) driving signal. These signals are transmitted from a power supply unit and a video processor to the scope section 310a. Moreover, various types of signals include a video signal. This signal is transmitted from the scope section 310a to the video processor.

Peripheral equipment such as a VTR (video tape recorder) deck and a video printer can be connected to the video processor inside the image processing unit 320. The video processor carries out signal processing on a video signal from the scope section 310a. On the basis of the video signal, an endoscope image is displayed on a display screen of the display unit 330.

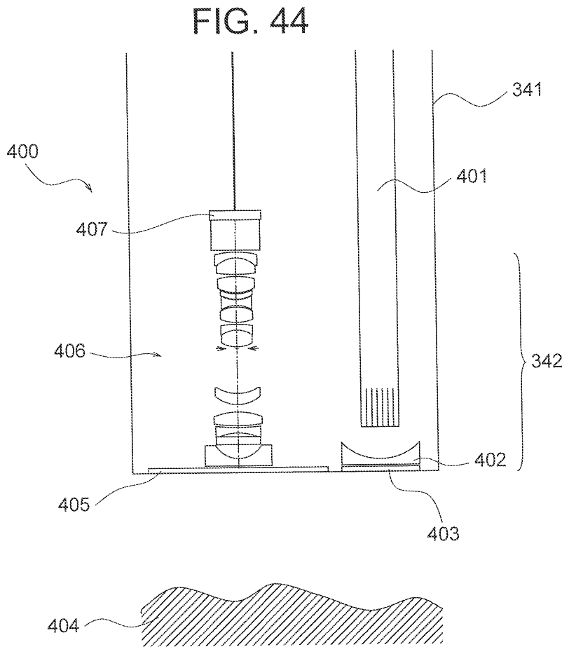

An optical system is disposed at a front-end portion 342 of the inserting portion 341. FIG. 44 is a diagram showing an arrangement of the optical system of the endoscope. An optical system 400 includes an illuminating section and an observation section.

The illuminating section includes a light guide 401 and an illuminating lens 402. The light guide 401 transmits illumination light to the front-end portion 342 of the inserting portion 341. The transmitted light is emerged from a front-end surface of the light guide 401.

At the front-end portion 342, the illuminating lens 402 is disposed. The illuminating lens 402 is disposed at a position of facing the front-end surface of the light guide 401. The illumination light passes through the illuminating lens 402 and is emerged from an illumination window 403. As a result, an observation object region 404 of an inside of an object (hereinafter, referred to as ‘observation region 404’) is illuminated.

At the front-end portion 342, an observation window 405 is disposed next to the illumination window 403. Light from the observation region 404 is incident on the front-end portion 342 through the observation window 405. An observation portion is disposed behind the observation window 405.

The observation portion includes a wide-angle optical system 406 and an image sensor 407. The wide-angle optical system of the example 1 is used for the wide-angle optical system 406, for instance.

Reflected light from the observation region 404 passes through the wide-angle optical system 406 and is incident on the image sensor 407. On an image pickup surface of the image sensor 407, an image (an optical image) of the observation region 404 is formed. The image of the observation region 404 is converted photoelectrically by the image sensor 407, and thereby an image of the observation region 404 is acquired. The image of the observation region 404 is displayed on the display unit 330. By doing so, it is possible to observe the image of the observation region 404

In the wide-angle optical system 406, an image plane is curved shape. The image sensor 407 has a curved-shape light receiving surface (an image pickup surface) same as an shape of the image plane. By using the image sensor 407, it is possible to improve an image quality of the acquired image.

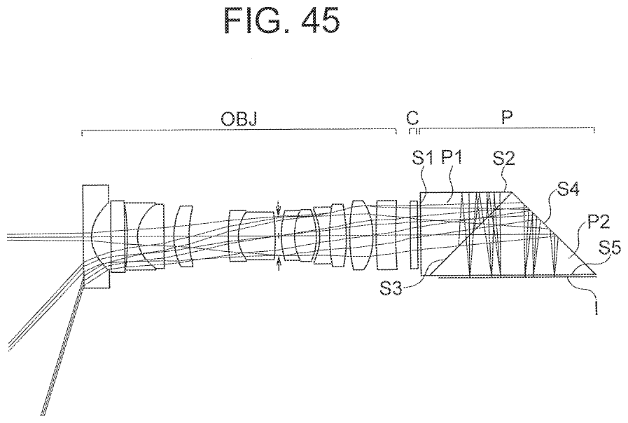

FIG. 45 is a diagram showing an arrangement of an optical system of an image pickup apparatus. The optical system includes an objective optical system OBJ, a cover glass C, and a prism P. The cover glass C is disposed between the objective optical system OBJ and the prism P. The wide-angle optical system of the example 21 is used for the objective optical system OBJ. An optical filter may be disposed instead of the cover glass C. Or, the cover glass C may not be disposed.

The prism P includes a prims P1 and a prism P2. Both the prism P1 and the prism P2 are triangular prisms. An optical-path splitting element is formed by the prism P1 and the prism P2.

The prism P1 has an optical surface S1, an optical surface S2, and an optical surface S3. The prism P2 has an optical surface S3, an optical surface S4, and an optical surface S5. The prism P1 is cemented to the prism P2. A cemented surface is formed by the prism P1 and the prism P2. The optical surface S3 is a cemented surface.

Light emerged from the objective optical system OBJ (hereinafter, referred to as ‘imaging light’) passes through the cover glass C, and is incident on the optical surface S1. The optical surface S1 being a transmitting surface, the imaging light is transmitted through the optical surface S1.

Next, the imaging light is incident on the optical surface S3. The optical surface S3 is disposed so that a normal of the surface is at 45 degrees with respect to an optical axis. The imaging light incident on the optical surface S3 is divided into light transmitted through the optical surface S3 (hereinafter, referred to as ‘imaging light 1’) and light reflected at the optical surface S3 (hereinafter, referred to as ‘imaging light 2’).

The imaging light 1 and the imaging light 2 travel in mutually different directions. When an optical path through which the imaging light 1 travels is a first optical path and an optical path through which the imaging light 2 travels is a second optical path, the first optical path and the second optical path are formed by the optical surface S3. As just described, the optical surface S3 functions as an optical-path splitting surface.

The first optical path is formed on an extension line of an optical path of the objective optical system OBJ. The second optical path is formed to intersect the first optical path. In FIG. 45, the second optical path is orthogonal to the first optical path.

The optical surface S3, the optical surface S4, and the optical surface S5 are located in the first optical path. The imaging light 1 transmitted through the optical surface S3 is incident on the optical surface S4. The optical surface S4 is a reflecting surface. The imaging light 1 is reflected at the optical surface S4, and is incident on the optical surface S5. The optical surface S5 is a transmitting surface. The imaging light 1 is transmitted through the optical surface S5, and is converged on an image plane I near the optical surface S5. An optical image by the imaging light 1 is formed on the image plane I.

The optical surface S3, the optical surface S2, the optical surface S3, and the optical surface S5 are located in the second optical path. The imaging light 2 reflected at the optical surface S3 is incident on the optical surface S2. The optical surface S2 is a reflecting surface. The imaging light 2 is reflected at the optical surface S2, and is incident on the optical surface S3. At the optical surface S3, the imaging light 2 is divided into light transmitted through the optical surface S3 and light reflected at the optical surface S3.

The imaging light 2 transmitted through the optical surface S3 is incident on the optical surface S5. The imaging light 2 is transmitted through the optical surface S5, and is converged on the image plane I near the optical surface S5. An optical image by the imaging light 2 is formed on the image plane I.

Since two optical paths are formed in the optical system shown in FIG. 45, two optical images are formed on the same plane. The same plane is the image plane I in the two optical paths.

In a case in which an optical-path length of the first optical path and an optical-path length of the second optical path are same, two focused optical images are formed at different positions on the same plane. The two optical images are optical images when the same object is focused. Accordingly, a position of an object plane for one optical image and a position of an object plane for the other optical image are same.

Whereas, even in a case in which the optical-path length of the first optical path and the optical-path length of the second optical path are different, two focused optical images are formed at different positions on the same plane. However, the two optical images are optical images when different objects are focused. Accordingly, a position of an object plane for one optical image and a position of an object plane for the other optical image are different.

For instance, it is assumed that the optical-path length of the first optical path is shorter than the optical-path length of the second optical path. In this case, the object plane of the optical image formed by the imaging light 1 is positioned far from the object plane of the optical image formed by the imaging light 2. As just described, the focus is adjusted for each of the two object planes in which distance from the objective optical system (hereinafter, referred to as ‘object distance’) differs from each other. Even when the object distance differs for two object planes, the two optical images are formed at different locations in on the same plane.

The objective optical system OBJ has a section which is focused (hereinafter, referred to as ‘focusing section’). The focusing section is a section expressed by the object distance, and corresponds to a depth of field of the objective optical system OBJ. In the focusing section, wherever the object plane is positioned, a focused optical image is formed.

In a case in which the object distance differs for two object planes, there occurs a shift between a position of the focusing section for one object plane and a position of the focusing section for the other object plane. By setting appropriately the distance of the two object planes, it is possible to overlap a part of the focusing section for the one object plane and a part of the focusing section for the other object plane.

Thus, two optical images having the focusing section shifted are captured, and accordingly, two images are acquired. Moreover, only a focused area (an image area of a range corresponding to the depth of field) is extracted from the two images that were acquired, and the areas extracted are combined. By doing so, it is possible to acquire an image with a large depth of field.

For the optical surface S3, it is possible to use a half-mirror surface or a polarizing-beam splitter surface for example.

In a case in which the optical surface S3 is a half-mirror surface, a half of a quantity of imaging light is reflected at the optical surface S3 and the remaining half of the quantity of imaging light is transmitted through the optical surface S3. Accordingly, a quantity of the imaging light 2 becomes half of the quantity of the imaging light. The imaging light 2 is reflected at the optical surface S2. The imaging light 2 reflected at the optical surface S2 is transmitted through the optical surface S3. At the optical surface S3, only half of the quantity of the imaging light 2 can be transmitted.

In a case in which the optical surface S3 is a polarizing-beam splitter surface, a depolarization plate or a wavelength plate may be used instead of the cover glass C. Moreover, the optical surface S2 is not a reflecting surface but is a transmitting surface. A reflecting surface is disposed at a position away from the optical surface S2. Furthermore, a quarter-wave plate is disposed between the optical surface S2 and the reflecting surface.

P-polarized light is polarized light having an amplitude of light in a paper plane, and S-polarized light is polarized light having an amplitude in a plane orthogonal to the paper plane. When it is assumed that the P-polarized light is transmitted through the optical surface S3 and the S-polarized light is reflected at the optical surface S3, the P-polarized light corresponds to the imaging light 1 and the S-polarized light corresponds to the imaging light 2.

For instance, when the depolarization plate is used instead of the cover glass C, the imaging light passes through the depolarization plate. Consequently, in the imaging light emerged from the depolarization plate, a proportion of the P-polarized light and the S-polarized light in the imaging light becomes substantially half. The imaging light incident on the optical surface S3 is divided into the P-polarized light and the S-polarized light at the optical surface S3. Accordingly, the quantity of the imaging light 2 becomes half of the quantity of the imaging light.

The imaging light 2, when directed from the optical surface S3 toward the optical surface S2, is S-polarized light. In a case in which the optical surface S2 is a reflecting surface, the imaging light 2 is reflected toward the optical surface 3 as the S-polarized light as it has been. The imaging light 2 directed from the optical surface S2 toward the optical surface S3 being the S-polarized light, cannot be transmitted through the optical surface S3.

Whereas, in a case in which the optical surface S2 is a transmitting surface, the imaging light 2 is reflected at the reflecting surface. The X/4 plate is disposed between the optical surface S2 and the reflecting surface. By the imaging light 2 travelling to and from between the optical surface S2 and the reflecting surface, a direction of polarization for the imaging light 2 rotates 90 degrees. Accordingly, it is possible to convert the S-polarized light to the P-polarized light. As a result, the imaging light directed from the optical surface S2 toward the optical surface S3 becomes the P-polarized light.

The imaging light 2 converted to the P-polarized light reaches the optical surface S3. Accordingly, the imaging light 2 is not reflected at the optical surface S3. In other words, at the optical surface S3, almost whole of the amount of the imaging light 2 can be transmitted through.

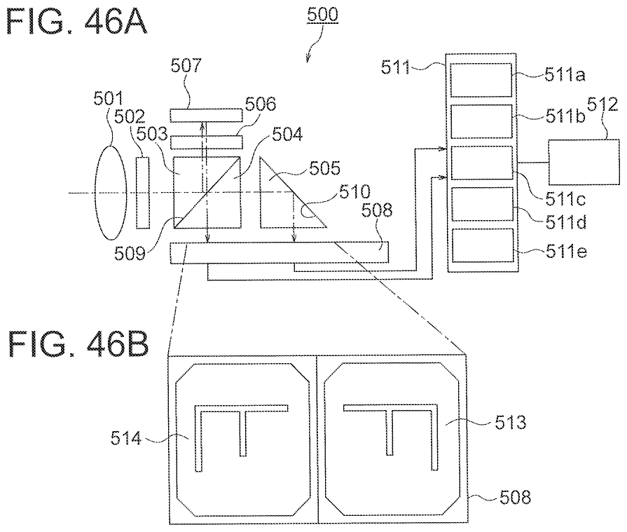

FIG. 46A and FIG. 46B are diagrams showing a schematic configuration of an image pickup apparatus. FIG. 46A is a diagram showing an overall configuration, and FIG. 46B is a diagram showing an orientation of an object.

As shown in FIG. 46A, an image pickup apparatus 500 includes an objective optical system 501, a depolarization plate 502, a first prism 503, a second prism 504, a third prism 505, a wavelength plate 506, a mirror 507, an image sensor 508, an image processor 511, and an image display unit 512.

In the image pickup apparatus 500, an optical-path splitting element is formed by the first prism 503, the second prism 504, and the third prism 505.

The objective optical system 501 forms an image of an object. The depolarization plate 502 is disposed between the objective optical system 501 and the first prism 503.

The first prism 503 and the second prism 504 are cemented. A cemented surface 509 is formed by the first prism 503 and the second prism 504. Light incident on the cemented surface 509 is divided into light reflected at the cemented surface 509 and light transmitted through the cemented surface 509.

It is possible to use a polarizing-beam splitter surface for the cemented surface 509. In this case, P- polarized light is transmitted through the cemented surface 509 and S-polarized light is reflected at the cemented surface 509.

The P-polarized light transmitted through the cemented surface 509 emerges from the second prism 504. The P-polarized light is incident on the third prism 505 and reaches an optical surface 510. The optical surface 510, for instance, is a mirror surface. Accordingly, the P-polarized light is reflected at the optical surface 510.

The P-polarized light reflected at the optical surface 510 emerges from the third prism 505 and is incident on the image sensor 508. As shown in FIG. 46B, the image sensor 508 has a first area 513 and a second area 514. The P-polarized light reflected at the optical surface 510 is incident on the first area 513. Accordingly, an optical image is formed on the first area 513.

On the other hand, the S-polarized light reflected at the cemented surface 509 emerges from the first prism 503. The S-polarized light is incident on the wavelength plate 506. A quarter-wave plate is used for the wavelength plate 506. Consequently, the S-polarized light is converted to circularly-polarized light at the wavelength plate 506. As a result, the circularly-polarized light emerges from the wavelength plate 506.

The circularly-polarized light is reflected at the mirror 507 and is incident once again on the wavelength plate 506. Light emerged from the wavelength plate 506 is incident on the first prism 503 and reaches the cemented surface 509. The circularly-polarized light incident on the wavelength plate 506 is converted to P-polarized light at the wavelength plate 506. The light reached the cemented surface 509 being the P-polarized light, the light reached the cemented surface 509 is transmitted through the cemented surface 509.

The P-polarized light which is transmitted through the cemented surface 509 emerges from the second prism 504 and is incident on the image sensor 508. As mentioned above, the image sensor 508 has the first area 513 and the second area 514. The P-polarized light transmitted through the cemented surface 509 is incident on the second area 514. As a result, an optical image is formed on the second surface 514.

For instance, a rolling shutter system is adopted for the image sensor 508. In the rolling shutter system, image information for a line is read for each line one-by-one. The image sensor 508 is connected to the image processor 511. Image information which is read is input to the image processor 511.

The image processor 511 includes a second image processing section 511b. In the second image processing section 511b, it is possible to select a focused image as an image for display by using the image information that has been read for each line one-by-one. Images for each line selected by the second image processing section 511b are combined and displayed on the image display unit 512.

The image processor 511 will be described below. The image processor 511 is provided to a central processing unit (not shown in the diagram). The image processor 511 includes a first image processing section 511a, the second image processing section 511b, a third image processing section 511c, a fourth image processing section 511d, and a fifth image processing section 511e.

In the first image processing section 511a, an orientation of an image acquired from the first area 513 (hereinafter, referred to as ‘first image’) and an orientation of an image acquired from the second area 514 (hereinafter, referred to as ‘second image’) are corrected. In correction of the orientation of the image, the image is rotated for example.

The orientation of the first image and the orientation of the second image are determined by an orientation of the optical image formed in the first area 513 (hereinafter, referred to as ‘first optical image’) and an orientation of the optical image formed in the second area 514 (hereinafter, referred to as ‘second optical image’) respectively.

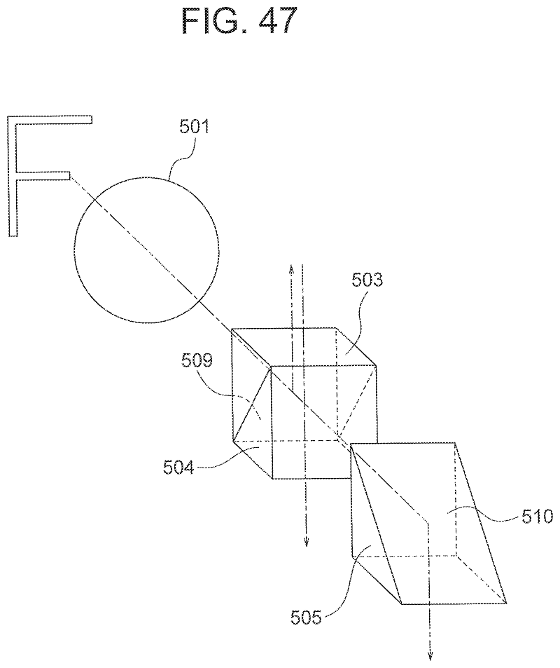

FIG. 47 is a diagram showing a positional relationship of an object, an objective optical system, and an optical-path splitting element. For instance, a case of observing a character ‘F’ as shown in FIG. 47 will be described below. Each of the orientation of the first optical image and the orientation of the second optical image is an orientation as shown in FIG. 46B.

As shown in FIG. 46B, the first optical image and the second optical image are mirror images of each other. Furthermore, when a vertical orientation of a paper surface is an upright direction, the first optical image and the second optical image are rotated 90 degrees from the upright direction.

Therefore, in a case of displaying an image of an object on the image display unit 512, in the first image processing section 511a, the first image is rotated 90 degrees with a central point of the first area 513 as a center. Even regarding the second image, the second image is rotated 90 degrees with a central point of the area 514 as a center. Moreover, regarding the second image, the second image is inverted, and a mirror image is corrected.

As the processing by the first image processing section 511a is terminated, processing by the second image processing unit 511b is executed. However, according to the requirement, processing by at least one of the third image processing section 511c, the fourth image processing section 511d, and the fifth image processing section 511e may be executed before executing the processing by the second image processing section 511b.

The third image processing section 511c is configured so that a white balance of the first image and a white balance of the second image are adjustable. The fourth image processing section 511d is configured so that a center position of the first image and a center position of the second image are movable or selectable. The fifth image processing section 511e is configured so that a display range of the first image and a display range of the second image are adjustable. Moreover, the fifth image processing section 511e may be configured so that a display magnification is adjustable instead of the display range.

The second image processing section 511b is configured to compare the first image and the second image, and to select an image of a focused area as an image for display.

The second image processing section 511b has a high- pass filter, a comparator, and a switch. The high-pass filter is connected to each of the first area 513 and the second area 514. In the high-pass filter, a high component is extracted from each of the first image and the second image.

Outputs of the two high-pass filters are input to the comparator. The high components extracted in the two high- pass filters are compared in the comparator. A comparison result is input to the switch. Moreover, the first area 513 and the second area 514 are connected to the switch. Accordingly, the comparison result, a signal of the first image, and a signal of the second image are input to the switch.

In the switch, an area with many high component in the first image and an area with many high component in the second image are selected on the basis of the comparison result.

The image display unit 512 has a display area. An image selected by the second processing section 511b is displayed in the display area. The image display unit 512 may have display areas displaying the first image and the second image.

According to the present disclosure, it is possible to provide a wide-angle optical system in which various aberrations are corrected favorably, and an outer diameter of a lens which moves and an outer diameter of a lens located near a lens unit that moves are adequately small, and an image pickup apparatus in which the wide-angle optical system is used.

As described heretofore, the present disclosure is suitable for a wide-angle optical system in which various aberrations are corrected favorably, and an outer diameter of a lens which moves and an outer diameter of a lens located near a lens unit that moves are adequately small, and an image pickup apparatus in which the wide-angle optical system is used.

What is claimed is:

1. A wide-angle optical system having a lens component which has a plurality of optical surfaces, and in the lens component, two optical surfaces are in contact with air, and at least one optical surface is a curved surface, comprising in order from an object side:
a first lens unit having a negative refractive power;
a second lens unit; and
a third lens unit having a positive refractive power, wherein
the second lens unit is moved between a first position and a second position along an optical axis for a focal-position adjustment, the first position is a position at which a distance between the first lens unit and the second lens unit becomes the minimum, and the second position is a position at which a distance between the second lens unit and the third lens unit becomes the minimum,
the third lens unit includes a cemented lens having a positive refractive power and a cemented lens having a negative refractive power, and
following conditional expression (1) is satisfied:
0.05<fL/R31F<1.0 (1)
where,
R31F denotes a radius of curvature of a surface on the object side of an object-side lens component,
fL denotes a focal length of the wide-angle optical system at the first position, and
the object-side lens component is a lens component located nearest to an object in the third lens unit.

2. The wide-angle optical system according to claim 1, wherein following conditional expression (2) is satisfied:
−1.0×10²<(R31F+R31R)/(R31F−R31R)<0.5 (2)
where,
R31F denotes the radius of curvature of the surface on the object side of the object-side lens component, and
R31R denotes a radius of curvature of a surface on an image side of the object-side lens component.

3. The wide-angle optical system according to claim 1, comprising:
a first air lens, wherein
the first air lens is an air lens which satisfied following conditional expression (3), and
the third lens unit is provided with the first air lens:
−−0.7<fL/R3AF<1.0 (3)
where,
R3AF denotes a radius of curvature of a surface on the object side of the first air lens, and
fL denotes the focal length of the wide-angle optical system at the first position.

4. The wide-angle optical system according to claim 1, comprising:
a first air lens, wherein
the first air lens is an air lens which satisfies following conditional expression (4), and
the third lens unit is provided with the first air lens:
−20.0<(R3AF+R3AR)/(R3AF−R3AR)<15.0 (4)
where,
R3AF denotes a radius of curvature of a surface on the object side of the first air lens, and
R3AR denotes a radius of curvature of a surface on an image side of the first air lens.

5. The wide-angle optical system according to claim 1, comprising:
a first air lens, wherein
the first air lens is an air lens which satisfies following conditional expression (5), and
the third lens unit is provided with the first air lens:
1.0<D31/fL<10.0 (5)
where,
D31 denotes a distance on an optical axis between the surface on the object side of the object-side lens component and a surface on an object side of the first air lens, and
fL denotes the focal length of the wide-angle optical system at the first position.

6. The wide-angle optical system according to claim 1, wherein the cemented lens having a positive refractive power is disposed on the object side of the cemented lens having a negative refractive power.

7. The wide-angle optical system according to claim 1, wherein the third lens unit includes a plurality of negative lenses.

8. The wide-angle optical system according to claim 1, wherein the third lens unit includes a plurality of positive lens components on the object side of a negative lens component nearest to the object.

9. The wide-angle optical system according to claim 1, wherein
in the third lens unit, the cemented lens having a positive refractive power is disposed on the object side of a negative lens component which is nearest to the object, and
following conditional expression (6) is satisfied:
0.5<f3C/fL<15 (6)
where,
f3C denotes a focal length of the cemented lens having a positive refractive power, and
fL denotes the focal length of the wide-angle optical system at the first position.

10. The wide-angle optical system according to claim 1, wherein
the third lens unit includes a first lens component, a second lens component, and a third lens component,
the first lens component is a single lens, and
the second lens component and the third lens component are cemented lenses.

11. The wide-angle optical system according to claim 1, wherein
the third lens unit includes a plurality of positive lenses,
the plurality of positive lenses includes a first positive lens and a second positive lens,
the first positive lens, among the plurality of positive lenses, is a positive lens located nearest to the object,
the second positive lens, among the plurality of positive lenses, is a positive lens located second from the object, and
following conditional expression (7) is satisfied:
−70<ν_{31P}−ν_{32P}<20 (7)
where,
ν_{31P} denotes an Abbe number for the first positive lens, and
ν_{32P} denotes an Abbe number for the second positive lens.

12. The wide-angle optical system according to claim 1, wherein
the third lens unit includes a plurality of positive lenses,
the plurality of positive lenses includes a first positive lens, a second positive lens, and a third positive lens,
the first positive lens, among the plurality of positive lenses, is a positive lens located nearest to the object,
the second positive lens, among the plurality of positive lenses, is a positive lens located second from the object,
the third positive lens, among the plurality of positive lenses, is a positive lens located third from the object, and
following conditional expression (8) is satisfied:
−40<ν_{33P}−(ν_{31P}+ν_{32P})/2<60 (8)
where,
ν_{31P} denotes an Abbe number for the first positive lens,
ν_{32P} denotes an Abbe number for the second positive lens, and
ν_{33P} denotes an Abbe number for the third positive lens.

13. The wide-angle optical system according to claim 1, wherein
the third lens unit includes a plurality of negative lenses,
the plurality of negative lenses includes a first negative lens and a second negative lens,
the first negative lens, among the plurality of negative lenses, is a negative lens located nearest to the object,
the second negative lens, among the plurality of negative lenses, is a negative lens located second from the object, and
following conditional expression (9) is satisfied:
−10<ν_{31N}ν_{V32N}<40 (9)
where,
ν_{31N} denotes an Abbe number for the first negative lens, and
ν_{32N} denotes an Abbe number for the second negative lens.

14. The wide-angle optical system according to claim 1, wherein the third lens unit includes not less than three positive lenses on an image side of a negative lens component which is nearest to an image.

15. The wide-angle optical system according to claim 1, comprising:
a second air lens, wherein
the second air lens is an air lens which satisfies following conditional expression (10), and
the third lens unit is provided with the second air lens:
3.0<SF_{RA}<5.0 (10)
where,
SF_{RA}=(R_{RAF}+R_{RAR})/(R_{RAF}−R_{RAR}),
R_{RAF} denotes a radius of curvature of a surface on the object side of the second air lens, and
R_{RAR} denotes a radius of curvature of a surface on an image side of the second air lens.

16. The wide-angle optical system according to claim 1, wherein the third lens unit is fixed at a time of the focal-position adjustment.

17. The wide-angle optical system according to claim 1, wherein following conditional expression (11) is satisfied:
−50<(R21F+R21R)/(R21F−R21R)<−1.0 (11)
where,
R21F denotes a radius of curvature of a surface on the object side of a predetermined lens component,
R21R denotes a radius of curvature of a surface on an image side of the predetermined lens component, and
the predetermined lens component is a lens component located nearest to the object in the second lens unit.

18. The wide-angle optical system according to claim 1, wherein following conditional expression (12) is satisfied:
0.0<D21/fL<3.0 (12)
where,
D21 denotes a distance on an optical axis between a surface nearest to the object and a surface nearest to an image of the second lens unit, and
fL denotes the focal length of the wide-angle optical system at the first position.

19. The wide-angle optical system according to claim 1, wherein following conditional expression (13) is satisfied:
1.01<β2F<1.35 (13)
where,
β2F denotes a magnification of the second lens unit at the first position.

20. The wide-angle optical system according to claim 1, wherein following conditional expression (14) is satisfied:
1.01<β2N/β2F<1.15 (14)
where,
β2F denotes a magnification of the second lens unit at the first position, and
β2N denotes a magnification of the second lens unit at the second position.

21. The wide-angle optical system according to claim 1, wherein following conditional expression (15) is satisfied:
0.10<(1−β2F²)×β3F²<0.35 (15)
where,
β2F denotes a magnification of the second lens unit at the first position, and
β3F denotes a magnification of the third lens unit at the first position.

22. The wide-angle optical system according to claim 1, wherein following conditional expression (16) is satisfied:
0.20<(1−⊖2N²)×β3N²<0.50 (16)
where,
β2N denotes a magnification of the second lens unit at the second position, and
β3N denotes a magnification of the third lens unit at the second position.

23. The wide-angle optical system according to claim 1, wherein the second lens unit has a positive refractive power.

24. The wide-angle optical system according to claim 1, wherein the first lens unit includes a plurality of negative lenses.

25. The wide-angle optical system according to claim 1, wherein
the first lens unit includes a plurality of negative lens components,
the plurality of negative lens components includes a first negative lens component and a second negative lens component,
the second negative lens component, among the plurality of negative lens components, is a negative lens component located second from the object, and
following conditional expression (17) is satisfied:
−2.0<fL/R12F<5.0 (17)
where,
R12F denotes a radius of curvature of a surface on the object side of the second negative lens component, and
fL denotes the focal length of the wide-angle optical system at the first position.

26. The wide-angle optical system according to claim 1, wherein
the first lens unit includes a plurality of negative lens components and a positive lens component, or includes a plurality of negative lens components,
the plurality of negative lens components includes a first negative lens component and a second negative lens component,
the second negative lens component, among the plurality of negative lens components, is a negative lens component located second from the object, and
following conditional expression (17) is satisfied:
−2.0<fL/R12F<5.0 (17)
where,
R12F denotes a radius of curvature of a surface on an object side of the second negative lens component, and
fL denotes the focal length of the wide-angle optical system at the first position.

27. The wide-angle optical system according to claim 1, wherein
the first lens unit includes a plurality of negative lens components,
the plurality of negative lens components includes a first negative lens component and a second negative lens component,
the first negative lens component, among the plurality of negative lens components, is a negative lens component located nearest to the object,
the second negative lens component, among the plurality of negative lens components, is a negative lens component located second from the object, and
following conditional expression (17) is satisfied:
−2.0<fL/R12F<5.0 (17)
where,
R12F denotes a radius of curvature of a surface on an object side of the second negative lens component, and
fL denotes the focal length of the wide-angle optical system at the first position.

28. The wide-angle optical system according to claim 1, wherein following conditional expression (18) is satisfied:
100×|f_{fin}|<|R_{fin}| (18)
where,
f_{fin} denotes a focal length of an image-side lens component, and
R_{fin} denotes a radius of curvature of a surface on an image side of the image-side lens component, and
the image-side lens component, among the plurality of lens components, is a lens component located nearest to an image.

29. The wide-angle optical system according to claim 1, comprising:
an image-side lens component; and
an optical element, wherein
the image-side lens component, among the plurality of lens components, is located nearest to an image,
the optical element is located on an image side of the image-side lens component, and
the image-side lens component and the optical element are cemented.

30. The wide-angle optical system according to claim 1, wherein following conditional expression (19) is satisfied:
2×ₘₐₓ<fL×tan ωₘₐₓ (19)
where,
yₘₐₓ denotes a maximum image height,
ωₘₐₓ denotes an angle of view corresponding to the maximum image height, and
fL denotes the focal length of the wide-angle optical system at the first position.

31. The wide-angle optical system according to claim 1, wherein following conditional expression (20) is satisfied:
ER<4×fL/F_{EX} (20)
where,
ER denotes an effective radius of a surface nearest to an image of the negative cemented lens,
F_{EX} denotes an effective F-value at the first position, and
fL denotes the focal length of the wide-angle optical system at the first position.

32. An image pickup apparatus comprising:
an optical system; and
an image sensor which is disposed on an image plane, wherein
the image sensor has an image pickup surface, and converts an image formed on the image pickup surface by the optical system to an electric signal, and
the optical system is a wide-angle optical system according to claim 1.
